(19) United States
(12) Patent Application Publication
(10) Pub. No.: US 2025/0273867 A1
(43) Pub. Date: Aug. 28, 2025

(54) FREQUENCY-SELECTIVE REFLECTOR

(71) Applicant: DAI NIPPON PRINTING CO., LTD, Tokyo (JP)

(72) Inventors: Atsuo NAKAMURA, Tokyo (JP); Yuichi MIYAZAKI, Tokyo (JP); Hiroyuki ASAKURA, Tokyo (JP); Yusuke ISAWA, Tokyo (JP)

(73) Assignee: DAI NIPPON PRINTING CO., LTD, Tokyo (JP)

(21) Appl. No.: 18/858,788

(22) PCT Filed: Apr. 24, 2023
(86) PCT No.: PCT/JP2023/016066

§ 371 Date: Jan. 6, 2025

(30) Foreign Application Priority Data
Apr. 25, 2022 (JP) 2022-071487
Feb. 14, 2023 (JP) 2023-020680

(51) Int. Cl. H01Q 15/14

(52) U.S. Cl. CPC H01Q 15/14

(57) ABSTRACT

The present disclosure provides a frequency selective reflector reflecting electromagnetic waves in a particular frequency band of 24 GHz or more in a direction different from a regular reflection direction, the frequency selective reflector comprising: a reflecting member reflecting the electromagnetic waves; and a dielectric layer that is disposed at an incident side of the electromagnetic waves with respect to the reflecting member and transmits the electromagnetic waves, the dielectric layer has two types of thicknesses, and includes a plurality of first regions with thinner thickness and a plurality of second regions with thicker thickness.

### TECHNICAL FIELD

The present disclosure relates to a frequency selective reflector reflecting electromagnetic waves in a particular frequency band in a direction different from a regular reflection direction.

### BACKGROUND ART

As described in Patent Documents 1 and 2 and Non-Patent Documents 1 and 2, to improve the propagation environment and propagation area in a mobile communication system, a technique of the reflect array has been considered. Since high frequency radio waves, such as those used in fifth generation mobile communication systems (5G), tend to travel straight, a resolution of coverage holes which the radio waves do not reach is an important issue.

It is desired that the reflect array reflect electromagnetic waves of a particular frequency in a desired direction. The electromagnetic waves are incident from a base station positioned in a given direction. In such a reflect array, for example, a plurality of reflective elements is arranged. Techniques of controlling the reflection phase of the electromagnetic waves by varying the size or shape of the reflective element to vary the resonant frequency of each reflective element, and thereby controlling the incident direction and the reflection direction of the electromagnetic waves have been developed.

### CITATION LIST

### Patent Documents

Patent Document 1: Japanese Patent No. 5371633
Patent Document 2: Japanese Patent No. 5162677

### Non-Patent Documents

Non-Patent Document 1: Hiromi MATSUNO et. Al. “Visible Light Transfer Meta-surface Reflectors”, The Institute of Electronics, Information and Communication Engineers (IEICE) Technical Report, 2020, Vol. 120, No. 9, pp. 13-17
Non-Patent Document 2: Mayumi YOSHINO et. Al. “Received Power Improvement in NLOS Region of L-Shaped Corridor by Utilizing Meta-Surface Reflector”, The Institute of Electronics, Information and Communication Engineers (IEICE) Technical Report, A·P2020-5 (2020-04)

### SUMMARY OF DISCLOSURE

### Technical Problem

In the reflect array, the pattern of reflective elements is known to be formed, for example, by etching a metal layer using photolithographic techniques.

In the mobile communication systems, the relationship between the position of the base station, the position of the coverage hole, and the installation location of the reflect array is assumed to be a variety of situations. To that end, it is necessary to use a reflect array having reflection properties that are the target incident angle and reflection angle in accordance with the situation.

However, in relation to the reflect array, in order to customize the reflection properties according to various situations, it is necessary to customize the photomask used for photolithography processing of the metal layer, the production cost increases and the production time is long.

Also, in the reflect array, for example, the reflection angle can be increased by narrowing the pitch of the reflective element. However, in the planar arrangement of reflective elements, it is difficult to increase the reflection angle due to limitations in the narrowing of the pitch of the reflective elements. Also, since photolithographic processing of the metal layer is limited in processing accuracy, it is difficult to finely control the reflection phase at a high frequency radio waves of which the wavelength is short and processing accuracy is required.

The present disclosure has been made in view of the above circumstances, and a main object thereof is to provide a frequency selective reflector capable of reducing the production cost and reducing the production time.

### Solution to Problem

One embodiment of the present disclosure provides a frequency selective reflector reflecting electromagnetic waves in a particular frequency band of 24 GHz or more in a direction different from a regular reflection direction, the frequency selective reflector comprising: a reflecting member reflecting the electromagnetic waves; and a dielectric layer that is disposed at an incident side of the electromagnetic waves with respect to the reflecting member and transmits the electromagnetic waves, the dielectric layer has two types of thicknesses, and includes a plurality of first regions with thinner thickness and a plurality of second regions with thicker thickness.

Another embodiment of the present disclosure provides a frequency selective reflector reflecting electromagnetic waves in a particular frequency band in a direction different from a regular reflection direction, the frequency selective reflector comprising: a substrate; a reflecting member disposed on one side of the substrate, and reflecting the electromagnetic waves; and a dielectric member disposed on an opposite side of the reflecting member to the substrate, and transmits the electromagnetic waves, the dielectric member includes a first dielectric layer and a second dielectric layer, in this order from the reflecting member side; the first dielectric layer includes a plurality of first dielectric portions disposed on an opposite side of the reflecting member to the substrate; the second dielectric layer includes a plurality of second dielectric portions disposed on an opposite side of the first dielectric layer to the reflecting member; the second dielectric portion is arranged so that the second dielectric portion overlaps a boundary of the adjacent first dielectric portions in a plan view; and the first dielectric portion includes a first dielectric pattern, and the second dielectric portion includes a second dielectric pattern.

### Advantageous Effects of Disclosure

The frequency selective reflector of the present disclosure exhibits effects that it is possible to reduce the production cost and reduce the production time.

### BRIEF DESCRIPTION OF DRAWINGS

FIG. 1 are a schematic plan view and a schematic cross-sectional view exemplifying the frequency selective reflector of the present disclosure, and a schematic diagram for explaining a relative reflection phase of electromagnetic waves in a first region and a second region of a dielectric layer in the frequency selective reflector of the present disclosure.

FIG. 2 is a schematic view exemplifying reflection properties of the frequency selective reflector of the present disclosure.

FIG. 3 is a schematic plan view exemplifying a reflecting member of the frequency selective reflector of the present disclosure.

FIG. 4 is a schematic plan view exemplifying the frequency selective reflector of the present disclosure, and a schematic diagram for explaining the relative reflection phase of electromagnetic waves in the first region and the second region of the dielectric layer in the frequency selective reflector of the present disclosure.

FIG. 5 are schematic views exemplifying reflection properties of the frequency selective reflector of the present disclosure.

FIG. 6 is a schematic view exemplifying reflection properties of the frequency selective reflector of the present disclosure.

FIG. 7 is a schematic plan view illustrating an example of the frequency selective reflector of the present disclosure.

FIG. 8 is a schematic diagram exemplifying an incident direction and a reflection direction of electromagnetic waves with respect to the frequency selective reflector.

FIG. 9 are a schematic plan view and a schematic cross-sectional view exemplifying the frequency selective reflector of the present disclosure.

FIG. 10 are a schematic plan view and a schematic cross-sectional view exemplifying a dielectric layer of the frequency selective reflector of the present disclosure.

FIG. 11 are a schematic plan view and a schematic cross-sectional view exemplifying the dielectric layer of the frequency selective reflector of the present disclosure.

FIG. 12 are a schematic cross-sectional view exemplifying the frequency selective reflector of the present disclosure, and a schematic diagram for explaining the relative reflection phase of electromagnetic waves in the first region and the second region of the dielectric layer in the frequency selective reflector of the present disclosure.

FIG. 13 are schematic cross-sectional views exemplifying the frequency selective reflector of the present disclosure.

FIG. 14 are a schematic plan view exemplifying the reflecting member in the frequency selective reflector of the present disclosure, and a schematic cross-sectional view exemplifying the frequency selective reflector of the present disclosure.

FIG. 15 are a schematic plan view exemplifying the reflecting member in the frequency selective reflector of the present disclosure, and a schematic cross-sectional view exemplifying the frequency selective reflector of the present disclosure.

FIG. 16 is a schematic cross-sectional view exemplifying the frequency selective reflector of the present disclosure.

FIG. 17 is a schematic cross-sectional view exemplifying the frequency selective reflector of the present disclosure.

FIG. 18 are a schematic cross-sectional view and a schematic plan view exemplifying the frequency selective reflector of the present disclosure.

FIG. 19 are a schematic plan view and a schematic cross-sectional view exemplifying a first dielectric portion constituting a first dielectric layer of the present disclosure.

FIG. 20 are a schematic plan view and a schematic cross-sectional view exemplifying a second dielectric portion constituting a second dielectric layer of the present disclosure.

FIG. 21 are a schematic cross-sectional view exemplifying the frequency selective reflector of the present disclosure, and a schematic diagram for explaining the relative reflection phase of electromagnetic waves in an A1 region, an A2 region, and an A3 region of a dielectric member in the frequency selective reflector of the present disclosure.

FIG. 22 is a schematic cross-sectional view exemplifying the frequency selective reflector.

FIG. 23 is a schematic plan view exemplifying the frequency selective reflector of the present disclosure.

FIG. 24 is a schematic plan view exemplifying the frequency selective reflector of the present disclosure.

FIG. 25 are schematic cross-sectional views exemplifying the first dielectric portion constituting the first dielectric layer in the frequency selective reflector of the present disclosure.

FIG. 26 are a schematic plan view exemplifying the frequency selective reflector of the present disclosure, and schematic plan views exemplifying the first dielectric layer and the second dielectric layer in the frequency selective reflector of the present disclosure.

FIG. 27 are a schematic plan view exemplifying the frequency selective reflector of the present disclosure, and schematic plan views exemplifying the first dielectric layer and the second dielectric layer in the frequency selective reflector of the present disclosure.

FIG. 28 are a schematic plan view exemplifying the frequency selective reflector of the present disclosure, and schematic plan views exemplifying the first dielectric layer and the second dielectric layer in the frequency selective reflector of the present disclosure.

FIG. 29 are a schematic plan view exemplifying the frequency selective reflector of the present disclosure, and schematic plan views exemplifying the first dielectric layer and the second dielectric layer in the frequency selective reflector of the present disclosure.

FIG. 30 are a schematic plan view exemplifying the frequency selective reflector of the present disclosure, and schematic plan views exemplifying the first dielectric layer and the second dielectric layer in the frequency selective reflector of the present disclosure.

FIG. 31 are schematic cross-sectional views exemplifying the frequency selective reflector of the present disclosure.

FIG. 32 are schematic cross-sectional views exemplifying the frequency selective reflector of the present disclosure.

FIG. 33 are a schematic cross-sectional view exemplifying the frequency selective reflector of the present disclosure, and a schematic diagram for explaining the relative reflection phase of electromagnetic waves in the A1 region, the A2 region, and the A3 region of the dielectric member in the frequency selective reflector of the present disclosure.

FIG. 34 are schematic cross-sectional views exemplifying the frequency selective reflector of the present disclosure.

FIG. 35 is a schematic plan view exemplifying the dielectric member in the frequency selective reflector of the present disclosure.

FIG. 36 are a schematic plan view exemplifying the dielectric member in the frequency selective reflector of the present disclosure, and a schematic diagram for explaining the relative reflection phase of electromagnetic waves in each region of the dielectric member in the frequency selective reflector of the present disclosure.

FIG. 37 is a schematic plan view exemplifying the dielectric member in the frequency selective reflector of the present disclosure.

FIG. 38 is a schematic plan view and a cross-sectional view exemplifying the first dielectric portion constituting the first dielectric layer of the present disclosure.

FIG. 39 is a schematic plan view exemplifying the frequency selective reflector of the present disclosure.

FIG. 40 is a schematic plan view exemplifying the frequency selective reflector of the present disclosure.

FIG. 41 is a schematic plan view exemplifying the frequency selective reflector of the present disclosure.

FIG. 42 is a schematic plan view exemplifying the frequency selective reflector of the present disclosure.

FIG. 43 is a schematic cross-sectional view exemplifying the frequency selective reflector of the present disclosure.

FIG. 44 are a schematic plan view exemplifying the reflecting member in the frequency selective reflector of the present disclosure, and a schematic cross-sectional view exemplifying the frequency selective reflector of the present disclosure.

FIG. 45 are a schematic plan view exemplifying the reflecting member in the frequency selective reflector of the present disclosure, and a schematic cross-sectional view exemplifying the frequency selective reflector of the present disclosure.

FIG. 46 is a schematic cross-sectional view exemplifying the frequency selective reflector of the present disclosure.

FIG. 47 is a received power distribution diagram showing a simulation result of Example 1.

FIG. 48 is a received power distribution diagram showing a simulation result of Example 2.

FIG. 49 is a received power distribution diagram showing a simulation result of Reference Example 1.

FIG. 50 is a received power distribution diagram showing a simulation result of Example 3.

FIG. 51 are diagrams showing a simulation result of Reference Example 2.

FIG. 52 is a schematic diagram exemplifying a transmission line equivalent circuit.

### DESCRIPTION OF EMBODIMENTS

Embodiments in the present disclosure are hereinafter explained with reference to, for example, drawings. However, the present disclosure is implemented in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present descriptions and each drawing, for the factor same as that described in the figure already explained, the same reference sign is indicated and the detailed explanation thereof may be omitted.

In the present descriptions, in expressing an aspect wherein some member is placed on the other member, when described as merely “above” or “below”, unless otherwise stated, it includes both of the following cases: a case wherein some member is placed directly on or directly below the other member so as to be in contact with the other member, and a case wherein some member is placed on the upper side or the lower side of the other member via yet another member. Also, in the present descriptions, on the occasion of expressing an aspect wherein some member is placed on the surface of the other member, when described as merely “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

The frequency selective reflector in the present disclosure will be hereinafter described in detail.

### A. Frequency Selective Reflector

The frequency selective reflector in the present disclosure has two embodiments. Each embodiment is hereinafter described.

### I. First Embodiment

A main object of the present embodiment is to provide a frequency selective reflector capable of controlling the reflection direction of electromagnetic waves with a simple structure, and also capable of reducing the production cost and reducing the production time.

The frequency selective reflector of the present embodiment is a frequency selective reflector reflecting electromagnetic waves in a particular frequency band of 24 GHz or more in a direction different from a regular reflection direction, the frequency selective reflector comprising: a reflecting member reflecting the electromagnetic waves; and a dielectric layer that is disposed at an incident side of the electromagnetic waves with respect to the reflecting member; and transmits the electromagnetic waves, wherein the dielectric layer has two types of thicknesses, and includes a plurality of first regions with thinner thickness and a plurality of second regions with thicker thickness.

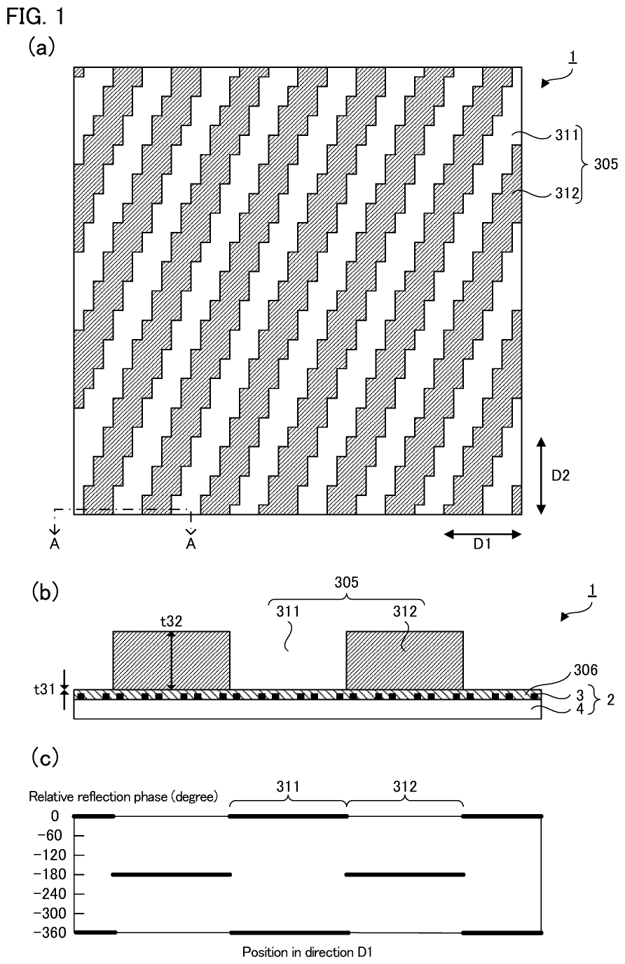

FIGS. 1(a), (b) are a schematic plan view and cross-sectional view showing an example of the frequency selective reflector of the present embodiment, and FIG. 1(b) is a cross-sectional view of A-A line in FIG. 1(a). As shown in FIGS. 1(a), (b), a frequency selective reflector 1 includes a reflecting member 2 reflecting particular electromagnetic waves, and a dielectric layer 305 disposed at an incident side of the electromagnetic waves with respect to the reflecting member 2, and transmits particular electromagnetic waves. Also, the frequency selective reflector 1 may include adhesive layer 306 between the reflecting member 2 and the dielectric layer 305. The dielectric layer 305 has two types of thicknesses t31, t32, and includes a plurality of first regions 311 with the thinner thickness t31 and a plurality of second regions 312 with the thicker thickness t32. Incidentally, although the thickness t31 of the first region 311 of dielectric layer 305 is 0 in FIG. 1(b), the thickness of the first region is not limited thereto.

In the dielectric layer 305, since the thickness t31 of the first region 311 and the thickness t32 of the second region 312 are different, the round-trip optical path length when the electromagnetic waves are transmitted through the dielectric layer 305, reflected by the reflecting member 2, and emitted to the incident side of the electromagnetic waves by being transmitted through the dielectric layer 305 again, are different in the first region 311 and the second region 312. The differences in round-trip optical path length in these dielectric layers, that is, the optical path difference, will produce a relative reflection phase difference.

The term “optical path length” is used in the present description because the wavelength of the frequency band targeted in the present disclosure is more easily explained when described as behavior similar to the light since the wavelength of the frequency band targeted in the present disclosure is closer to that of the light as compared to the frequency band of a conventional LTE and the tendency to travel straight is high. The optical path length actually refers to the effective distance when the electromagnetic waves travel through the dielectric layer.

FIG. 1(c) is a graph setting a horizontal axis as the position of the dielectric layer 305 in the predetermined direction D1, and setting a vertical axis as a relative reflection phase when the electromagnetic waves are transmitted through the dielectric layer 305, reflected by the reflecting member 2 and emitted to the incident side of the electromagnetic waves by being transmitted through the dielectric layer 305 again, wherein the value of the relative reflection phase of the electromagnetic waves is −360 degrees or more and 0 degrees or less; and it is an example of the relative reflection phase of electromagnetic waves in the first region and the second region of the dielectric layer in the frequency selective reflector shown in FIGS. 1(a), (b). As shown in FIG. 1(c), the relative reflection phase of the electromagnetic waves in the first region 311 and the second region 312 of dielectric layer 305 is 0 degrees (−360 degrees), and −180 degrees, respectively.

Although “reflection phase” in the present descriptions is referred to as the amount of change in phase of the reflected wave with respect to the phase of the incident wave incident on a surface; in the frequency selective reflector including the reflecting member and the dielectric layer of the present embodiment, “reflection phase” is referred to as the amount of change in phase of the reflected wave when the incident wave is transmitted through the dielectric layer, reflected by the reflecting member and emitted by being transmitted through the dielectric layer again, with respect to the phase of the incident wave.

Also, in the present descriptions, the term “relative reflection phase” is one in which, among the first region and the second region of the dielectric layer, when the reflection phase in the one region where the delay of the reflection phase is small is used as a reference, the delay of the reflection phase in the other region with respect to the reflection phase of the reference is shown as a negative signal. For example, among the first region and the second region of the dielectric layer, when the reflection phase in the one region where the delay of the reflection phase is small is −10 degrees, the relative reflection phase in the region where the reflection phase is −40 degrees, is −30 degrees.

Incidentally, when the reflecting member has a reflection phase control function as described below, the relative reflection phase of the electromagnetic waves in the first region and the second region of the dielectric layer is a value obtained by also synthesizing the reflection phase in the reflecting member.

Note that the reflection phase is in the range of over −360 degrees to less than 360 degrees unless otherwise noted, and −360 degrees and 360 degrees return to 0 degrees. Also, the relative reflection phase is in the range of over −360 degrees to 0 degrees or less, unless otherwise noted, and −360 degrees returns to 0 degrees.

In a conventional reflect array in which a plurality of reflective elements is arranged, for example, by adjusting the size or shape of the reflective element, the reflection phase can be delayed, and the reflection phase can be advanced. On the other hand, in the frequency selective reflector of the present embodiment, the reflection phase is basically delayed by adjusting the thickness of the first region and the second region of the dielectric layer. For this reason, the relative reflection phase is based on the reflection phase in the region where the delay of the reflection phase is small, among the first region and the second region of the dielectric layer.

Also, among the first region and the second region of the dielectric layer, the region where the delay of the reflection phase is small is usually the first region with thinner thickness.

As described above, in the dielectric layer 305, when the thicknesses t31, t32 vary, the round-trip optical path length in the dielectric layer 305 varies and the relative reflection phase of the electromagnetic waves varies. In conventional reflect arrays, the reflection direction of electromagnetic waves is controlled utilizing the properties that the electromagnetic waves travel in the normal direction of the plane of the same phase. Similarly in the frequency selective reflector of the present embodiment, the reflection direction of the electromagnetic waves can be controlled. For example, in the frequency selective reflector with reflection properties as shown in FIG. 1(c), when a plane wave is injected directly above the frequency selective reflector, the line (plane) connecting the center portions of the first region 311 and the second region 312 in order can be regarded as the plane of the same phase, of the reflected wave, and the reflected wave proceeds in the normal direction.

The frequency selective reflector in the present embodiment is a so-called 1-bit reflect array, and the reflection phase variation thereof is 1 bit. Therefore, in the first region 311, for the relative reflection phase of the electromagnetic waves, 0 degrees and −360 degrees are equivalent. Thus, for the line (plane) connecting the center portions of the first region 311 and the second region 312 in order, two same phase planes are formed, diagonally right down and diagonally left down. As the result, when a plane wave is injected directly above the frequency selective reflector, the reflected wave is generated axisymmetrically, and although the reflected power in each direction is halved, it is possible to deliver the electromagnetic waves in the predetermined reflection direction. Also, when the incident wave is not from the front direction of the frequency selective reflector but from the direction inclined to the frequency selective reflector, although the reflected wave is axisymmetrical, the reflected power on one side is strongly reflected, which makes it possible to deliver the electromagnetic waves more effectively. Incidentally, the decrease in reflected power due to this symmetry can be compensated by means such as increasing the area of the frequency selective reflector.

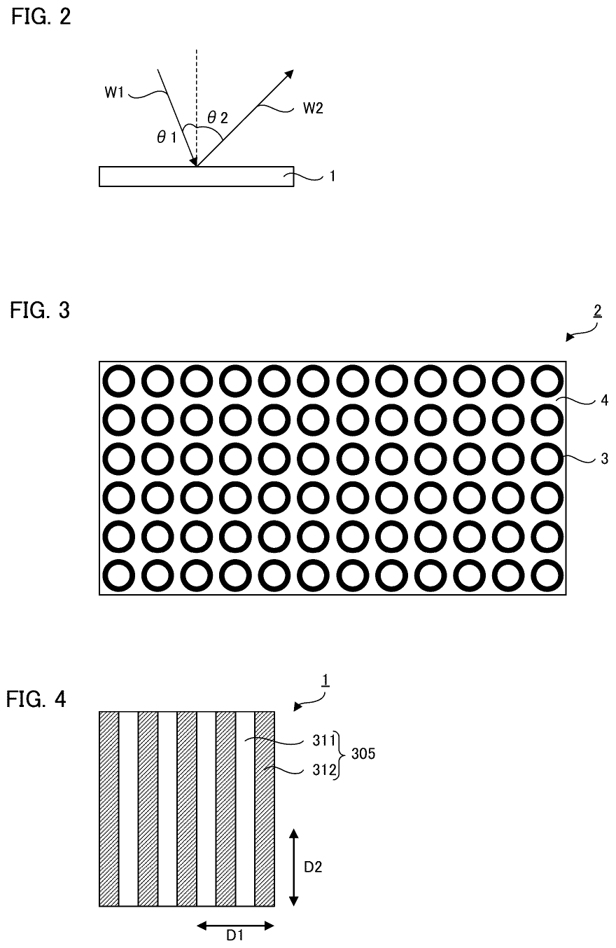

Therefore, as exemplified in FIG. 2, the incident wave W1 of the electromagnetic waves can be reflected in a direction different from the regular reflection (specular reflection) direction. In this case, the incident angle θ1 of the incident wave W1 of the electromagnetic waves is different from the reflection angle θ2 of the reflected wave W2 of the electromagnetic waves.

Therefore, in the frequency selective reflector of the present embodiment, by varying the thicknesses of the first region and the second region of the dielectric layer, the round-trip optical path length in the dielectric layer can be varied between the first region and the second region, and the reflection phase of the electromagnetic waves can be controlled. As the result, the reflection direction of the electromagnetic waves with respect to the predetermined incident direction can be controlled in any direction.

Further, the dielectric layer in the present embodiment can be formed by various techniques such as, for example, cutting, laser processing, shaping using a mold, 3D printer, and joining small piece parts. Therefore, there is no need for a photomask unlike photolithographic processing of a metal layer in a conventional reflect array. Further, the number of types of the thickness of the dielectric layer is only two types. Thus, the desired dielectric layer can be formed relatively inexpensively and in a short time. Particularly, when the dielectric layer is formed by, for example, cutting, or laser processing, the production costs can be significantly reduced and production time can be significantly shortened. Therefore, it is easy to respond to the needs of small quantities and a wide variety of products. It is also possible to use highly durable materials such as engineering plastics that are not suitable for the molding and the 3D printers. Further, since the number of types of the thickness of the dielectric layer is only two types, the maximum thickness of the dielectric layer may be made thin. Therefore, in the frequency selective reflector of the present embodiment, although the reflection direction of the electromagnetic waves is controlled by controlling the reflection phase of the electromagnetic waves by the thickness of the dielectric layer, a thin type frequency selective reflector may be obtained.

Also, in the frequency selective reflector in the present embodiment, the thickness of the first region and the second region of the dielectric layer and the pitch of the first region or the second region of the dielectric layer affect the control of the reflection properties. Since the range of possible processing of the thickness of the first region and the second region of the dielectric layer and the pitch of the first region or the second region of the dielectric layer are relatively wide, and thus, for example, the incident angle or the reflection angle of the electromagnetic waves can be increased, and the control range of the reflection properties can be widened. Furthermore, with respect to the thickness of the first region and the second region of the dielectric layer and the pitch of the first region or the second region the dielectric layer, the margin of dimensional processing accuracy for achieving the desired reflection phase is relatively wide, and thus the desired reflection properties can be easily obtained and the influence of dimensional variations can be reduced.

Also, in the frequency selective reflector of the present embodiment, the reflecting member may be a frequency selective plate that reflects only particular electromagnetic waves. FIG. 3 is a schematic plan view exemplifying the reflecting member, and it is an example of the reflecting member shown in FIG. 1(b). As shown in FIG. 3, the reflecting member 2 is the one in which a plurality of ring-shaped reflective elements 3 is arranged, and it includes dielectric substrate 4, and a plurality of reflective elements 3 arranged on the dielectric layer 305 side surface of the dielectric substrate 4.

Further, in the frequency selective reflector of the present embodiment, the reflecting member may be a frequency selective plate that reflects only particular electromagnetic waves, as well as a member having a reflection phase control function that controls the reflection phase of the electromagnetic waves. In such a reflecting member, by varying the size or shape of the reflective element, the resonant frequency per reflective element can be varied and the targeted reflection phase of the electromagnetic waves can be controlled. In this case, the reflection phase of the electromagnetic waves can be controlled not only by the thickness of the dielectric layer but also by the size or shape of the reflective element, and the degree of freedom of design for controlling the reflection properties can be improved.

Thus, in the frequency selective reflector of the present embodiment, when such a reflecting member is used, the degree of freedom in controlling the reflection properties can be widened by combining with the dielectric layer. For example, an operation where the reflection properties in top and bottom directions may be prepared with multiple types of reflecting members and combined with a dielectric layer that adjusts the reflection properties in horizontal direction is one example.

The inventors of the present disclosure also simulated the reflection properties of electromagnetic waves in a particular frequency band when the reflecting member is a frequency selective plate including a reflective element that reflects only particular electromagnetic waves in the frequency selective reflector including the reflecting member and the dielectric layer of the present embodiment. The results have found that when the thicknesses of the first region and the second region of the dielectric layer are varied to vary the round-trip optical path length in the dielectric layer between the first region and the second region, the deviation of the reflection phase was greater compared to the deviation of the reflection phase in the reflective element due to the proximity of the dielectric layer to the reflecting member (frequency selective plate). Also, it has been discovered that the design of substantial reflection properties can be substantially determined by the design of the thickness of the dielectric layer. At this time, the resonant frequency of the reflective element varies depending on the presence or absence of the adjacent dielectric layer, but if the design is performed on the premise that the dielectric layer is present, the practical problem is solved.

Further, it has been found out that the in-plane arrangement of the first region and the second region of the dielectric layer that achieves the in-plane distribution design of the reflection phase in the frequency selective reflector does not need to be in a fixed positional relationship with respect to the in-plane arrangement of the reflective element of the reflecting member, and even if the first region and the second region of the dielectric layer are shifted and arranged relative to the in-plane arrangement of the reflective element, there is no significant effect on the reflection properties.

Thus, when the dielectric layer and the reflecting member as described above are combined and used in the frequency selective reflector of the present embodiment, it is possible to design each of the dielectric layer and the reflecting member independently, and combine the two. In this case, a dielectric layer for achieving reflection properties according to the use environment may be made each time or a plurality of specifications may be prepared in advance. As a result, it is possible to more easily design the reflection direction of the frequency selective reflector that changes according to the use environment. Incidentally, as described above, in the case of adjusting the total reflection properties of the frequency selective reflector by the combination of the respective reflection phase distributions of the reflecting member and the dielectric layer, the accuracy of the misalignment between the reflecting member and the dielectric layer according to the required specification is required, but when the reflection properties of the frequency selective reflector are adjusted only by the reflection phase distribution of the dielectric layer, the accuracy of the misalignment between the reflecting member and the dielectric layer is not required so much.

Each configuration of the frequency selective reflector of the present embodiment will be hereinafter explained.

### 1. Dielectric Layer

The dielectric layer in the present embodiment is a member that is disposed at an incident side of the electromagnetic waves with respect to the reflecting member, and transmits the electromagnetic waves in a particular frequency band. Also, the dielectric layer has two types of thicknesses, and includes a plurality of first regions with thinner thickness and a plurality of second regions with thicker thickness.

### (1) Structure of Dielectric Layer

The dielectric layer has two types of thicknesses, and includes a plurality of first regions with thinner thickness and a plurality of second regions with thicker thickness.

In the dielectric layer, an absolute value of a difference between a relative reflection phase of the electromagnetic waves in the first region and a relative reflection phase of the electromagnetic waves in the second region may be more than 0 degrees and less than 360 degrees. In the present disclosure, as described below, two dielectric layers may be stacked in the thickness direction. When only one dielectric layer is used, the absolute vale of the difference in the relative reflection phases of the electromagnetic waves described above is preferably, for example, 150 degrees or more and 210 degrees or less, more preferably 170 degrees or more and 190 degrees or less, and further preferably 175 degrees or more and 185 degrees or less. In this case, as the absolute value of the difference in the relative reflection phase of the electromagnetic waves described above gets closer to 180 degrees, the disturbance of the wavefront of the reflected waves can be controlled. Also, when two dielectric layers are disposed by stacking in the thickness direction, the absolute vale of the difference in the relative reflection phases of the electromagnetic waves described above is preferably, for example, 90 degrees or more and 150 degrees or less, more preferably 110 degrees or more and 130 degrees or less, and further preferably 115 degrees or more and 125 degrees or less. In this case, as the absolute value of the difference in the relative reflection phase of the electromagnetic waves described above gets closer to 120 degrees, the disturbance of the wavefront of the reflected waves can be controlled.

In the dielectric layer, the difference between the round-trip optical path lengths in the first regions and the round-trip optical path lengths in the second region is designed such that the absolute value of the difference between the relative reflection phase of the electromagnetic waves in the first region and the relative reflection phase of the electromagnetic waves in the second region is set as described above. Also, the thickness of the first region and the second region is respectively designed such that the difference between the round-trip optical path lengths in the first regions and the round-trip optical path lengths in the second region is the difference described above. The thickness of the A1 region and the A2 region is appropriately set according to the wavelength of the electromagnetic waves, the dielectric constant of the material of the dielectric layer, and the intended reflection properties, respectively. For example, if the effective wavelength of the electromagnetic waves passing through the dielectric body is λ_{g} and the thickness of the base is a, the thickness of the first region and the second region is preferably about α+0% or more and α+λ_{g}/2 or less, respectively. Also, as described above, when only one dielectric layer is used, the thickness of the second region is more preferably about α+λ_{g}/4 or less. Meanwhile, in the above case, the thickness of the second region is more preferably α+λ_{g}/10 or more. The thickness α of the base may be the same as the thickness of the first region. Although the thickness α of the base is appropriately set in consideration to the overall strength, ease of formation, etc., it is preferable that the thickness α of the base is typically about 0.1λ_{g} or less, in view of the influence to the electromagnetic waves. Specifically, when the wavelength λ0 in the air of the electromagnetic waves is 10 mm and the specific dielectric constant of the dielectric layer is 2.57, the thickness of the A1 region and the A2 region is preferably 0 mm or more and 8.9 mm or less, and more preferably 0 mm or more and 4.2 mm or less, respectively. In this case, the thickness of the second region is further preferably 1.2 nm or more.

Among the above, the thickness of the first region is preferably 0. When the thickness of the first region is 0, the dielectric layer can be formed more easily. Incidentally, a case where the thickness of the first region is 0 refers to an aspect where the dielectric layer is not formed on the first region located on the reflecting member.

The pitch of the first region or the second region is appropriately set according to the intended reflection properties. The pitch of the first region is shifted by one wavelength (phase difference: 360 degrees) per one pitch. Similarly, the pitch of the second region is shifted by one wavelength (phase difference: 360 degrees) per one pitch. Therefore, the reflection angle can be adjusted by the pitch of the first region or the second region. For example, by shortening the pitch of the first region or the second region, the difference of the reflection angle with respect to the regular reflection angle can be increased, while the difference of the reflection angle with respect to the regular reflection angle can be reduced by lengthening the pitch of the first region or the second region.

Also, when the reflecting member is a member in which a plurality of reflective elements is arranged, the pitch of the first region or the second region of the dielectric layer may be the same as or different from the pitch of the reflective element of the reflecting member. If the pitch of the first region or the second region of the dielectric layer is the same as the pitch of the reflective element of the reflecting member, the designing is easy. Also, for example, by adjusting the pitch of the first region or the second region of the dielectric layer, the control range of the reflection properties can be widened regardless of the pitch of the reflective element of the reflecting member.

In the dielectric layer as a whole, the pitch of the first region or the second region is appropriately set according to the intended reflection properties, the pitch may be uniform or non-uniform.

Incidentally, the pitch of the first region refers to the distance from the center of one first region to the center of the neighboring first region. Also, the pitch of the second region refers to the distance from the center of one second region to the center of the neighboring second region.

The size of the first region and the second region are appropriately set respectively.

In the dielectric layer as a whole, the size of the first region and the second region are respectively appropriately set according to the intended reflection properties, and the size may be uniform or non-uniform. The shape of the first region and the second region in plan view is not particularly limited if it is a shape capable of arranging the first region and the second region without a gap, respectively.

In the dielectric layer as a whole, the shape of the first region and the second region in a plan view may be uniform or non-uniform, respectively.

The pattern shape of the first region and the second region is not particularly limited, and examples thereof may include a striped shape.

In the dielectric layer, the arrangement of the first region and the second region is appropriately set according to the intended reflection properties. The first region and the second region are usually arranged alternately. For example, when the shape of the frequency selective reflector in a plan view is a rectangular shape, the first region and the second region may be arranged alternately in the longitudinal direction or in the horizontal direction, or they may be arranged alternately in the diagonal direction. For example, FIG. 4 is an example where the first region 311 and the second region 312 are arranged alternately in the horizontal direction (direction D1) of the figure. Also, FIG. 1(a) is an example where the first region 311 and the second region 312 are arranged alternately in the diagonal direction of the figure. Also, when arranging the first region and the second region without a gap, the direction of the arrangement is not particularly limited. According to the required reflection properties design, the first region and the second region may be arranged by selecting the appropriate arrangement angle and the appropriate arrangement direction.

Also, the first region and the second region may be arranged, for example, alternately concentrically. In this case, concentric circle may be one, and may be plural.

Also, the first region and the second region may be arranged, for example, in a sea-island shape. In this case, the first region may be the sea and the second region may be the island; or the first region may be the island and the second region may be the sea.

In the dielectric layer in the present embodiment, the thickness of the first region and the second region affects the reflection properties of the frequency selective reflector as a whole, and for example, the pitch of the first region or the second region, the size of the first region and the second region, as well as the shape of the first region and the second region in a plan view, the pattern shape of the first region and the second region can also affect the reflection properties of the frequency selective reflector as a whole. Specifically, the adjustment of polarization characteristics, the effect on the beam profile (such as high directivity, spread, and multibeam), and the like are to be influenced.

In the dielectric layer, the thickness distribution of the dielectric layer is appropriately selected so that the normal vector of the same phase plane of the reflected wave with respect to the incident wave incident at a predetermined incident angle is in a desired reflection direction, and the plurality of the first regions and the second regions is arranged.

For example, when the incident plane wave is reflected in a single direction, reflected as so-called plane wave, the pitch of the first region or the second region, the width of the first region and the second region, and the shape of the first region and the second region in a plan view are preferably uniform in the dielectric layer as a whole, respectively. Also, in this case, the pattern shape of the first region and the second region is more preferably a striped shape. For example, in FIG. 4, in the dielectric layer 305 as a whole, the pitch of the first region 311 or the second region 312, the width of the first region 311 and the second region 312, and the shape of the first region 311 and the second region 312 in a plan view are uniform, respectively. Also, the pattern shape of the first region 311 and the second region 312 is a striped shape. In this case, as exemplified in FIG. 2, the incident wave W1 incident at a predetermined incident angle θ1 can be reflected at a predetermined reflection angle θ2, and the reflected wave W2 can be a plane wave that does not spread. Also, when the shape of the frequency selective reflector in a plan view is a rectangular shape, and when the pattern shape of the first region and the second region is a striped shape, the longitudinal direction of the stripes of the first region and the second region may be parallel to the short direction of the frequency selective reflector, and the longitudinal direction of the stripes of the first region and the second region may be parallel to the longitudinal direction of the frequency selective reflector. In the actual frequency selective reflector, the longitudinal direction and the shorter direction of the stripes of the first region and the second region can be set arbitrarily according to the design of the reflection properties.

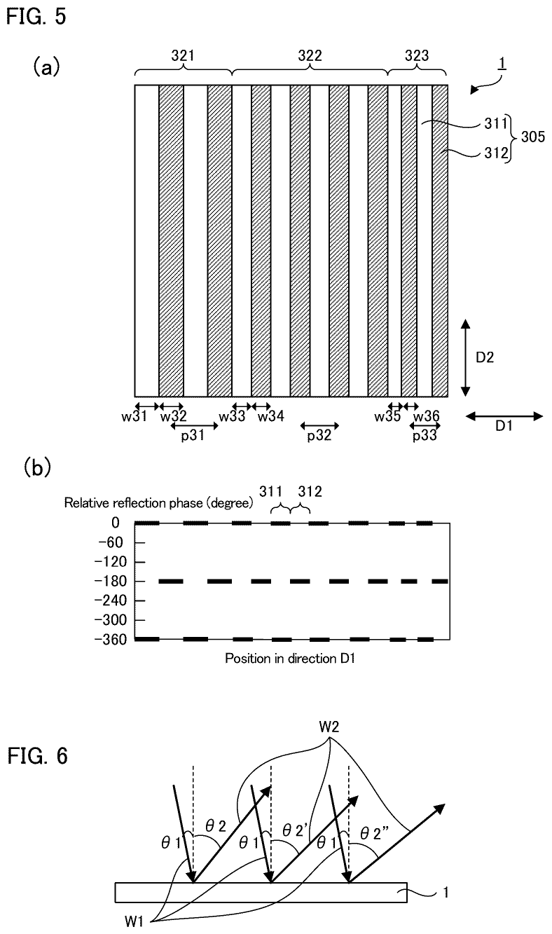

Also, for example, when reflecting the electromagnetic waves as, for example, a cylindrical wave, examples thereof may include an aspect where the dielectric layer includes a plurality of periodic structures with reflection properties different from each other. For example, in FIG. 5(a), the dielectric layer 305 includes three types of periodic structures 321 to 323. In these periodic structures 321 to 323, the widths w31, w33, w35 of the first region 311, the widths w32, w34, w36 of the second region 312, and the pitches p31, p32, p33 of the second region 312 differ from each other. Thereby, the three types of the periodic structures 321 to 23 have different reflection properties. Also, as shown in FIG. 5(b), the relative reflection phase of the electromagnetic waves in the first region 311 and the second region 312 of dielectric layer 305 is 0 degrees (−360 degrees), and −180 degrees, respectively. Also, the pattern shape of the first region 311 and the second region 312 is a striped shape. In this case, as exemplified in FIG. 6, the incident wave W1 incident at a predetermined incident angle θ1 can be reflected at the reflection angles θ2, θ2′, and θ2″ according to the periodic structures, can be reflected with a spread, and the wavefront of the reflected wave W2 can be widened.

Also, when a spherical wave is reflected as a plane wave, for example, the pattern shape of the first region and the second region is preferably an arc striped shape.

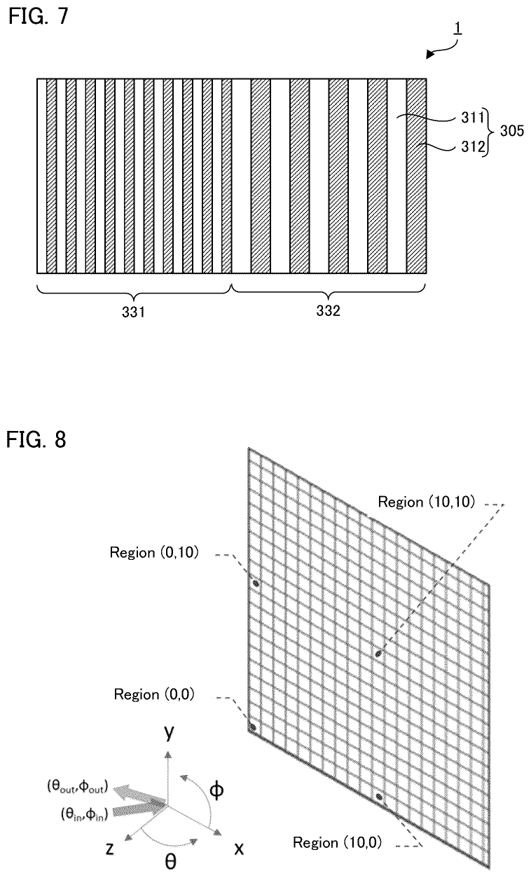

Also, the dielectric layer may include a plurality of regions with reflection properties different from each other, and the plurality of regions may be arranged in a plane. For example, in FIG. 7, the dielectric layer 305 includes two types of regions 331, 332 with reflection properties different from each other, and the two types of regions 331, 332 are arranged in a plane. In these regions 331, 332, for example, the width of the first region 311, the width of the second region 312, and the pitch of the second region 312 differ from each other. Thereby, the two types of regions 331, 332 have different reflection properties. In such an aspect, a plurality of coverage holes may be associated.

Further, for example, when the reflecting member described below is a frequency selective plate and includes multiple types of frequency selective surfaces (FSS) for selectively reflecting electromagnetic waves in different frequency bands from each other, the reflection properties of the dielectric layer may be designed according to the frequency selectivity of these frequency selective surfaces, and the dielectric layer may include regions with reflection properties different from each other. In this case also, for example, it can be arranged as shown in FIG. 7. In such an aspect, the dual band or more of the bands can be corresponded.

Also, when the incident wave and the reflected wave are plane waves, the dielectric layer includes a periodic structure in which the first region and the second region are repeatedly arranged. The term “periodic structure” refers to a structure in which the first region and the second region are periodically repeatedly arranged. In the first region and the second region in the periodic structure, in the periodic structure having the identical reflection properties, for example, the width of the first region and the second region, the pitch of the first region or the second region, the shape of the first region and the second region in a plan view, and the pattern shape of the first region and the second region may be the same, respectively. Also, in the case where the dielectric layer has a periodic structure, the periodic structures including different reflection properties can be combined as described above. In that case, the reflection properties of the periodic structure to be combined are appropriately designed according to the target reflection properties, and specifically, for example, the width of the first region and the second region, the pitch of the first region or the second region, the shape of the first region and the second region in a plan view, and the pattern shape of the first region and the second region in the periodic structure to be combined are appropriately set according to the target reflection properties.

In general, a reflective characteristic design in which a plane wave is reflected as a plane wave in a direction different from the regular reflection direction, for example, can be designed by, after resolving into incident and reflection properties as the in-plane x-direction and in-plane y-direction of the reflective plate, converting them to a reflective phase distribution in the x-direction and the y-direction, and incorporating them as the thickness distribution of the dielectric layer. For example, as shown in FIG. 8, a part of the frequency selective reflector in which a region of the same size capable of individually adjusting a reflection phase is arranged to 10×10 (i=10, j=10), is described as an example. The reflection phase δ_{i,j} determined in the region of the (i,j) position when the plane wave incident from the direction of the incident angle (θᵢₙ, φᵢₙ) is reflected by the plane wave in the direction of the reflection angle (θₒᵤₜ, φₒᵤₜ) is given by following equation.

$${δ}_{i , j} = 2 \prod \{ p \times i \times ( sin {θ}_{out} \times cos {φ}_{out} - sin {θ}_{i n} \times cos {φ}_{i n} ) + p \times j \times ( sin {θ}_{out} \times sin {φ}_{out} - sin {θ}_{i n} \times sin {φ}_{i n} ) \} / λ$$

Here, in the above equation, indicated are:
δ_{i,j}: the reflection phase of the cell region in the (i, j) position with respect to phase center (0, 0)
λ: wavelength of the reflected wave [m]
p: size of the region [m]
θᵢₙ: θ slope of incident wave
φᵢₙ: φ slope of incident wave
θₒᵤₜ: θ slope of reflected wave
φₒᵤₜ: φ slope of reflected wave.

The dielectric layer may be, for example, a single layer, and may be multiple layers. The dielectric layer may also include a substrate portion that can be a base and a concave and convex portion disposed on the substrate portion. Also, for example, the dielectric layer may be a single member in which all first region and second region are integrally formed, and may be one in which the individual first region and second region are formed separately, and the block-like first region and second region are arranged.

### (2) Properties of Dielectric Layer

The dielectric layer transmits electromagnetic waves in a particular frequency band and may or may not transmit electromagnetic waves in other frequency bands.

The dielectric loss tangent of the dielectric layer is preferably relatively small. The low dielectric loss tangent of the dielectric layer can reduce dielectric loss and reduce high frequency losses. Specifically, the dielectric loss tangent of the dielectric layer with respect to the electromagnetic waves of the target frequency is preferably 0.01 or less. Also, the dielectric loss tangent of the dielectric layer is the smaller the more preferable, and the lower limit value is not particularly limited.

Also, the dielectric constant of the dielectric layer is preferably relatively high. With the high dielectric constant of the dielectric layer, the effect of reducing the thickness of the dielectric layer can be expected. Specifically, the dielectric constant of the dielectric layer in the electromagnetic waves of the target frequency is preferably 2 or more, more preferably 2.5 or more, and when the difference in the reflection angle with respect to the regular reflection angle is increased, further more preferably 3 or more.

The dielectric loss tangent and the dielectric constant of the dielectric layer are measured by a resonator method. The dielectric loss tangent and the dielectric constant of the dielectric layer are measured in accordance with JIS C 2138:2007.

### (3) Material of Dielectric Layer

The material of the dielectric layer is not particularly limited if it is a dielectric capable of transmitting predetermined electromagnetic waves, and for example, a resin, glass, quartz, ceramics are used. That is, the dielectric layer may include a resin. In view of the ease of forming the dielectric layer, the resin is suitable among them.

Although the resin is not particularly limited if it is capable of transmitting predetermined electromagnetic waves, it is preferably the one that absorption of the electromagnetic waves is relatively low and the transmittance of the electromagnetic waves is preferably relatively high. Also, the resin preferably satisfies the aforementioned dielectric loss tangent, and more preferably satisfies the aforementioned dielectric constant. Examples of such resins may include polycarbonates, acrylic resins, ABS resins, PLA resins, olefinic resins, and copolymers thereof. In particular, the polycarbonate is suitable since it is excellent in dimensional stability and low in high frequency loss.

Also, the dielectric layer may further include a filler. The dielectric layer may contain a filler to adjust the dielectric constant and mechanical strength of the dielectric layer. The dielectric constant of the filler is preferably higher than the dielectric constant of the resin. This can increase the dielectric constant of the dielectric layer and reduce the thickness of the required dielectric layer. The high dielectric constant filler is not particularly limited, and examples thereof may include inorganic particles such as glass, and silica; and fine fibers.

The filler material, shape, size, and content may be appropriately chosen from the desired dielectric constant, mechanical strength, and difficulty of dispersibility, etc. The size of the filler needs to be sufficiently smaller than the effective wavelength of the electromagnetic waves that passes through the dielectric layer. When the effective wavelength of the electromagnetic waves is λ_{g}, the diameter of the filler sphere is preferably, for example, 0.01λ_{g} or less. However, it tends to be difficult to uniformly disperse as the size of the filler approaches the nanometer order, the load of the processing process may increase. Also, the content of the filler in the dielectric layer varies depending on the combination of the material of the dielectric and the filler, the shape of the filler, the size of the filler, and the like, and is appropriately adjusted.

Also, when the dielectric layer is formed by molding or the like using a mold, for example, a release agent, and an antistatic agent may be added to the dielectric layer. These can be used as appropriately selected from those generally used. In addition, it is preferable that the dielectric layer does not contain additives or fillers such as carbon black and metal particles that impart electrical conductivity.

### (4) Supporting Portion

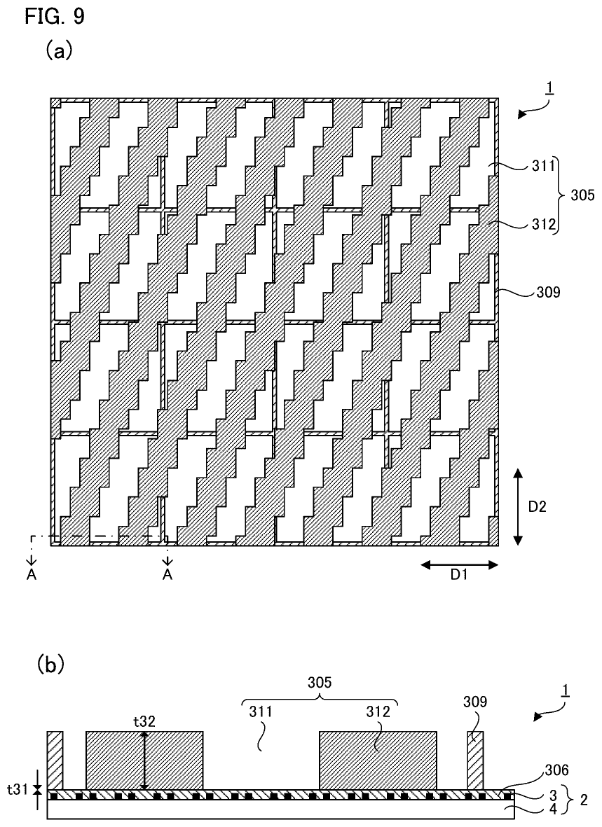

In the present embodiment, when the thickness of the first region is 0, the dielectric layer may include a supporting portion supporting the second region. For example, in FIGS. 9(a), (b), the thickness t31 of the first region 311 is 0, and the dielectric layer 305 includes a supporting portion 309 supporting the second region 312. Incidentally, FIG. 9(b) is an A-A line cross-sectional view of FIG. 9(a). When the dielectric layer includes the supporting portion, the strength can be increased. Also, when the thickness of the first region is 0, the plurality of the second regions can be integrated by the supporting portion so that the dielectric layer can be formed easily.

The position of the supporting portion is not particularly limited if it is a position capable of connecting and integrating the second regions. The supporting portion is preferably disposed at least on the periphery of the dielectric layer. The supporting portion may further be disposed on the location other than the periphery, that is, inside of the dielectric layer. In FIG. 9(a) for example, the supporting portion 309 is disposed on the periphery and the inside of the dielectric layer 305.

The thickness of the supporting portion may be the same as the thickness of the second region. In this case, the second region and the supporting portion can be formed at the same time. Also, the thickness of the supporting portion located on the periphery of the dielectric layer may be more than the thickness of the second region. As described later, when the first dielectric layer and the second dielectric layer are disposed by stacking in order from the reflecting member side, the thickness of the supporting portion located on the periphery of the second dielectric layer may be more than the thickness of the second region for only the second dielectric layer. As described later, when a cover member is disposed on the opposite side of the dielectric layer to the reflecting member, the cover member may be supported by the supporting portion, by making the thickness of the supporting portion located on the periphery of the dielectric layer more than the thickness of the second region.

The width of the supporting portion is preferably a width so as not to affect the reflection properties. When the thickness of the supporting portion is equivalent to the thickness of the second region, when the wavelength of the electromagnetic waves is regarded as λ, the width of the supporting portion is preferably λ or less, and more preferably λ/2 or less. If the width of the supporting portion is too large, it may affect the reflection properties. Also, when the width of the supporting portion is A/2 or less, resonance is less likely to occur, and the reflection intensity of the electromagnetic waves decreases abruptly. Meanwhile, the lower limit of the width of the supporting portion is not particularly limited if it is the width capable of supporting the second region.

Specifically, the width of the supporting portion is preferably 0.05 mm or more and 2 mm or less, more preferably 0.1 mm or more and 1 mm or less, and further preferably 0.2 mm or more and 0.5 mm or less. When the width of the supporting portion is too small, it may be difficult to form the supporting portion, and it may be difficult to support the second region. Also, when the width of the supporting portion is too large, it may affect the reflection properties.

The supporting portion disposed on the periphery of the dielectric layer is considered not to affect the reflection properties. Therefore, the width of the supporting portion disposed on the periphery of the dielectric layer is not particularly limited, it may be in the above range, and it may be out of the above range.

The width of the supporting portion disposed on the periphery of the dielectric layer may or may not be the same as the width of the supporting portion disposed on the location other than the periphery, that is, inside of the dielectric layer.

Also, the ratio of the total area of the supporting portion to the external area of the dielectric layer is preferably 30% or less, more preferably 20% or less, and further preferably 10% or less. If the ratio is too much, the performance of the frequency selective reflector may be degraded. Meanwhile, the lower limit of the ratio is not particularly limited if the second region can be supported by the supporting portion. In this case, as described above, since the supporting portion disposed on the periphery of the dielectric layer is considered not to affect the reflection properties, it is not included in the total area of the supporting portion described above.

Here, the ratio of the total area of the supporting portion with respect to the external area of the dielectric layer is measured by the following method. First, an region of 1/16 size is randomly selected for the entire dielectric layer. The ratio of the total area of the supporting portion with respect to the area of this selected region is determined. At this time, if the ratio is in the above range, the ratio in the selected region is considered to be the ratio of the total area of the supporting portion with respect to the external area of the dielectric layer. Meanwhile, if the ratio exceeds the above range, the ratio of the total area of the supporting portion with respect to the external area of the dielectric layer is determined for the entire dielectric layer. Also, the external area of the dielectric layer is the area of the region enclosed by the outermost peripheral contour line of the dielectric layer in the plan view of the dielectric layer. As shown in FIG. 1(a) for example, when the thickness of the first region of the dielectric layer is 0, the region surrounded by the outermost periphery outline of the dielectric layer when looking at the dielectric layer in a plane is the region surrounded by the outermost periphery outline of the region where the first region and the second region are combined, that is, in FIG. 1(a), it is the rectangular region including the shaded portion of the second region, and the external area of the dielectric layer is the area of the rectangular region.

Among them, the width of the supporting portion is preferably in the above range and the ratio of the total area of the supporting portion with respect to the external area of the dielectric layer is in the above range.

The shape of the supporting portion in a plan view is not particularly limited. The shape of the supporting portion, in a plan view, located on the periphery of the dielectric layer is appropriately selected according to the external shape of the dielectric layer, and examples thereof may include a frame shape. Also, examples of the shape of the supporting portion, in a plan view, located inside of the dielectric layer may include a lattice shape, and a striped shape.

### (5) Plurality of Dielectric Layer

In the present embodiment, when the thickness of the first region of the dielectric layer is 0, two dielectric layers may be disposed by stacking in the thickness direction.

Incidentally, in the following case where two dielectric layers are disposed by stacking in the thickness direction, one dielectric layer located on the side of the reflecting member, among the two dielectric layers, may be referred to as a first dielectric layer, and the other dielectric layer may be referred to as a second dielectric layer.

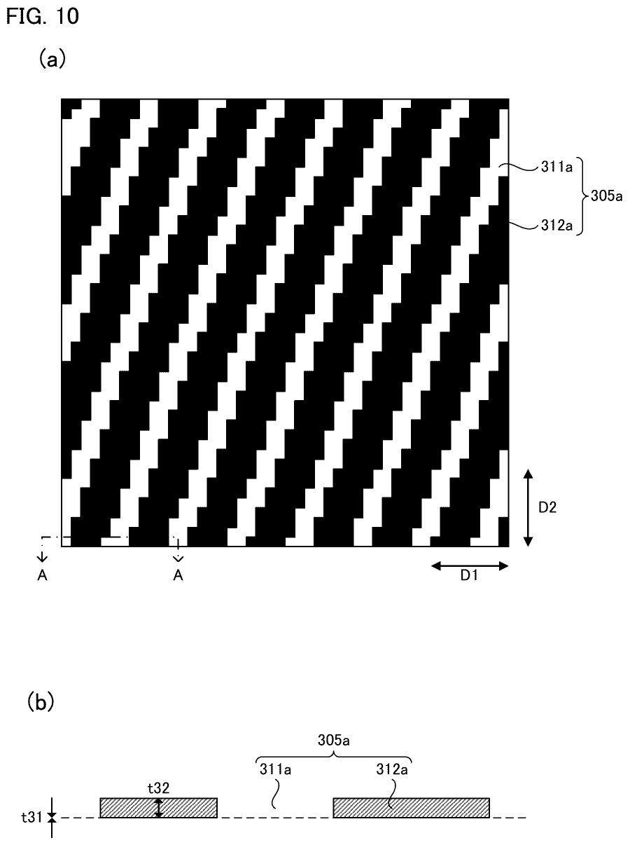

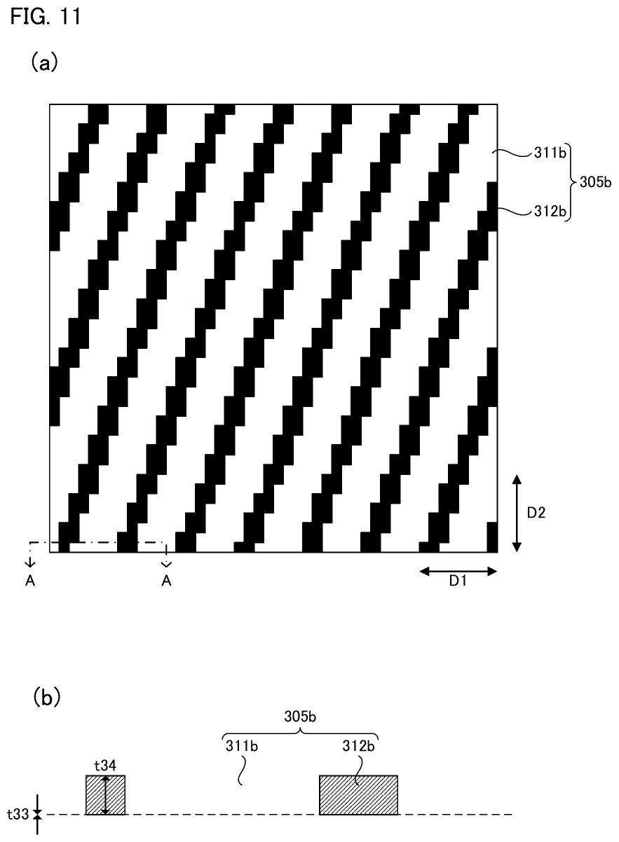

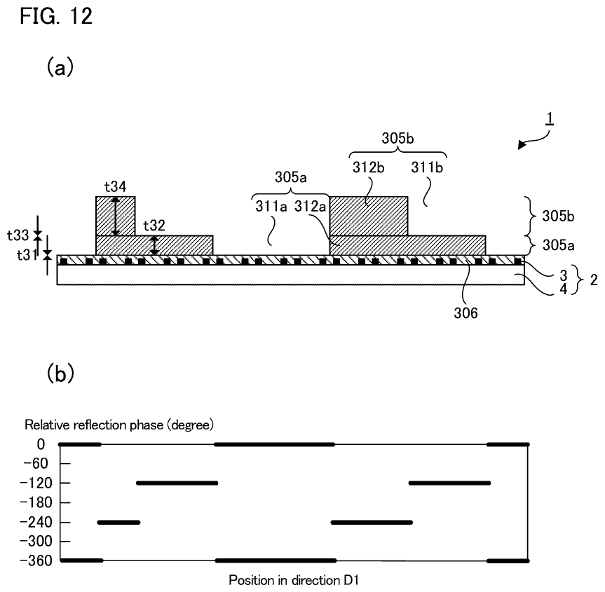

FIGS. 10(a), (b) are a schematic plan view and a schematic cross-sectional view exemplifying the first dielectric layer 305a. FIGS. 11(a), (b) are a schematic plan view and a schematic cross-sectional view exemplifying the second dielectric layer 305b. FIG. 12(a) is an example where the first dielectric layer 305a and the second dielectric layer 305b are disposed by stacking in the thickness direction. As shown in FIG. 12(a), the first dielectric layer 305a and the second dielectric layer 305b are disposed in this order from the reflecting member 2 side. As shown in FIGS. 10(a), (b), the first dielectric layer 305a includes a plurality of first regions 311a with thinner thickness t31 and a plurality of second regions 312a with thicker thickness t32. The thickness t31 of the first region 311a is 0. Also, as shown in FIGS. 11(a), (b), the second dielectric layer 305b includes a plurality of first regions 311b with thinner thickness t33 and a plurality of second regions 312b with thicker thickness t34. The thickness t33 of the first region 311b is 0.

FIG. 12(b) is a graph setting a horizontal axis as the position of the first dielectric layer 305a and the second dielectric layer 305b in the predetermined direction D1, and setting a vertical axis as a relative reflection phase when the electromagnetic waves are transmitted through the first dielectric layer 305a and the second dielectric layer 305b, reflected by the reflecting member 2 and emitted to the incident side of the electromagnetic waves by being transmitted through the first dielectric layer 305a and the second dielectric layer 305b again, wherein a value of the relative reflection phase of the electromagnetic waves is −360 degrees or more and 0 degrees or less; and it is an example of the relative reflection phase of electromagnetic waves in the first region and the second region of the dielectric layer in the frequency selective reflector shown in FIG. 12(a). As shown in FIG. 12(b), the relative reflection phase of the electromagnetic waves in the region where the first region 311a of the first dielectric layer 305a and the first region 311b of the second dielectric layer 305b are overlapped is 0 degrees (−360 degrees), respectively. Also, the relative reflection phase of the electromagnetic waves in the region where the second region 312b of the first dielectric layer 305a and the first region 311b of the second dielectric layer 305b are overlapped is −120 degrees. Also, the relative reflection phase of the electromagnetic waves in the region where the second region 312a of the first dielectric layer 305a and the second region 312b of the second dielectric layer 305b are overlapped is −240 degrees.

When the two dielectric layers are disposed by stacking in the thickness direction, by making the thickness of the first region of the first dielectric layer and the first region of the second dielectric layer 0, and by varying the thickness of the second region of the first dielectric layer and the second region of the second dielectric layer, the round-trip optical path length in the dielectric layer can be varied in the following regions: the region wherein the first region of the first dielectric layer and the first region of the second dielectric layer are overlapped; the region wherein the second region of the first dielectric layer and the first region of the second dielectric layer are overlapped; and the region wherein the second region the first dielectric layer and the second region of the second dielectric layer are overlapped, so that the reflection phase of the electromagnetic waves can be controlled. As a result, the reflection direction of the electromagnetic waves with respect to the predetermined incident direction can be controlled in any direction.

For the arrangement of the first dielectric layer and the second dielectric layer, the first region and the second region of the first dielectric layer and the first region and the second region of the second dielectric layer are preferably arranged so that the second region of the second dielectric layer is not located on the first region of the first dielectric layer; and the second region of the second dielectric layer is located on a part of the second region of the first dielectric layer.

### (6) Method for Forming Dielectric Layer

The method for forming the dielectric layer is not particularly limited if a dielectric layer having two types of thicknesses can be formed, and examples thereof may include cutting a resin sheet, laser processing, a shaping using a mold, a modeling by a 3D printer, and joining small piece parts. In the case of a forming method that does not use a mold, such as cutting, laser processing, and 3D printers, since customization according to the target reflection angle is easy, and thus it can be suitably used for tuning the design when designing and developing a large-scaled frequency selective reflector of which a special installation situation and simulation are difficult. In the case of using a mold, it may be shaped on a substrate made of a dielectric material. The substrate and the shaped resin in this case may be materials that are different from each other if they are materials that transmit predetermined electromagnetic waves. Also, for example, in the case of designing and producing the reflecting member and the dielectric layer separately, by preparing multiple types of dielectric layers having reflection properties to have a predetermined incident angle and reflection angle in advance, selecting the type of the dielectric layer according to the situation, and rotating the dielectric layer in the plane with the normal direction as an axis, when a fine adjustment of the reflection direction of the electromagnetic waves is performed, it may be more cost effective when the dielectric layers of the same specification are prepared at the same time, and in that case, the method for shaping using a mold is suitable.

Among the above, the cutting a resin sheet, and the laser processing are preferable. The production costs can be significantly reduced and production time can be significantly shortened. It is also possible to use highly durable materials such as engineering plastics that are not suitable for the molding and the 3D printers.

### 2. Reflecting Member

The reflecting member in the present embodiment is a member that reflects electromagnetic waves in a particular frequency band.

The reflecting member is not particularly limited if it reflects electromagnetic waves in a particular frequency band, and for example, it may reflect only electromagnetic waves in a particular frequency band, or it may reflect not only electromagnetic waves in a particular frequency band but also electromagnetic waves in other frequency bands. In particular, the reflecting member preferably includes a wavelength selecting function that reflects only electromagnetic waves in a particular frequency band.

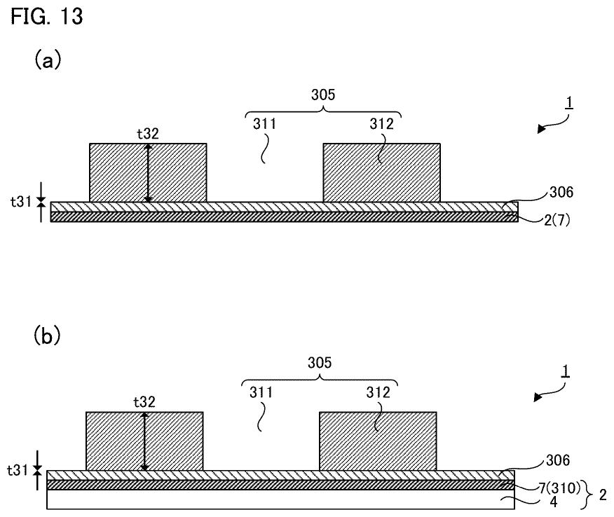

The reflecting member that reflects electromagnetic waves in a particular frequency band as well as other frequency bands may include, for example, a reflective layer disposed on the entire surface of the frequency selective reflector. For example, FIG. 13(a) is an example in which the reflecting member 2 is a reflective layer 7. In FIG. 13(a), the reflective layer 7 is disposed on the entire surface of the frequency selective reflector 1. Also, as exemplified in FIG. 13(b), the reflecting member 2 may include a dielectric substrate 4 and a reflective layer 7 disposed on the entire surface of the dielectric substrate 4. In this case, as described later, the reflective layer 7 may also serve as a ground layer 310.

The reflective layer is not particularly limited if it is capable of reflecting electromagnetic waves in a particular frequency band, and examples thereof may include conductive films such as a metal film, a metal oxide film, a carbon film, and a metal mesh. Examples of the metal oxide film may include ITO, IZO, AZO, GZO and ATO.

The thickness of the reflective layer is not particularly limited if the thickness is capable of reflecting electromagnetic waves in a particular frequency band, and it is appropriately set.

In addition, the reflecting member that reflects only a particular frequency band may be the one that includes a wavelength selecting function that reflects only electromagnetic waves in a particular frequency band, and examples thereof may include a frequency selective plate.

The frequency selective plate includes a frequency selective surface (FSS) that controls reflection and transmission of electromagnetic waves in a particular frequency band, and when functioning as a reflector for electromagnetic waves in a particular frequency band, a plurality of reflective elements (scattering elements) are arranged in a plane. Examples of the frequency selective plate may include, for example, one including a dielectric substrate and a plurality of reflective elements arranged on a dielectric layer side of the dielectric substrate. For example, FIG. 3 is an example in which the reflecting member 2 is a frequency selective plate, and the reflecting member 2 includes a dielectric substrate 4 and a plurality of reflective elements 3 arranged on the dielectric layer 305 side of the dielectric substrate 4. The frequency selective plate may be appropriately selected and used from conventionally known frequency selective plates.

The shape of the reflective element forming the frequency selective surface is not particularly limited, and examples thereof may include any shapes such as a ring shape, a cross shape, a square shape, a rectangular shape, a circular shape, an ellipse shape, a bar shape, a planar pattern such as a pattern divided into a plurality of adjacent regions, and a three-dimensional structure such as a through-hole via.

The reflection element may be, for example, a single layer or multiple layers. If the reflective element is a single layer, examples of the frequency selective plate may include the one in which a plurality of reflective elements is arranged on one side of the dielectric substrate. Also, when the reflective element is multiple layers, examples of the frequency selective plate may include the one in which a plurality of reflective elements is arranged on both sides of the dielectric substrate, one in which a dielectric substrate, a plurality of reflective elements, a dielectric substrate, and a plurality of reflective elements are arranged in the order, and one in which a conductor is disposed on entire surface of the surface farthest from the surface of the incident side of the electromagnetic waves.

The frequency reflective plate, that is, the reflecting member preferably includes a reflection phase control function controlling a reflection phase of the electromagnetic waves. In such a reflecting member, by varying the size or shape of the reflective element, the resonant frequency per reflective element can be varied and the reflection phase of the electromagnetic waves can be controlled. That is, the reflecting member may include multiple types of reflective elements of different sizes. Therefore, when the frequency selective plate has a reflection phase control function, the reflection properties of the electromagnetic waves can be controlled by controlling the reflection phase distribution of the electromagnetic waves by the thickness of the dielectric layer and the size or shape of the reflective element. Thus, for example, the reflection properties in two orthogonal directions (such as x-axis direction and y-axis direction) in the plane of the frequency selective reflector can be individually designed with the frequency selective plate and the dielectric layer, and the reflection properties of the desired electromagnetic waves can be obtained while suppressing the thickness of the dielectric layer.

General frequency selective surfaces may be applied as a frequency selective plate having a reflection phase control function. Although there are advantages and disadvantages in the design of these, it is possible to vary the reflection phase of the electromagnetic waves by varying the size or shape of these reflective element.

The different sizes of the reflective element are appropriately selected depending on the shape of the reflective element.

### Control of Reflection Direction of Electromagnetic Waves

In the frequency selective reflector of the present embodiment, by varying the thickness of the first region and the second region of the dielectric layer, the round-trip optical path length in the dielectric layer can be varied between the first region and the second region, and the relative reflection phase of the electromagnetic waves can be controlled. Also, in addition to the thickness of the first region and the second region, by adjusting the pitch of the first region or the second region, the size of the first region and the second region, and the pattern shape of the first region and the second region, for example, the reflection direction of electromagnetic waves injected from a predetermined direction can be controlled.

In addition, when the reflecting member is a frequency selective plate and is a member having a reflection phase control function, by varying the thickness of the first region and the second region of the dielectric layer, the round-trip optical path length in the dielectric layer can be varied between the first region and the second region, and also, by varying the size or shape of the reflective element of the reflecting member, the resonance frequency per reflective element can be varied to control the reflection phase of the electromagnetic wave; thereby, the degree of freedom of design related to the reflection properties control can be increased.

In this case, it is also possible to divide the reflection control direction in the reflecting member and the reflection control direction in the dielectric layer, and perform two-dimensional reflection direction control in the entire frequency selective reflector. Also, when the reflection control directions in the reflecting member and the dielectric layer are overlapped, for example, a reflection phase distribution to be reflected in a certain direction to some degree can be achieved by the reflecting member, and further fine adjustment can be performed in the dielectric layer. In this case, there is an advantage that the thickness of the dielectric layer can be reduced.

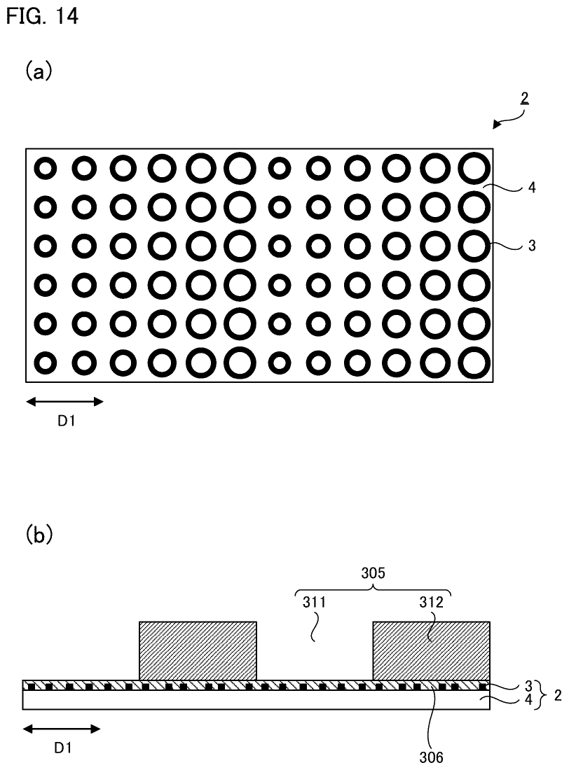

As the arrangement of the thickness distribution of the dielectric layer and the size distribution of the reflective element of the reflecting member, for example, as shown in FIGS. 14, the dielectric layer 305 and the reflecting member 2 can be arranged so that the thickness of the dielectric layer 305 becomes thicker as the size of the reflective element 3 of the reflecting member 2 increases. In such an aspect, the thickness of the dielectric layer can be suppressed. This makes it possible to reduce the weight and cost of the frequency selective reflector because the dielectric layer is thin. This makes the reflected waves less likely to hit the dielectric layer even when the reflection angle increases.

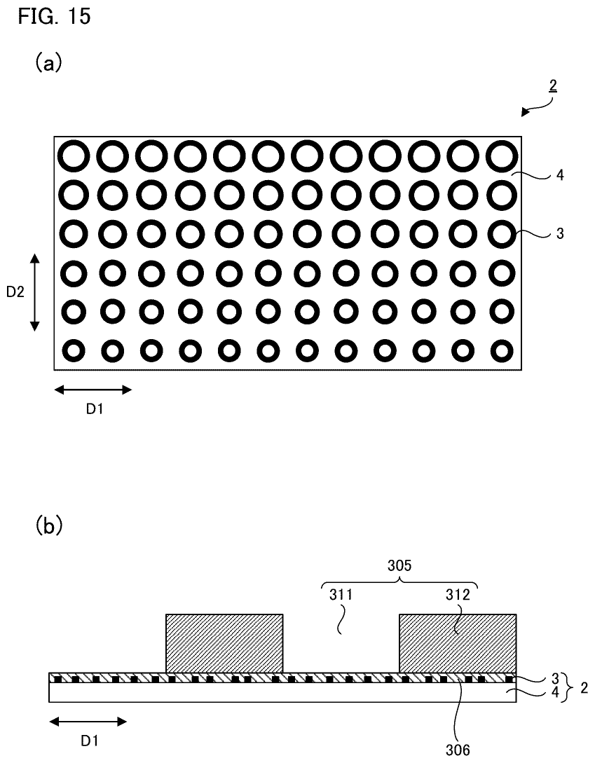

As an arrangement of the thickness distribution of the dielectric layer and the size distribution of the reflective element of the reflecting member, for example, as shown in FIGS. 15, the dielectric layer 305 and the reflecting member 2 may be arranged such that the size of the reflective element 3 of the reflecting member 2 is increased along the direction D2, and the thickness of the dielectric layer 305 becomes thicker along the direction D2.

Incidentally, in FIGS. 15, since the sizes of the reflective elements are different, the relative reflection phase of the electromagnetic waves in a unit region, at which each reflective element is disposed, is partially different according to the sizes of the reflective element.

Also, in the case of a specification in which the reflecting member and the dielectric layer are separately designed and combined, the reflection direction of the electromagnetic waves can be finely adjusted by rotating the dielectric layer in the plane with the normal direction as an axis with respect to the reflecting member to adjust the orientation of the first region and the second region of the dielectric layer relative to the reflecting member.

Also, as described above, in the dielectric layer, the reflection properties can be controlled by adjusting the pitch of the first region or the second region. For example, by shortening the pitch of the first region or the second region, the reflection angle of the electromagnetic waves can be increased, while the reflection angle of the electromagnetic waves can be reduced by lengthening the pitch of the first region or the second region.

Incidentally, as described above, the in-plane arrangement of the first region and the second region of the dielectric layer that achieves the in-plane distribution design of the reflection phase in the frequency selective reflector does not need to be in a fixed positional relationship with respect to the in-plane arrangement of the reflective element of the reflecting member, and even if the first region and the second region of the dielectric layer are shifted and arranged relative to the in-plane arrangement of the reflective element, there is no significant effect on the reflection properties. Thus, when the reflecting member is a frequency selective plate and is a member having a reflection phase control function, it is possible to independently design the dielectric layer and the reflecting member, respectively.

### 4. Other Configurations

The frequency selective reflector of the present embodiment may include other configurations as required in addition to the reflecting member and the dielectric layer described above.

### (1) Adhesive Layer

The frequency selective reflector of the present embodiment may include an adhesive layer between the reflecting member and the dielectric layer. The adhesive layer may bond the reflecting member and the dielectric layer. Further, when the reflecting member is a member in which a plurality of reflective elements is arranged, the adhesive layer may flatten the unevenness of the reflective element, and may suppress the influence of unevenness caused by the reflective element when the dielectric layer is laminated on the reflecting member. For example, in FIG. 1(b), an adhesive layer 306 is disposed between the reflecting member 2 and the dielectric layer 305.

The adhesive layer may be, for example, an adhesive agent or a pressure-sensitive adhesive agent, and may be appropriately selected from known adhesive agents and pressure-sensitive adhesive agents. In that case, the adhesive agent or the pressure-sensitive adhesive agent needs to be a non-conductor. In addition, when the adhesive agent or the pressure-sensitive adhesive agent is in a liquid state, it is preferable that the one can be uniformly spread and have a fluidity to the extent capable of removing the biting of bubbles. In addition, when the adhesive agent or the pressure-sensitive adhesive agent is in the form of a sheet, the thickness is preferably uniform, and it is preferable to have flexibility to the extent capable of following the unevenness of the bonding interface and suppressing the biting of bubbles.

The thickness of the adhesive layer is preferably uniform and in thickness to provide the desired adhesive force. Also, when the reflecting member is a member in which a plurality of reflective elements is arranged, the thickness of the adhesive layer is preferably equal to or greater than the thickness of the reflective element from the point of planarization. In this case, when the adhesive layer is thicker than the thickness of the reflective element, the reflective element is embedded in the adhesive layer. Preferably, the thickness of the adhesive layer is sufficiently smaller than the effective wavelength of the target electromagnetic waves, and when the effective wavelength of the electromagnetic waves is λ_{g}, specifically, it is preferably 0.01λ_{g} or less.

### (2) Space

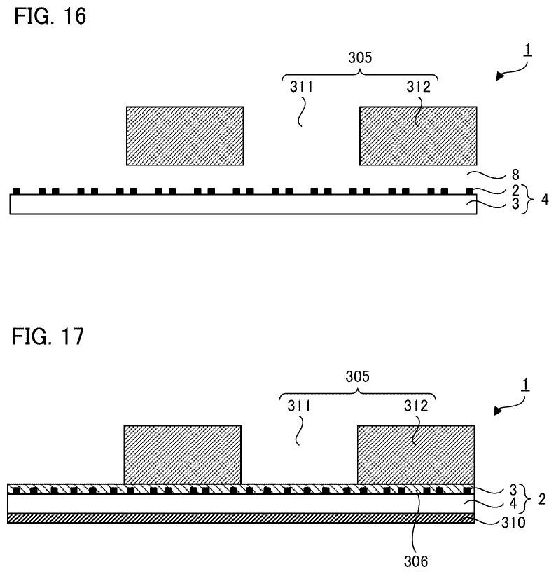

The frequency selective reflector of the present embodiment may include a space between the reflecting member and the dielectric layer. For example, in FIG. 16, a space 8 is arranged between the reflecting member 2 and the dielectric layer 305.

When a space is arranged between the reflecting member and the dielectric layer, the distance between the reflecting member and the dielectric layer is preferably constant. This makes it possible to align the optical path lengths in the space.

### (3) Cover Member

The frequency selective reflector of the present embodiment may include a cover member on an opposite side of the dielectric layer to the reflecting member. The cover member can protect the dielectric layer. Design can also be imparted by the cover member.

In addition, if the cover member is disposed, a frame-shaped spacer that supports the cover member may further be disposed on the outer periphery of the dielectric layer.

### (4) Ground Layer

The frequency selective reflector of the present embodiment may include a ground layer on an opposite side of the reflecting member to the dielectric layer. In addition, if the reflecting member reflects not only electromagnetic waves in a particular frequency band but also electromagnetic waves in other frequency bands, that is, if the reflecting member does not have wavelength selectivity, the reflecting member may include a reflective layer that also serves as a ground layer. The ground layer can block interference with objects present on the backside of the frequency selective reflector and suppress the occurrence of noise. For example, in FIG. 17, a ground layer 310 is disposed on an opposite side of the reflecting member 2 to the dielectric layer 305. Also, as shown in FIG. 13(b), the reflecting member 2 may include a dielectric substrate 4 and a reflective layer 7 disposed on the entire surface of the dielectric substrate 4, and the reflective layer 7 may also serve as the ground layer 310. The ground layer may be a part of the reflecting member that does not have wavelength selectivity. Incidentally, if the reflecting member does not have wavelength selectivity, the reflecting member also reflects electromagnetic waves other than the particular frequency band. However, the structure of the dielectric layer designed for the electromagnetic waves in an intended particular frequency band enables the electromagnetic waves in the particular frequency band to be reflected in the intended direction, so it can exhibit a function as a frequency selective reflector.

A commonly used conductive film such as a metal film, a metal mesh, a carbon film, and an ITO film may be used as the ground layer.

### (5) Planarizing Layer

The frequency selective reflector of the present embodiment may include a planarizing layer between the reflecting member and the dielectric layer. When the reflecting member is a member in which a plurality of reflective elements is arranged, the planarizing layer can flatten the unevenness of the reflective elements, and can suppress the influence of the unevenness due to the reflective elements when the dielectric layer is laminated on the reflecting member. It should be noted that the planarizing layer referred to herein is the one disposed separately from the adhesive layer, and example thereof may be an ionizing radiation cured resin layer disposed in the state of embedding the reflective element. Further, when a space is provided between the reflecting member and the dielectric layer, the planarizing layer may be provided with a function of protecting the reflective element.

### (6) Fixing Layer

When the frequency selective reflector of the present embodiment is used by being attached to, for example, a wall or the like, a fixing layer having a mechanism for attaching the frequency selective reflector may be disposed on the opposite side of the reflecting member to the dielectric layer. In order to inhibit interference among the fixing layer, the reflecting member and the dielectric layer, a metal layer may also be disposed between the fixing layer and the reflecting member, and the fixing layer may also serve as a metal layer. In addition, when the frequency selective reflector of the present embodiment is attached to a wall or the like, the fixing layer may have a mechanism for making the angle in the normal direction of the frequency selective reflector variable so that the deviation between the designed incident direction and the reflection direction of the electromagnetic waves, and the actual incident direction and the reflection direction of the electromagnetic waves can be corrected.

### (7) Anti-Reflective Layer

Because of the impact of reflections at the dielectric layer interface in the case of high frequencies, in the frequency selective reflector of the present embodiment, an anti-reflective layer may be disposed on the interface between the dielectric layer and the air as necessary. The anti-reflective layer may have, for example, a multilayer structure having a different dielectric constant, and may include a concave and convex structure smaller than the wavelength of the electromagnetic waves.

### (9) Interference Mitigation Layer

The frequency selective reflector of the present embodiment may include an interference mitigation layer, mitigating the property variation due to the interaction with the surface on which the frequency selective reflector is installed, on an opposite side of the reflecting member to the dielectric layer. The interference mitigation layer is not particularly limited as long as it has a dielectric constant close to air, and is capable of securing an appropriate distance which makes the interaction between the ground surface and the reflecting member small, and for example, foam such as urethane foam, having a dielectric constant close to air, can be used.

### 5. Other Points of Frequency Selective Reflector

The frequency selective reflector of the present embodiment reflects electromagnetic waves in a particular frequency band of 24 GHz or more in a direction different from a regular reflection direction. The frequency band of the electromagnetic waves is not particularly limited if it is 24 GHz or more, but in particular, it is preferably in the range of 24 GHz or more and 300 GHz or less. If the frequency band of the electromagnetic waves is in the above range, the frequency selective reflector of the present embodiment can be utilized for the fifth generation mobile communication system, so-called 5G.

The frequency selective reflector of the present embodiment can be used, for example, as a frequency selective reflector for communication, and is suitable as a frequency selective reflector for mobile communication, among others.

### II. Second Embodiment

In order to reflect high-intensity electromagnetic waves on a coverage hole, a large-area reflect array is required. However, it is difficult to produce a large-area reflect array due to the limitations of the production equipment.

Although it is not a reflect array, in the field of display devices, a tiling technique arranging a plurality of display devices next to each other is being developed as a large-area technique. Thus, using the tiling technique, by arranging a plurality of reflect arrays next to each other, it is considered that the area of the reflect array may be enlarged.

However, when the plurality of reflect arrays is arranged next to each other on a substrate, if the strength of the substrate is insufficient, the substrate may deflect or bend due to the weight of the reflect array. In this case, there is a problem that, since the reflect array is also deflected or bent, the desired reflection properties cannot be obtained. The lack of strength of the substrate also causes damage after the installation of the tiled reflect arrays. Meanwhile, if the thickness of the substrate is increased in order to increase the strength of the substrate, the overall weight is increased. Therefore, it is difficult to install the tiled reflect arrays. Also, there is a concern about falling after installation.

A main object of the present embodiment is to provide a frequency selective reflector capable of reducing the production cost and reducing the production time, and capable of further enlarging the area.

The frequency selective reflector in the present embodiment is a frequency selective reflector reflecting electromagnetic waves in a particular frequency band in a direction different from a regular reflection direction, the frequency selective reflector comprising: a substrate; a reflecting member disposed on one side of the substrate, and reflecting the electromagnetic waves; and a dielectric member disposed on an opposite side of the reflecting member to the substrate, and transmits the electromagnetic waves, the dielectric member includes a first dielectric layer and a second dielectric layer, in this order from the reflecting member side; the first dielectric layer includes a plurality of first dielectric portions disposed on an opposite side of the reflecting member to the substrate; the second dielectric layer includes a plurality of second dielectric portions disposed on an opposite side of the first dielectric layer to the reflecting member; the second dielectric portion is arranged so that the second dielectric portion overlaps a boundary of the adjacent first dielectric portions in a plan view; and the first dielectric portion includes a first dielectric pattern, and the second dielectric portion includes a second dielectric pattern.

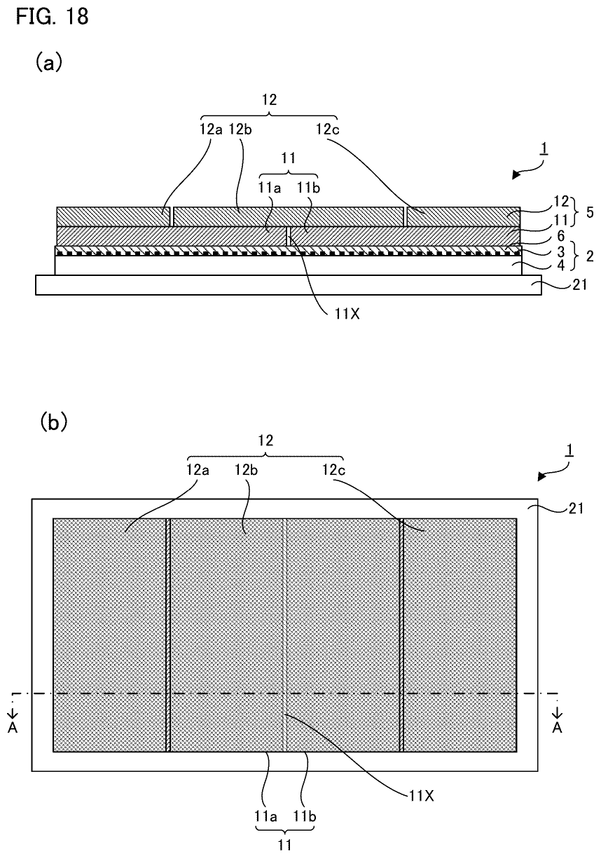

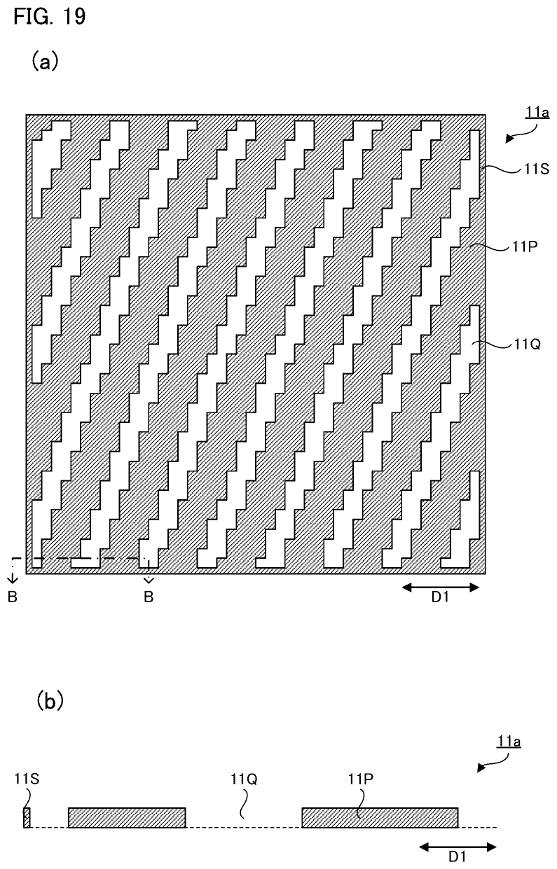

FIGS. 18(a), (b) are a schematic cross-sectional view and a plan view exemplifying the frequency selective reflector of the present embodiment, and FIG. 18(a) is a cross-sectional view of A-A line in FIG. 18(b). As shown in FIGS. 18(a), (b), frequency selective reflector 1 includes: a substrate 21; a reflecting member 2 disposed on one side of the substrate 21, and reflecting the electromagnetic waves in a particular frequency band; and a dielectric member 5 disposed on an opposite side of the reflecting member 2 to the substrate 21, and transmits the electromagnetic waves in a particular frequency band. Also, the frequency selective reflector 1 may include adhesive member 6 between the reflecting member 2 and the dielectric member 5. The dielectric member 5 includes a first dielectric layer 11 and a second dielectric layer 12, in this order from the reflecting member 2 side. The first dielectric layer 11 includes two first dielectric portions 11a, 11b disposed on an opposite side of the reflecting member 2 to the substrate 21. The second dielectric layer 12 includes three second dielectric portions 12a, 12b, 12c disposed on an opposite side of the first dielectric layer 11 to the reflecting member 2. The second dielectric portion 12b is arranged so that the second dielectric portion 12b overlaps a boundary 11X of the adjacent first dielectric portions 11a, 11b in a plan view

FIGS. 19(a), (b) are a schematic plan view and cross-sectional view exemplifying the first dielectric portion constituting the first dielectric layer in the present embodiment, and FIG. 19(b) is a cross-sectional view of B-B line in FIG. 19(a). The first dielectric portion 11a shown in FIGS. 19(a), (b) corresponds to the first dielectric portion 11a shown in FIGS. 18(a), (b). As shown in FIGS. 19(a), (b), the first dielectric portion 11a includes a first dielectric pattern 11P. Also, the first dielectric portion 11a may include a first supporting portion 11S supporting the first dielectric pattern 11P. In FIG. 19(a), the first supporting portion 11S is disposed, in a frame shape, on the periphery of the first dielectric portion 11a. Also, in the first dielectric portion 11a, the place other than the first dielectric pattern 11P and the first supporting portion 11S is an opening 110.

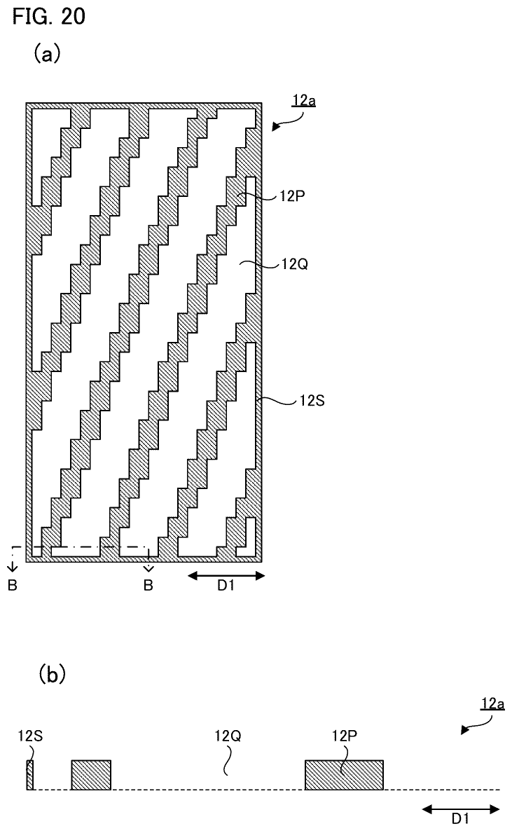

FIGS. 20(a), (b) are a schematic plan view and cross-sectional view exemplifying the second dielectric portion constituting the second dielectric layer in the present embodiment, and FIG. 20(b) is a cross-sectional view of B-B line in FIG. 20(a). The second dielectric portion 12a shown in FIGS. 20(a), (b) corresponds to the second dielectric portion 12a shown in FIGS. 18(a), (b). As shown in FIGS. 20(a), (b), the second dielectric portion 12a includes a second dielectric pattern 12P. Also, the second dielectric portion 12a may include a second supporting portion 12S supporting the second dielectric pattern 12P. In FIG. 20(a), the second supporting portion 12S is disposed, in a frame shape, on the periphery of the second dielectric portion 12a. Also, in the second dielectric portion 12a, the place other than the second dielectric pattern 12P and the second supporting portion 12S is an opening 12Q.

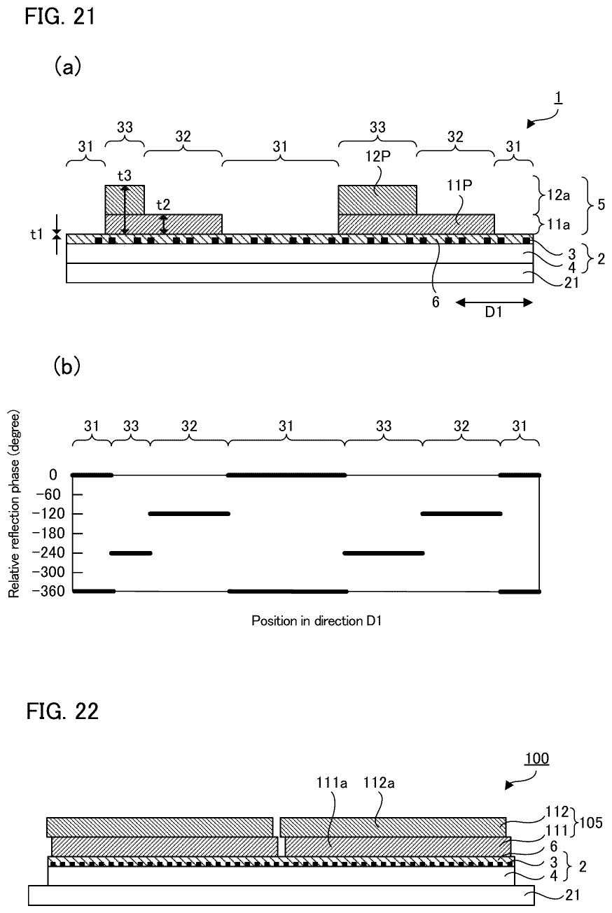

FIG. 21(a) is a schematic cross-sectional view exemplifying the frequency selective reflector in the present embodiment. The first dielectric portion 11a and the second dielectric portion 12a shown in FIG. 21(a) correspond to the first dielectric portion 11a and the second dielectric portion 12a shown in FIGS. 18(a), (b), and correspond to the first dielectric portion 11a shown in FIGS. 19(a), (b) and the second dielectric portion 12a shown in FIGS. 20(a), (b). As shown in FIG. 21(a), the dielectric member 5 includes an A1 region 31 which does not include the first dielectric pattern 11P and the second dielectric pattern 12P from the reflecting member 2 side; an A2 region 32 including only the first dielectric pattern 11P from the reflecting member 2 side; and an A3 region 33 including the first dielectric pattern 11P and the second dielectric pattern 12P from the reflecting member 2 side.

In the dielectric member 5, since the A1 region 31 does not include the first dielectric pattern 11P and the second dielectric pattern 12P; the A2 region 32 includes only the first dielectric pattern 11P; and the A3 region 33 includes the first dielectric pattern 11P and the second dielectric pattern 12P, the thickness t1 of the A1 region 31 is 0, and the thickness t1 of the A1 region 31, the thickness t2 of the A2 region 32, and the thickness t3 of the A3 region 33 differ from each other. Therefore, the round-trip optical path length when the electromagnetic waves are transmitted through the dielectric member 5, reflected by the reflecting member 2, and emitted to the incident side of the electromagnetic waves by being transmitted through the dielectric member 5 again, are different in the A1 region 31, the A2 region 32, and the A3 region 33. The differences in round-trip optical path length in these dielectric members, that is, the optical path difference, will produce a relative reflection phase difference.

The description about “optical path length” is the same as the description about “optical path length” in the first embodiment described above. The optical path length actually refers to the effective distance when the electromagnetic waves travel through the dielectric member.

FIG. 21(b) is a graph setting a horizontal axis as the position of the dielectric member 5 in the predetermined direction D1, and setting a vertical axis as a relative reflection phase when the electromagnetic waves are transmitted through the dielectric member 5, reflected by the reflecting member 2 and emitted to the incident side of the electromagnetic waves by being transmitted through the dielectric member 5 again, wherein a value of the relative reflection phase of the electromagnetic waves is −360 degrees or more and 0 degrees or less. Also, FIG. 21(b) is an example of the relative reflection phase of electromagnetic waves in the A1 region, the A2 region, and the A3 region of the dielectric member in the frequency selective reflector shown in FIG. 21(a). As shown in FIG. 21(b), the relative reflection phase of the electromagnetic waves in the A1 region 31, the A2 region 32 and the A3 region 33 of dielectric member 5 is 0 degrees (−360 degrees), −120 degrees, and −240 degrees, respectively.

The descriptions about “reflection phase” and “relative reflection phase” are the same as the descriptions about “reflection phase” and “relative reflection phase” in the first embodiment described above. In the descriptions of “reflection phase” and “relative reflection phase” in the first embodiment above, “dielectric layer” is read as “dielectric member” and “first region and second region of dielectric layer” is read as “each region of dielectric member”.

Also, when the dielectric member includes only the first dielectric layer and the second dielectric layer as the dielectric layer, the region where the delay of the reflection phase is the small, among the A1 region, the A2 region, and the A3 region of the dielectric member, is generally the A1 region with the thickness of 0. Also, when a dielectric member includes three or more dielectric layers, the region where the delay of the reflection phase is the smallest, among each region of the dielectric member, is generally the region whose thickness is 0, and which does not include any dielectric pattern constituting each dielectric layer.

As described above, in the dielectric member 5, by varying the thickness t1 of the A1 region 31, the thickness t2 of the A2 region 32, and the thickness t3 of the A3 region 33, the round-trip optical path length in the dielectric member 5 is varied, and the relative reflection phase of the electromagnetic waves is varied. In conventional reflect arrays, the reflection direction of electromagnetic waves is controlled utilizing the properties that the electromagnetic waves travel in the normal direction of the same phase plane. In the frequency selective reflector of the present embodiment, the reflection direction of the electromagnetic waves can be controlled similarly. In the frequency selective reflector with reflection properties as shown in FIG. 21(b) for example, when a plane wave is injected directly above the frequency selective reflector, the line (plane) connecting the center portion of the A1 region 31, the center portion of the A2 region 32, and the center portion of the A3 region 33 in order can be regarded as the same phase plane of the reflected wave, and the reflected wave proceeds in the normal direction of the plane.

Therefore, as exemplified in FIG. 2, the incident wave W1 of the electromagnetic wave can be reflected in a direction different from the regular reflection (specular reflection) direction.

Therefore, according to the frequency selective reflector of the present embodiment, by, for example, forming the A1 region which does not include the first dielectric pattern and the second dielectric pattern; the A2 region including only the first dielectric pattern; and an A3 region including the first dielectric pattern and the second dielectric pattern, and varying the thickness of the A1 region, the thickness of the A2 region, and the thickness of the A3 region, in the dielectric member, the round-trip optical path length in the dielectric member can be varied between the A1 region, the A2 region, and the A3 region, and the reflection phase of the electromagnetic waves can be controlled. As a result, the reflection direction of the electromagnetic waves with respect to the predetermined incident direction can be controlled in any direction.

Also, in the present disclosure, the dielectric portion constituting each dielectric layer can be formed by various techniques such as a hollowing processing such as cutting, and laser processing; and 3D printer. Therefore, there is no need for a photomask unlike photolithographic processing of a metal layer in a conventional reflect array. Thus, the desired dielectric portion can be formed relatively inexpensively and in a short time. Particularly, when the dielectric portion is formed by, for example, a hollowing processing such as cutting, and laser processing, the production costs can be significantly reduced and production time can be significantly shortened. Therefore, it is easy to respond to the needs of small quantities and a wide variety of products. It is also possible to use highly durable materials such as engineering plastics that are not suitable for the molding and the 3D printers. Further, when the dielectric member includes only the first dielectric layer and the second dielectric layer as the dielectric layer, the maximum thickness of the dielectric member may be reduced. Therefore, in the frequency selective reflector of the present embodiment, although the reflection direction of the electromagnetic waves is controlled by controlling the reflection phase of the electromagnetic waves by the thickness of each region of the dielectric member, a thin type frequency selective reflector may be obtained.

Also, in the frequency selective reflector in the present embodiment, the thickness of each region of the dielectric member and the pitch of each region of the dielectric member affect the control of the reflection properties. Since the range of possible processing of the thickness of each region of the dielectric member and the pitch of each region of the dielectric member is relatively wide, and thus, for example, the incident angle or the reflection angle of the electromagnetic waves can be increased, and the control range of the reflection properties can be widened. Furthermore, with respect to the thickness of each region of the dielectric member and the pitch of each region of the dielectric member, the margin of dimensional processing accuracy for achieving the desired reflection phase is relatively wide, and thus the desired reflection properties can be easily obtained and the influence of dimensional variations can be reduced.

Also, in the frequency selective reflector of the present embodiment, the reflecting member may be a frequency selective plate that reflects only particular electromagnetic waves. FIG. 3 is a schematic plan view exemplifying the reflecting member, and it is an example of the reflecting member shown in FIG. 18(a). As shown in FIG. 18(a) and FIG. 3, the reflecting member 2 is one in which a plurality of ring-shaped reflective elements 3 is arranged, and it includes dielectric substrate 4, and a plurality of reflective elements 3 arranged on an opposite side of the dielectric substrate 4 to the substrate 21.

Further, in the frequency selective reflector of the present embodiment, the reflecting member may be a frequency selective plate that reflects only particular electromagnetic waves, and may be a member including a reflection phase control function that controls the reflection phase of the electromagnetic waves. In such a reflecting member, by varying the size or shape of the reflective element, the resonant frequency per reflective element can be varied and the targeted reflection phase of the electromagnetic waves can be controlled. In this case, the reflection phase of the electromagnetic waves can be controlled not only by the thickness of each region of the dielectric member but also by the size or shape of the reflective element, and the degree of freedom of design for controlling the reflection properties can be improved.

Thus, in the frequency selective reflector of the present embodiment, when such a reflecting member is used, the degree of freedom in controlling the reflection properties can be widened by combining with the dielectric member. For example, an operation where the reflection properties in top and bottom directions may be prepared with multiple types of reflecting members and combined with a dielectric member that adjusts the reflection properties in horizontal direction, is one example.

The inventors of the present disclosure also simulated the reflection properties of electromagnetic waves in a particular frequency band when the reflecting member is a frequency selective plate including a reflective element that reflects only particular electromagnetic waves in the frequency selective reflector including the reflecting member and the dielectric member of the present disclosure. The results have found that when the thicknesses of each region of the dielectric member are varied to vary the round-trip optical path length in the dielectric member for each region, the deviation of the reflection phase was greater compared to the deviation of the reflection phase in the reflective element due to the proximity of the dielectric member to the reflecting member (frequency selective plate). Also, it has been discovered that the design of substantial reflection properties can be substantially determined by the design of the thickness of each region of the dielectric member. At this time, the resonant frequency of the reflective element varies depending on the presence or absence of the adjacent dielectric member, but if the design is performed on the premise that the dielectric member is present, the practical problem is solved. Further, it was found out that the in-plane arrangement of each region of the dielectric member that achieves the in-plane distribution design of the reflection phase in the frequency selective reflector does not need to be in a fixed positional relationship with respect to the in-plane arrangement of the reflective element of the reflecting member, and even if each region of the dielectric member is shifted and arranged relative to the in-plane arrangement of the reflective element, there is no significant effect on the reflection properties.

Thus, when the dielectric member and the reflecting member as described above are combined and used in the frequency selective reflector of the present embodiment, it is possible to design each of the dielectric member and the reflecting member independently, and combine the two. In this case, a dielectric member for achieving reflection properties according to the use environment may be made each time, and a plurality of specifications may be prepared in advance. As a result, it is possible to more easily design the reflection direction of the frequency selective reflector that varies according to the use environment. As described above, in the case of adjusting the total reflection properties of the frequency selective reflector by the combination of the respective reflection phase distributions of the reflecting member and the dielectric member, the accuracy of the misalignment between the reflecting member and the dielectric member according to the required specification is required. On the other hand, when the reflection properties of the frequency selective reflector are adjusted only by the reflection phase distribution of the dielectric member, the accuracy of the misalignment between the reflecting member and the dielectric member is not required so much.

Also, according to the frequency selective reflector of the present embodiment, in the dielectric member, a plurality of first dielectric portions is arranged next to each other in the first dielectric layer, and a plurality of second dielectric portions is arranged next to each other in the second dielectric layer. In this way, the present disclosure uses tiling technique, and the area of the frequency selective reflector may be increased.

However, as described above, when the tiling technique is used for the frequency selective reflector, if the strength of the substrate is insufficient, the substrate may deflect or bend due to the weight of the dielectric member and the reflecting member. In this case, there is a problem that, since the dielectric member and the reflecting member are also deflected or bent, the desired reflection properties cannot be obtained.

For example, when the first dielectric layer 111 and the second dielectric layer 112 are stacked in the dielectric member 105, and when the first dielectric layer 111 is constituted by arranging a plurality of first dielectric portions 111a next to each other, and the second dielectric layer 112 is constituted by arranging a plurality of second dielectric portions 112a next to each other, as the frequency selective reflector 100 shown in FIG. 22, the first dielectric portion 111a and the second dielectric portion 112a may be stacked so that the positions of the upper layer and the lower layer align with each other. However, considering the alignment accuracy, it is difficult to stack the first dielectric portion 111a and the second dielectric portion 112a so that the position of the end portion of the first dielectric portion 111a is aligned with the position of the end portion of the second dielectric portion 112a. Therefore, it is difficult to arrange the first dielectric portion 111a so that the adjacent first dielectric portions 111a are in contact with each other, and arrange the second dielectric portion 112a so that the adjacent second dielectric portions 112a are in contact with each other. Therefore, due to the positions of the end portions of the dielectric portions being not aligned in the upper layer and the lower layer, and therefore the adjacent dielectric portions being arranged apart, the substrate is easily deflected or bent at the boundary of the adjacent dielectric portions.

In particular, in the dielectric member, since the first dielectric portion constituting the first dielectric layer includes the first dielectric pattern; and the second dielectric portion constituting the second dielectric layer includes the second dielectric pattern; and each dielectric portion includes an opening, the strength of each dielectric portion itself is relatively low. Therefore, the problem described above is noticeable.

In contrast to the above, in the dielectric member according to the present disclosure, the second dielectric portion is arranged so that the second dielectric portion overlaps a boundary of the adjacent first dielectric portions in a plan view. Thereby, the strength of the dielectric member as a whole can be increased. Therefore, the deflection or bending of the substrate can be suppressed at the boundary of the adjacent first dielectric portions or the boundary of the adjacent second dielectric portions. As the result, the deflection or bending of each dielectric layer due to the deflection or bending of the substrate can also be suppressed. Therefore, the desired reflection properties can be obtained while increasing the area of the frequency selective reflector. Also, it is not necessary to increase the thickness of the substrate in order to increase the strength of the substrate, so that the reduction of the weight and thickness of the frequency selective reflector is possible.

Each configuration of the frequency selective reflector of the present embodiment will be hereinafter explained.

### 1. Substrate

The substrate in the present embodiment is a member supporting the reflecting member and the dielectric member.

### (1) Substrate

The substrate is not particularly limited as long as it is a substrate capable of supporting the reflecting member and the dielectric member, and examples thereof may include resin substrates. The resin substrate may be any one of, for example, a resin film, a resin sheet, and a resin board.

The substrate may be light transmissive, and may be light non-transmissive. These optical properties of the substrate are appropriately selected according to the method for detecting the first alignment mark and the arrangement of the first alignment mark described later. For example, when the first alignment mark is detected by the transmitted light, the substrate is light transmissive. Also, for example, when the first alignment mark is detected by the reflected light, the substrate may be light transmissive, and may be light non-transmissive. Also, as described below, for example, when the first alignment mark is disposed on the opposite side of the substrate to the reflecting member and dielectric member, the substrate is light transmissive.

In the present descriptions, “light transmissive” means transmissivity to visible light. Also, “light non-transmissive” means non-transmissivity to visible light.

Also, the substrate may be X-ray transmissive. When the substrate is X-ray transmissive, the first alignment mark is detected by transmitted X-rays.

The transmittance of the substrate is not particularly limited if the first alignment mark can be detected by the transmitted light or the reflected light, and can be appropriately set according to, for example, the material, or the thickness of the substrate.

The resin constituting the resin substrate is not particularly limited, and examples thereof may include engineering plastics.

Also, the resin substrate may include, for example, an additive such as an ultraviolet absorber, a light stabilizer, an antioxidant, and a coloring agent, if necessary.

The thickness of the resin substrate is not particularly limited.

### (2) First Alignment Mark

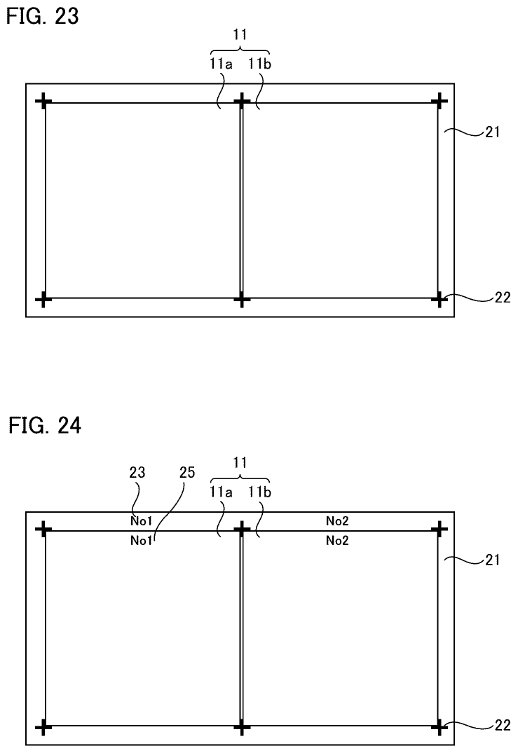

The substrate preferably includes an alignment mark. The alignment of the plurality dielectric portions constituting each dielectric layer can be performed using an alignment mark of the substrate. Incidentally, for convenience, the alignment mark provided on the substrate is referred to as a first alignment mark. In FIG. 23 for example, the substrate 21 includes a first alignment mark 22. In FIG. 23, the reflecting member is omitted and only the first dielectric layer among the dielectric member is shown.

The first alignment mark may be light non-transmissive. Also, the first alignment mark may be light reflective. These optical properties of the first alignment marks are appropriately selected according to whether the first alignment mark is detected by transmitted light or reflected light. For example, when the first alignment mark is detected by the transmitted light, the first alignment mark is light non-transmissive. Also, for example, when the first alignment mark is detected by the reflected light, the first alignment mark is light reflective.

In the present descriptions, “light reflective” means reflectivity with respect to visible light.

Also, the first alignment mark may be X-ray transmissive. When the substrate and the first alignment mark are X-ray transmissive, the first alignment mark is detected by transmitted X-rays.

The transmittance or the reflectance of the first alignment mark are not particularly limited if the first alignment mark can be detected by transmitted light or the reflected light, and can be appropriately set according to, for example, the material, or the thickness. of the first alignment mark.

The shape of the first alignment mark in plan view is not particularly limited, and is similar to the shape of a general alignment mark in plan view. Examples of the shape of the first alignment mark in plan view may include a cross shape, an X shape, a shape of a square with a cross inside, a parallel crosses shape, a circular shape, a rectangular shape, a triangular shape, a double circular shape, a double rectangular shape, a hollow circular shape, a hollow rectangular shape, and a combination of these.

The size or line width of the first alignment mark is not particularly limited if the first alignment mark can be detected.

The number of the first alignment marks is not particularly limited if it is capable of aligning the plurality of dielectric portions constituting each dielectric layer.

The position of the first alignment mark in the substrate is appropriately set according to the desired position of the disposed plurality of dielectric portions constituting each dielectric layer.

The first alignment mark may be disposed on the reflecting member and dielectric member side of the substrate, and may be disposed on the opposite side of the substrate to the reflecting member and the dielectric member.

The thickness the first alignment mark is not particularly limited if it is a thickness capable of forming the first alignment mark in high precision, and is appropriately adjusted according to the optical properties of the first alignment mark.

Examples of the material of the first alignment mark may include metal materials such as metals, alloys, metal oxides, and metal nitrides; and resins. For resins, a coloring agent can be added. Among them, the resin is preferable, considering the effect of the reflection of electromagnetic waves due to the first alignment mark.

The method for forming the first alignment mark is appropriately selected according to the material of the first alignment mark. In the case of metallic materials, examples of the method for forming the first alignment mark may include a photolithography method, a mask film deposition method, a lift-off method, and a printing method. Also, in the case of the resin, examples of the method for forming the first alignment mark may include a photolithography method and a printing method.

### (3) First Identification Mark

In the present disclosure, the substrate may include an identification mark for identifying the position of the plurality of dielectric portions constituting each dielectric layer. Incidentally, for convenience, the identification mark provided on the substrate is referred to as a first identification mark.

For example, in FIG. 24, the substrate 21 includes first identification marks 23 of “No 1” and “No 2”. In FIG. 24, the reflecting member is omitted and only the first dielectric layer among the dielectric member is shown. By the substrate including the first identification mark, the position of the plurality of dielectric portions constituting each dielectric layer can be easily identified, so that the plurality of dielectric portions constituting each dielectric layer can be disposed reliably and easily in the correct positions. In particular, as described below, it is useful when the dielectric member includes a plurality of reflective regions with different reflective properties from each other.

The first identification mark may be light non-transmissive. Also, the first identification mark may be light reflective. As similar to the first alignment mark, these optical properties of the first identification mark are appropriately selected according to whether the first identification mark is detected by transmitted light or reflected light.

The transmittance and the reflectance of the first identification mark are not particularly limited if the first identification mark can be detected by transmitted light or the reflected light, and can be appropriately set according to, for example, the material, or the thickness of the first identification mark.

The first identification mark is not particularly limited if it is a mark that is able to be identified, and examples thereof may include letters, symbols, and figures. Specific examples may include a code. Also, the first identification mark may be data capable of being recognized by Optical Character Recognition (OCR).

The size or line width of the first identification mark is not particularly limited if the first identification mark can be detected.

The position of the first identification mark in the substrate is not particularly limited if it is capable of identifying the positions of the plurality of dielectric portions constituting each dielectric layer.

The first identification mark may be disposed on the reflecting member and dielectric member side of the substrate, and may be disposed on the opposite side of the substrate to the reflecting member and the dielectric member.

The thickness, material of and the method for forming the first identification mark are the same as the thickness, material of and the method for forming of the first alignment mark.

When the material of the first identification mark is identical to the material of the first alignment mark, the first alignment mark and the first identification mark can be formed at the same time.

### 2. Dielectric Member

The dielectric member in the present embodiment is a member that is disposed on the opposite side of the reflecting member to the substrate, and transmits the electromagnetic waves in a particular frequency band. The dielectric member is disposed at an incident side of the electromagnetic waves with respect to the reflecting member. Also, the dielectric member includes a first dielectric layer and a second dielectric layer, in this order from a reflecting member side. The first dielectric layer includes a plurality of first dielectric portions disposed on an opposite side of the reflecting member to the substrate, and the second dielectric layer includes a plurality of second dielectric portions disposed on an opposite side of the first dielectric layer to the reflecting member.

### (1) Arrangement of Dielectric Portion

In the dielectric member in the present embodiment, the second dielectric portion is arranged so that the second dielectric portion overlaps a boundary of the adjacent first dielectric portions in a plan view.

“Boundary of the adjacent first dielectric portions” means the boundary between the end portion of one first dielectric portion and the end portion of the other first dielectric portion in two adjacent first dielectric portions. The end portion of the first dielectric portion is the portion that protrudes the most on the side surface of the first dielectric portion.

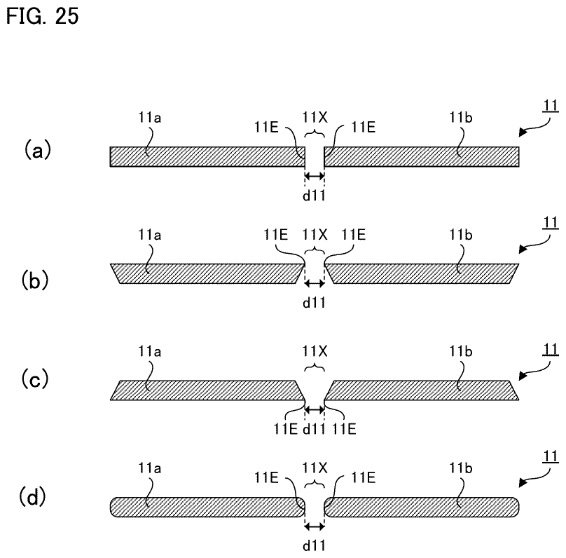

FIGS. 25(a) to (d) show examples of the end portion 11E of first dielectric portions 11a, 11b and a boundary 11X of adjacent first dielectric portions 11a, 11b. FIG. 25(a) shows an example where the side surfaces of the first dielectric portions 11a, 11b are perpendicular. FIGS. 25(b), (c) show examples where the side surfaces of the first dielectric portions 11a, 11b are inclined. FIG. 25(d) shows an example where the side surfaces of the first dielectric sections 11a, 11b are curved.

Also, “the second dielectric portion is arranged so that the second dielectric portion overlaps a boundary of the adjacent first dielectric portions in a plan view” means that the second dielectric portion is arranged so that the second dielectric portion overlaps at least a part of the boundary of the adjacent first dielectric portions in a plan view. That is, among the boundaries of the adjacent first dielectric portions, there may be a part where the second dielectric portion does not overlap in the plan view.

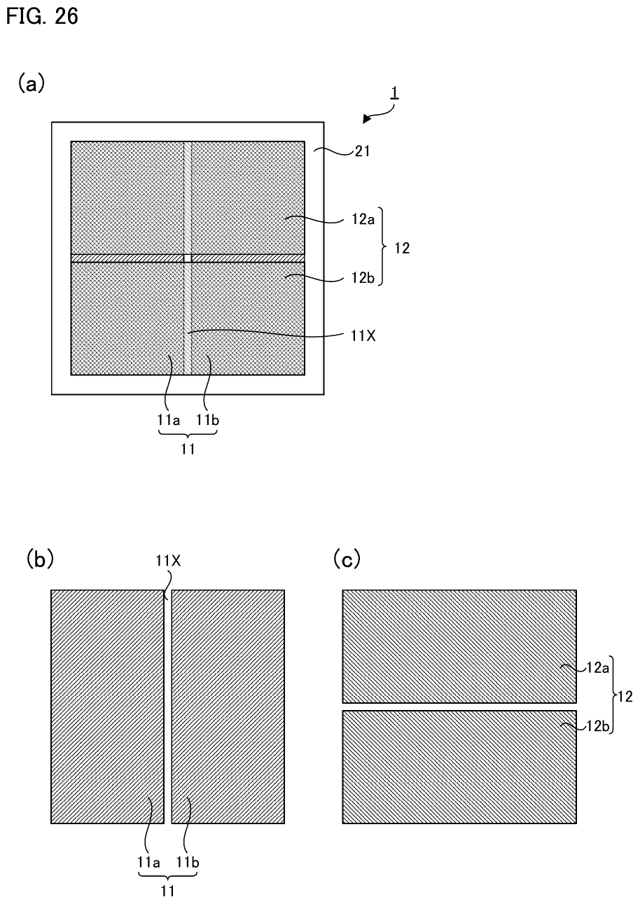

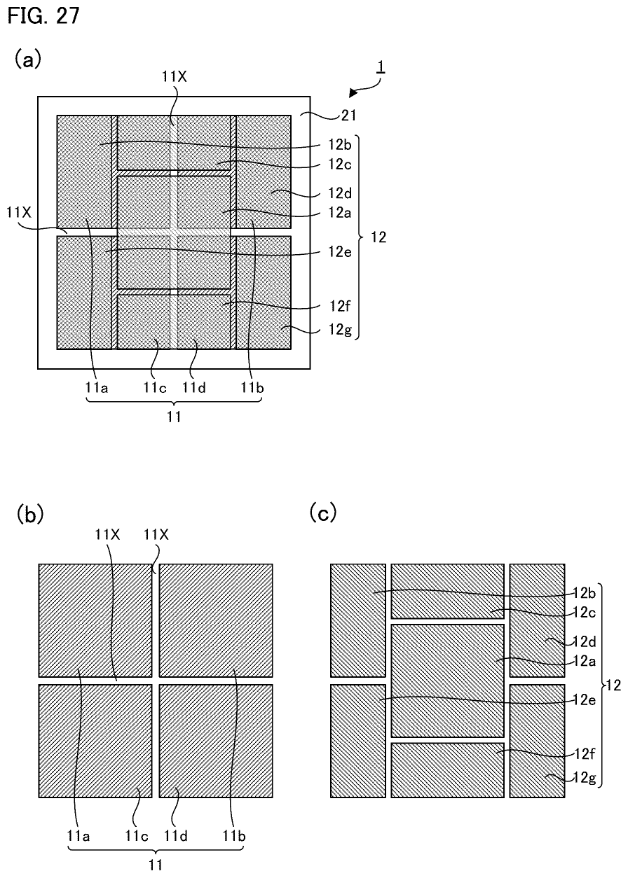

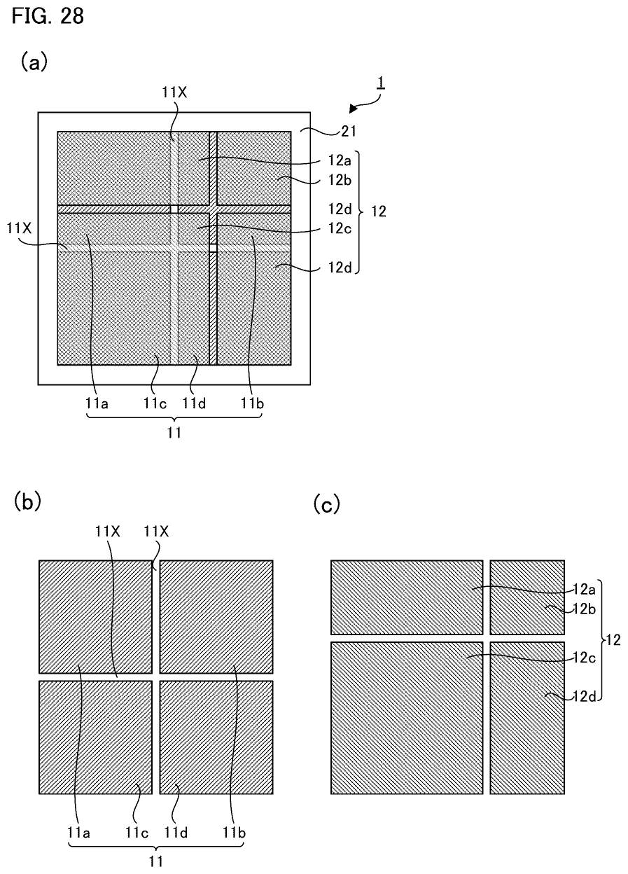

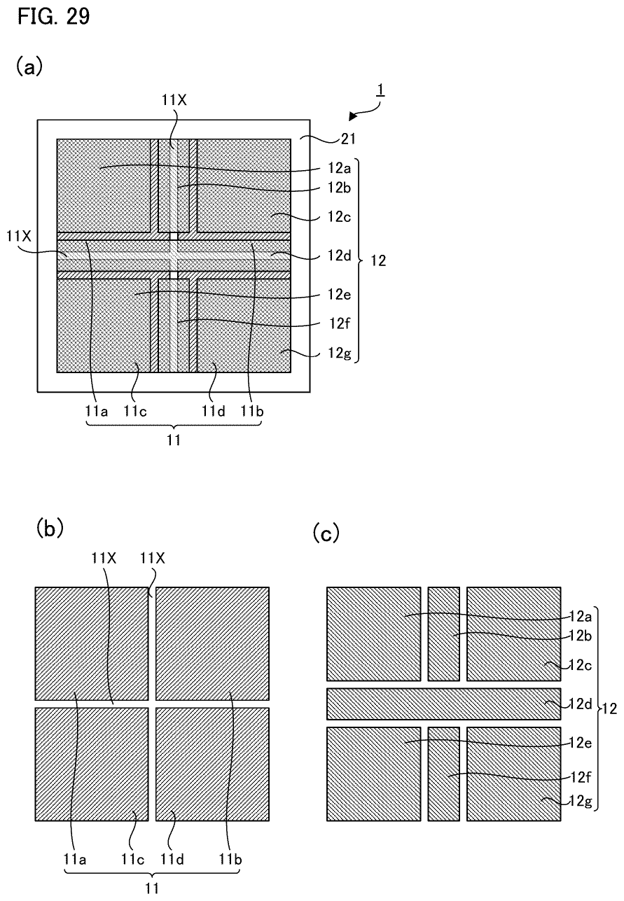

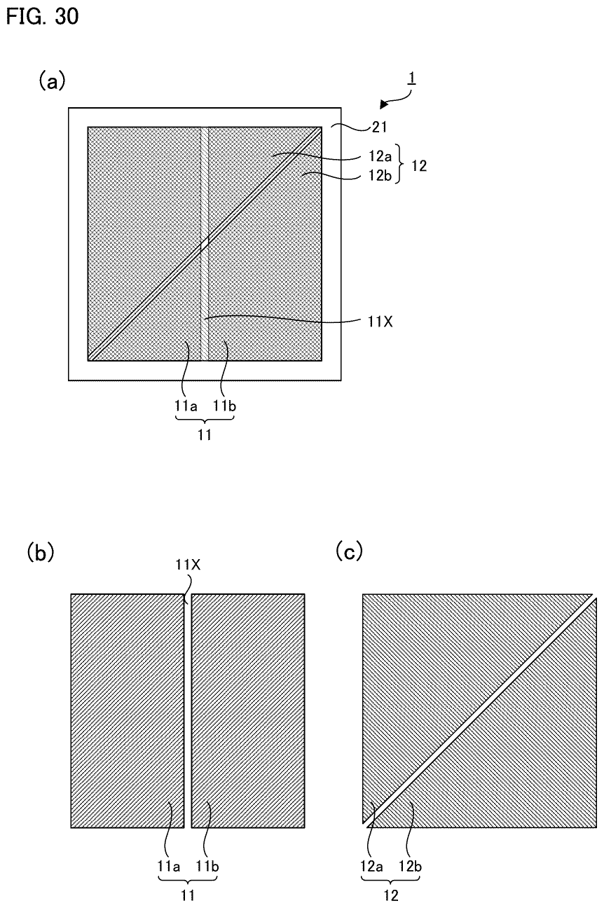

FIGS. 18 and FIGS. 26 to 30 show examples of the arrangement of the first dielectric portion and the second dielectric section. In FIG. 18(a), the first dielectric layer 11 includes two first dielectric portions 11a, 11b, the second dielectric layer 12 includes three second dielectric portions 12a, 12b, 12c, and the second dielectric portion 12b is arranged so that the second dielectric portion 12b overlaps entirety of the boundary 11X of the adjacent first dielectric portions 11a, 11b in a plan view. In FIGS. 26(a) to (c), the first dielectric layer 11 includes two first dielectric portions 11a, 11b, the second dielectric layer 12 includes two second dielectric portions 12a, 12b, and the second dielectric portions 12a, 12b are respectively arranged so that the second dielectric portions 12a, 12b overlaps a part of the boundary 11X of the adjacent first dielectric portions 11a, 11b in a plan view. In FIGS. 27(a) to (c), the first dielectric layer 11 includes four first dielectric portions 11a to 11d, the second dielectric layer 12 includes seven second dielectric portions 12a to 12g, and the second dielectric portion 12c is arranged so that the second dielectric portion 12c overlaps a part of the boundary 11X of the adjacent first dielectric portions 11a, 11b; the second dielectric portion 12f is arranged so that the second dielectric portion 12f overlaps a part of the boundary 11X of the adjacent first dielectric portions 11c, 11d; the second dielectric portion 12a is arranged so that the second dielectric portion 12a overlaps a part of the boundary 11X of the adjacent first dielectric portions 11a, 11b, a part of the boundary 11X of the adjacent first dielectric portions 11c, 11d, a part of the boundary 11X of the adjacent first dielectric portions 11a, 11c, and a part of the boundary 11X of the adjacent first dielectric portions 11b, 11d; in a plan view. In FIGS. 28(a) to (c), the first dielectric layer 11 includes four first dielectric portions 11a to 11d, the second dielectric layer 12 includes four second dielectric portions 12a to 12d, and the second dielectric portion 12a is arranged so that the second dielectric portion 12a overlaps a part of the boundary 11X of the adjacent first dielectric portions 11a, 11b; the second dielectric portion 12d is arranged so that the second dielectric portion 12d overlaps a part of the boundary 11X of the adjacent first dielectric portions 11b, 11d; the second dielectric portion 12c is arranged so that the second dielectric portion 12c overlaps a part of the boundary 11X of the adjacent first dielectric portions 11a, 11b, entirety of the boundary 11X of the adjacent first dielectric portions 11c, 11d, entirety of the boundary 11X of the adjacent first dielectric portions 11a, 11c, and a part of the boundary 11X of the adjacent first dielectric portions 11b, 11d; in a plan view. In FIGS. 29(a) to (c), the first dielectric layer 11 includes four first dielectric portions 11a to 11d, the second dielectric layer 12 includes seven second dielectric portions 12a to 12g, and the second dielectric portion 12b is arranged so that the second dielectric portion 12b overlaps a part of the boundary 11X of the adjacent first dielectric portions 11a, 11b; the second dielectric portion 12f is arranged so that the second dielectric portion 12f overlaps a part of the boundary 11X of the adjacent first dielectric portions 11c, 11d; the second dielectric portion 12d is arranged so that the second dielectric portion 12d overlaps a part of the boundary 11X of the adjacent first dielectric portions 11a, 11b, a part of the boundary 11X of the adjacent first dielectric portions 11c, 11d, entirety of the boundary 11X of the adjacent first dielectric portions 11a, 11c, and entirety of the boundary 11X of the adjacent first dielectric portions 11b, 11d; in a plan view. In FIGS. 30(a) to (c), the first dielectric layer 11 includes two first dielectric portions 11a, 11b, the second dielectric layer 12 includes two second dielectric portions 12a, 12b, and the second dielectric portions 12a, 12b are respectively arranged so that the second dielectric portions 12a, 12b overlaps a part of the boundary 11X of the adjacent first dielectric portions 11a, 11b in a plan view.

In the dielectric member as a whole, the second dielectric portion is arranged so that the second dielectric portion overlaps a part of the boundary of the adjacent first dielectric portions in a plan view. Among the above, in the dielectric member as a whole, the second dielectric portion is preferably arranged so that the second dielectric portion overlaps the entirety of the boundary of the adjacent first dielectric portions in a plan view. That is, all of the boundaries of the adjacent first dielectric portions are preferably covered by the second dielectric portion in the plan view. The strength of the dielectric member as a whole can be increased by arranging the second dielectric portion so that the second dielectric portion overlaps a part of the boundary of the adjacent first dielectric portions in a plan view. Also, in the dielectric member as a whole, the second dielectric portion may be arranged so that the second dielectric portion overlaps 1/10 or more of the total area of the boundary of the adjacent first dielectric portions in a plan view, in the dielectric member as a whole. In this case, in the dielectric member as a whole, the second dielectric portion is preferably arranged so that the second dielectric portion overlaps ⅕ or more of the total area of the boundary of the adjacent first dielectric portions in a plan view, in the dielectric member as a whole.

Also, as described later, when the dielectric member includes the first dielectric layer, the second dielectric layer, and the third dielectric layer, the arrangement of the third dielectric portion constituting the third dielectric layer is not particularly limited.

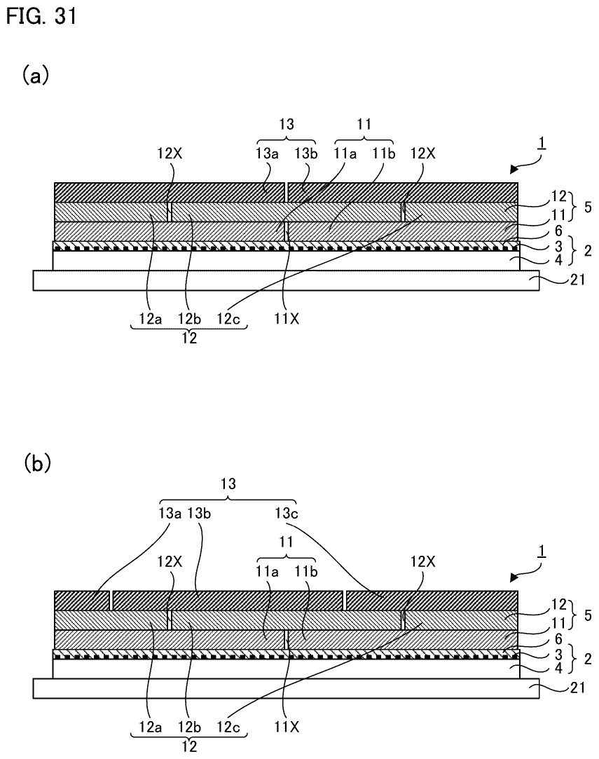

Among the above, with respect to the dielectric portion constituting the dielectric layer adjacent to the third dielectric layer, the third dielectric portion is preferably arranged so that the third dielectric portion overlaps the boundary of the adjacent dielectric portions in a plan view. For example, as shown in FIGS. 31(a), (b), when the first dielectric layer 11, the second dielectric layer 12 and the third dielectric layer 13 are arranged in the order from the reflecting member 2 side, the third dielectric portions 13a, 13b, 13c are preferably arranged so that the third dielectric portions 13a, 13b, 13c overlap the boundary 12X of the adjacent second dielectric portions 12a, 12b, and the boundary 12X of the adjacent second dielectric portions 12b, 12c in a plan view. Also, when the third dielectric layer, the first dielectric layer and the second dielectric layer are arranged in the order from the reflecting member side, the third dielectric portion is preferably arranged so that the third dielectric portion overlaps the boundary of the adjacent first dielectric portions in a plan view. Also, when the first dielectric layer, the third dielectric layer and the second dielectric layer are arranged in the order from the reflecting member side, the third dielectric portion is preferably arranged so that the third dielectric portion overlaps the boundary of the adjacent first dielectric portions, and the third dielectric portion overlaps the boundary of the adjacent second dielectric portions in a plan view. Thereby, the strength of the dielectric member as a whole can further be increased.

Particularly, regardless of the position of the third dielectric layer, in a plan view, the third dielectric portion is preferably arranged so that the third dielectric portion overlaps a boundary of the adjacent first dielectric portions, and the third dielectric portion overlaps a boundary of the adjacent second dielectric portions. Thereby, the strength of the dielectric member can further be increased. In FIG. 31(b) for example, in a plan view, the third dielectric portions 13a to 13c are arranged so that the third dielectric portions 13a to 13c overlap the boundary 11X of the adjacent first dielectric portions, and the third dielectric portions 13a to 13c overlap the boundary 12X of the adjacent second dielectric portions.

In relation to “boundary of the adjacent second dielectric portions”, it is similar to the descriptions about “boundary of the adjacent first dielectric portions” described above. Also, in relation to “the third dielectric portion is arranged so that the third dielectric portion overlaps the boundary of the adjacent first dielectric portions in a plan view” and “the third dielectric portion is arranged so that the third dielectric portion overlaps the boundary of the adjacent second dielectric portions in a plan view”, they are similar to the descriptions about “the second dielectric portion is arranged so that the second dielectric portion overlaps the boundary of the adjacent first dielectric portions in a plan view” described above.

Also, as described later, when the dielectric member includes three or more dielectric layers, the arrangement of dielectric portions constituting the dielectric layer other than the first dielectric layer and the second dielectric layer is not particularly limited. The arrangement of dielectric portions constituting the dielectric layer other than the first dielectric layer and the second dielectric layer is similar to the arrangement of the third dielectric portions constituting the third dielectric layer described above.

In a plan view, the distance between the boundary of the adjacent first dielectric portions and the boundary of the adjacent second dielectric portions is preferably more than the alignment accuracy caused by, for example, an alignment device.

Also, in a plan view, a distance between the boundary of the adjacent first dielectric portions and the boundary of the adjacent second dielectric portions is preferably ⅓ or more of the thickness of the dielectric member. When the distance is in the above range, the strength against bending may be increased.

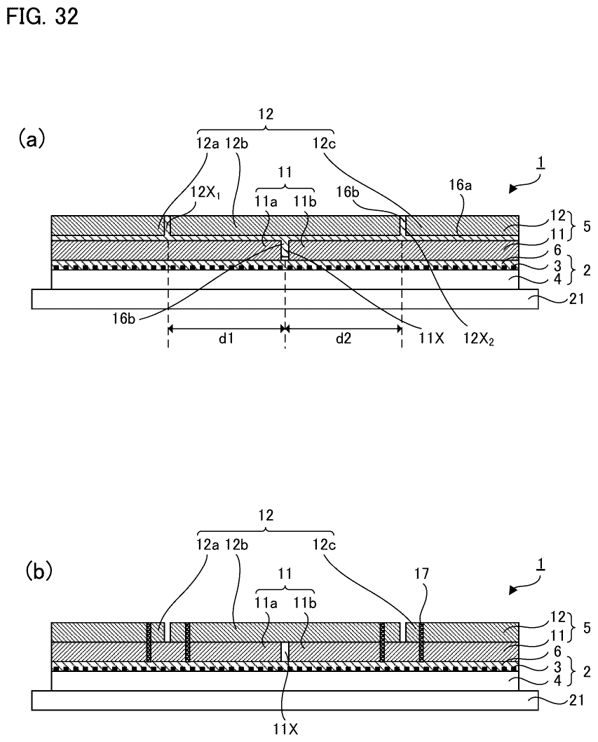

The “distance between the boundary of the adjacent first dielectric portions and the boundary of the adjacent second dielectric portions” means the distance between the boundary of the adjacent first dielectric portions and the boundary of the second dielectric portion positioned on that boundary of the first dielectric portions and the second dielectric portion adjacent to that second dielectric portion. In FIG. 32(a) for example, the distance between the boundary of the adjacent first dielectric portions and the boundary of the adjacent second dielectric portions is the distances d1, d2 between the boundary 11X of the adjacent first dielectric portions 11a, 11b and the boundaries 12X₁, 12X₂ of the second dielectric portion 12b positioned on that boundary 11X of the first dielectric portions 11a, 11b and the second dielectric portions 12a, 12c adjacent to that second dielectric portion 12b. Also, the “distance between the boundary of the adjacent first dielectric portions and the boundary of the adjacent second dielectric portions” means the distance from the center of the boundary of the adjacent first dielectric portions to the center of the boundary of the adjacent second dielectric portions.

Also, as described later, when the dielectric member includes three or more dielectric layers, in two adjacent dielectric layers, the distance between the boundary of the adjacent dielectric portions in the lower dielectric layer and the boundary of the adjacent dielectric portions in the upper dielectric layer is similar to the distance between the boundary of the adjacent first dielectric portions and the boundary of the adjacent second dielectric portions.

In the first dielectric layer, the distance between the adjacent first dielectric portions is preferably less than ½, more preferably ⅕ or less, and further preferably 1/10 or less of the wavelength of the electromagnetic waves in a particular frequency band.

Although it is not a reflect array, in phased array antennas wherein a plurality of subarrays is arranged next to each other, in order to align the phase of the electromagnetic waves in each subarray and increase the intensity of the electromagnetic waves, the distance between the adjacent subarrays is usually less than ½ of the wavelength of the electromagnetic waves. In the present disclosure, since a plurality of dielectric portions is arranged next to each other in each dielectric layer, in order to suppress the turbulence of the wavefront of the reflected wave in the frequency selective reflector as a whole, for example, in order to align the phase of the reflected wave in each dielectric portion, and increase the intensity of the reflected wave, the distance between the adjacent dielectric portions is considered that it is desirably less than ½ of the wavelength of the electromagnetic waves.

As described later, the frequency band of the electromagnetic waves is preferably 24 GHz or more, that is, the wavelength of the electromagnetic waves in the air is preferably 12.49 mm or less. Therefore, the distance between the adjacent first dielectric portions is specifically 6.245 mm or less. Also, the smaller the distance between the adjacent first dielectric layers, the more preferable, and the lower limit value is not particularly limited.

In the adjacent two first dielectric portions, “distance between the adjacent first dielectric portions” refers to the distance between the end portion of one first dielectric portion and the end portion of the other first dielectric portion. For example, in FIGS. 25(a) to (d), the distance d11 between the end portion 11E of the first dielectric portion 11a and the end portion 11E of the first dielectric portion 11b is the distance between the adjacent first dielectric portions 11a, 11b.

The distance between the adjacent second dielectric portions in the second dielectric layer is similar to the distance between the adjacent first dielectric portions described above.

Also, as described later, when the dielectric member includes the first dielectric layer, the second dielectric layer, and the third dielectric layer, the distance between the adjacent third dielectric portions in the third dielectric layer is similar to the distance between the adjacent first dielectric portions described above.

Also, as described later, when the dielectric member includes three or more dielectric layers, the distance between the adjacent dielectric portions in the dielectric layer other than the first dielectric layer and the second dielectric layer is similar to the distance between the adjacent first dielectric portions described above.

### (2) Number of Dielectric Portions

The first dielectric layer includes a plurality of first dielectric portions disposed next to each other on an opposite side of the reflecting member to the substrate. In the first dielectric layer, the number of the first dielectric portions has only to be two or more, and it is appropriately selected according to the size of the frequency selective reflector and the size of the first dielectric portion. The upper limit of the number of first dielectric portions is not particularly limited.

The second dielectric layer includes a plurality of second dielectric portions disposed next to each other on an opposite side of the first dielectric layer to the reflecting member. In the second dielectric layer, the number of the second dielectric portions has only to be two or more, and it is appropriately selected according to the size of the frequency selective reflector and the size of the second dielectric portion. The upper limit of the number of second dielectric portions is not particularly limited. The number of the second dielectric portions may be the same or different from the number of the first dielectric portions. When the number of the first dielectric portions and the number of the second dielectric portions are different, the number of the second dielectric portions may be less or more than the number of the first dielectric portions. When the number of the second dielectric portions is more than the number of the first dielectric portions, the strength of the second dielectric portion can be increased, as described later. When the number of the second dielectric portions is more than the number of the first dielectric portions, the average of the size of the second dielectric portions is smaller than the size of the first dielectric portions. Therefore, the strength of the second dielectric portions can be increased, and thereby, the strength of the second dielectric layer can be increased. Meanwhile, in order to arrange the second dielectric portion so that the second dielectric portion overlaps the boundary of the adjacent first dielectric portions in a plan view, the size of the first dielectric portion and the second dielectric portion are adjusted, and the number of the second dielectric portions may be the number of the first dielectric portions or less.

Also, as described later, when the dielectric member includes the first dielectric layer, the second dielectric layer, and the third dielectric layer, a plurality of third dielectric portions is arranged next to each other in the third dielectric layer. In the third dielectric layer, the number of the third dielectric portions has only to be two or more, and it is appropriately selected according to the size of the frequency selective reflector and the size of the third dielectric portion. The upper limit of the number of third dielectric portions is not particularly limited. The number of the third dielectric portions may be the same or different from the number of the first dielectric portions. When the number of the first dielectric portions and the number of the third dielectric portions are different, the number of the third dielectric portions may be less or more than the number of the first dielectric portions. Also, the number of the third dielectric portions may be the same or different from the number of the second dielectric portions. When the number of the second dielectric portions and the number of the third dielectric portions are different, the number of the third dielectric portions may be less or more than the number of the second dielectric portions.

When the first dielectric layer, the second dielectric layer, and the third dielectric layer are disposed in order from the reflecting member side, there are following five combinations, for example, of the number of the first dielectric portions, the number of the second dielectric portions, and the number of the third dielectric portions. Those are: the first combination wherein the number of second dielectric portions is different from the number of the first dielectric portions and the number of the third dielectric portions, and the number of first dielectric portions and the number of the third dielectric portions are the same; the second combination wherein the number of second dielectric portions is different from the number of the first dielectric portions, and the number of second dielectric portions and the number of the third dielectric portions are the same; the third combination wherein the number of second dielectric portions and the number of the first dielectric portions are the same, and the number of second dielectric portions is different from the number of the third dielectric portions; the fourth combination wherein the number of first dielectric portions, the number of the second dielectric portions, and the number of the third dielectric portions are different from each other; and the fifth combination wherein the number of first dielectric portions, the number of the second dielectric portions, and the number of the third dielectric portions are the same. In any one of the combinations, when the number of the dielectric portions constituting the dielectric layer is more than the number of the dielectric portions constituting the adjacent dielectric layer, the strength of the dielectric layer including more dielectric portions can be increased, as described later. In the dielectric layer including more dielectric portions, the average size of the dielectric portions is smaller than the dielectric layer including less dielectric portions. Therefore, the strength of the dielectric portion in the dielectric layer including more dielectric portions can be increased, and thereby, the strength of the dielectric layer including more dielectric portions can be increased.

The number of the first dielectric portions, the number of the second dielectric portions, and the number of the first dielectric portions in the cases where the third dielectric layer, the first dielectric layer, and a second dielectric layer are disposed in this order from the reflecting member side; and the cases where the first dielectric layer, the third dielectric layer, and a second dielectric layer are disposed in this order from the reflecting member side may be considered similar to the number of the first dielectric portions, the number of the second dielectric portions, and the number of the third dielectric portions in the cases where the first dielectric layer, the second dielectric layer, and the third dielectric layer are disposed in this order from the reflecting member side described above.

Also, as described later, when the dielectric member includes three or more dielectric layers, the number of dielectric portions in the dielectric layer other than the first dielectric layer and the second dielectric layer is similar to the number of third dielectric portions described above.

### (3) Size and Shape of Dielectric Layer and Dielectric Portion

The size of each dielectric layer refers to the external size of each dielectric layer in a plan view. Specifically, the external size of the dielectric layer in a plan view is the size of the region enclosed by the outermost peripheral contour line of the dielectric layer in the plan view of the dielectric layer. Also, the size of each dielectric portion refers to the external size of each dielectric portion in a plan view. Specifically, the external size of the dielectric portion in a plan view is the size of the region enclosed by the outermost peripheral contour line of the dielectric portion in the plan view of the dielectric portion. Also, the shape of each dielectric portion in a plan view refers to the external shape of each dielectric portion in a plan view. For example, in FIG. 19(a) and FIG. 20(a), there is a supporting portion on the outermost peripheral of each dielectric portion. However, the supporting portion is not necessarily on the outermost peripheral of the dielectric portion. In such cases, the region enclosed by the outermost peripheral contour line of the dielectric portion in the plan view of the dielectric portion is the region enclosed by the outermost peripheral contour line of the region including the dielectric pattern and the opening, and in FIG. 19(a) for example, it is the rectangular region including the shaded area of the dielectric pattern, and the external size of the dielectric portion in a plan view is the size of the rectangular region.

In the first dielectric layer, the size of the first dielectric portion is appropriately selected according to the size of the substrate or the use application of the frequency selective reflector. The size of the first dielectric portion is preferably, for example, 150 mm square or more, and more preferably 200 mm square or more. The size of the plurality of first dielectric portions may be the same or different from each other. When the size of the plurality of first dielectric portions is the same, the first dielectric portions can be easily produced, stored, and transported. For example, FIGS. 18 and FIGS. 26 to 30 are examples of where the size of the plurality of first dielectric portions is the same.

The size of the second dielectric portion in the second dielectric layer is similar to the size of the first dielectric portion described above. The size of the second dielectric portions may be the same or different as the size of the first dielectric portion. When the size of the first dielectric portion and the size of the second dielectric portion are different, the size of the second dielectric portion may be smaller or larger than the size of the first dielectric portion. When the size of the second dielectric portion is the size of the first dielectric portion or less, the strength of the second dielectric portion can be increased, as described above. Meanwhile, in order to arrange the second dielectric portion so that the second dielectric portion overlaps the boundary of the adjacent first dielectric portions in a plan view, the size of the first dielectric portion and the second dielectric portion are adjusted, and the size of the second dielectric portion may be the size of the first dielectric portion or less. Also, when the size of the second dielectric portion is an integer multiple or one over an integer of the size of the first dielectric portion, the first dielectric portion and the second dielectric portion can be easily produced, stored, and transported. For example, in FIGS. 18, the size of the second dielectric portions 12a, 12c are approximately ½ of the size of the first dielectric portions 11a, 12b. For example, also in FIGS. 27, the size of the second dielectric portions 12b to 12g are approximately ½ of the size of the first dielectric portions 11a to 11d. The size of the plurality of second dielectric portions may be the same or different from each other. When the size of the plurality of second dielectric portions is the same, the second dielectric portions can be easily produced, stored, and transported. For example, FIG. 26 and FIG. 30 are examples of where the size of the plurality of second dielectric portions is the same. Also, for example, FIGS. 18 and FIGS. 27 to 29 are examples where the size of all of the plurality of second dielectric portions is the same.

Also, as described later, when the dielectric member includes the first dielectric layer, the second dielectric layer, and the third dielectric layer, the size of the third dielectric portion in the third dielectric layer is similar to the size of the first dielectric portion described above. The size of the third dielectric portion may be the same or different as the size of the first dielectric portion. When the size of the first dielectric portion and the size of the third dielectric portion are different, the size of the third dielectric portion may be smaller or larger than the size of the first dielectric portion. Also, the size of the third dielectric portion may be the same or different as the size of the second dielectric portion. When the size of the second dielectric portion and the size of the third dielectric portion are different, the size of the third dielectric portion may be smaller or larger than the size of the second dielectric portion.

When the first dielectric layer, the second dielectric layer, and the third dielectric layer are disposed in order from the reflecting member side, there are following five combinations, for example, of the size of the first dielectric portion, the size of the second dielectric portion, and the size of the third dielectric portion. Those are: the first combination wherein the size of the second dielectric portion is different from the size of the first dielectric portion and the size of the third dielectric portion, and the size of first dielectric portion and the size of the third dielectric portion are the same; the second combination wherein the size of the second dielectric portion is different from the size of the first dielectric portion, and the size of the second dielectric portion and the size of the third dielectric portion are the same; the third combination wherein the size of the second dielectric portion and the size of the first dielectric portion are the same, and the size of the second dielectric portion is different from the size of the third dielectric portion; the fourth combination wherein the size of the first dielectric portion, the size of the second dielectric portion, and the size of the third dielectric portion are different from each other; and the fifth combination wherein the size of the first dielectric portion, the size of the second dielectric portion, and the size of the third dielectric portion are the same. In any one of the combinations, when the size of the dielectric portions constituting the dielectric layer is smaller than the size of the dielectric portions constituting the adjacent dielectric layer, in the dielectric layer including the dielectric portions with smaller size, the strength of the dielectric portion can be increased, and thereby the strength of the dielectric layer can also be increased.

The size of the first dielectric portion, the size of the second dielectric portion, and the size of the third dielectric portion in the cases where the third dielectric layer, the first dielectric layer, and the second dielectric layer are disposed in this order from the reflecting member side; and the cases where the first dielectric layer, the third dielectric layer, and the second dielectric layer are disposed in this order from the reflecting member side may be considered similar to the size of the first dielectric portion, the size of the second dielectric portion, and the size of the third dielectric portion in the cases where the first dielectric layer, the second dielectric layer, and the third dielectric layer are disposed in this order from the reflecting member side.

Also, when the size of the third dielectric portion is an integer multiple or one over an integer of the size of the first dielectric portion, and an integer multiple or one over an integer of the size of the second dielectric portion, the first dielectric portion, the second dielectric portion, and the third dielectric portion can be easily produced, stored, and transported. The size of the plurality of third dielectric portion may be the same or different from each other. When the size of the plurality of third dielectric portions is the same, the third dielectric portions can be easily produced, stored, and transported.

Also, as described later, when the dielectric member includes three or more dielectric layers, the size of the dielectric portions in the dielectric layer other than the first dielectric layer and the second dielectric layer is similar to the size of the third dielectric portions described above.

The size of the first dielectric layer and the size of the second dielectric layer is appropriately selected according to the size of the substrate or the use application of the frequency selective reflector. The size of the first dielectric layer and the size of the second dielectric layer are usually the same.

Also, as described later, when the dielectric member includes the first dielectric layer, the second dielectric layer, and the third dielectric layer, the size of the third dielectric layer is usually the same as the size of the first dielectric layer and the size of the second dielectric layer.

Also, as described later, when the dielectric member includes three or more dielectric layers, the size of the dielectric layer other than the first dielectric layer and the second dielectric layer is usually the same as the size of the first dielectric layer and the size of the second dielectric layer.

The shape of the first dielectric portion in plan view is not particularly limited if it is a shape capable of arranging the first dielectric portions without a gap, and examples thereof may include a square shape, and a rectangular shape. The shape of the plurality of first dielectric portions in a plan view may be the same or different from each other. When the shape of the plurality of the first dielectric portions in a plan view is the same, the first dielectric portions can be easily produced, stored, and transported. For example, FIGS. 18 and FIGS. 26 to 30 are examples where the shape of the first dielectric portion in a plan view is a square shape or a rectangular shape, and the shape of the plurality of first dielectric portions in a plan view is the same.

The shape of the second dielectric portion in a plan view is not particularly limited if it is a shape capable of arranging the second dielectric portions without a gap, and it is appropriately selected according to the arrangement of the first dielectric portions. Examples of the shape may include a square shape, a rectangle shape, and a right-angle triangular shape. The shape of the plurality of second dielectric portions in a plan view may be the same or different from each other. When the plurality of second dielectric portions in a plan view is the same, the second dielectric portions can be easily produced, stored, and transported. For example, FIGS. 18 and FIGS. 26 to 29 are examples where the shape of the second dielectric portion in a plan view is a square shape or a rectangular shape, and among them FIG. 26 is an example where the shape of the plurality of second dielectric portions in a plan view is the same. For example, FIG. 30 is an example where the shape of the second dielectric portion in a plan view is a right-angled triangular shape, and the shape of the plurality of second dielectric portions in a plan view is the same.

Also, as described later, when the dielectric member includes three or more dielectric layers, the shape of the dielectric portion in a plan view in the dielectric layer other than the first dielectric layer and the second dielectric layer is similar to the shape of the first dielectric portion in a plan view and the shape of the second dielectric portion in a plan view described above.

### (4) Number of Stacked Dielectric Layers

In the present disclosure, the dielectric member includes the first dielectric layer and the second dielectric layer, in this order from the reflecting member side.

The dielectric member may include at least the first dielectric layer and the second dielectric layer, for example, the first dielectric layer, the second dielectric layer and the third dielectric layer may be included. The position of the third dielectric layer is not particularly limited, and the first dielectric layer, the second dielectric layer, and the third dielectric layer may be disposed in this order from the reflecting member side; the third dielectric layer, the first dielectric layer, and the second dielectric layer may be disposed in this order from the reflecting member side; and the first dielectric layer, the third dielectric layer, and the second dielectric layer may be disposed in this order from the reflecting member side.

Also, the dielectric member may include at least two layers, the first dielectric layer and the second dielectric layer, and for example, it may include three or more dielectric layers. The number of the stacked dielectric layers have only to be two layers or more, and may be three layers or more. The higher the number of the stacked dielectric layers, the higher the reflection intensity of the electromagnetic waves in the frequency selective reflector as a whole. Also, the higher the number of the stacked dielectric layers, the more stress can be dispersed in the bending direction, thus increasing the strength of the dielectric member against bending. The upper limit of the number of the stacked dielectric layers is not particularly limited, and it is, for example, 10 layers or less. If the number of the stacked dielectric layers is too large, the thickness of each dielectric layer becomes thinner, which may cause difficulties in the production of the dielectric portion constituting the dielectric layer, or the strength of the dielectric portion itself may decrease significantly.

When the dielectric member includes three or more dielectric layers, the position of the dielectric layer other than the first dielectric layer and the second dielectric layer is similar to the position of the third dielectric layer described above.

### (5) Each Region of Dielectric Member

When the dielectric member includes the first dielectric layer and the second dielectric layer as the dielectric layer, as shown in FIG. 21(a) for example, the dielectric member 5 includes, an A1 region 31 which does not include the first dielectric pattern 11P and the second dielectric pattern 12P from the reflecting member 2 side; an A2 region 32 including only the first dielectric pattern 11P from the reflecting member 2 side; and an A3 region 33 including the first dielectric pattern 11P and the second dielectric pattern 12P from the reflecting member 2 side.

The absolute value of the difference between the relative reflection phase of the electromagnetic waves in the A1 region and the relative reflection phase of the electromagnetic waves in the A2 region; and the absolute value of the difference between the relative reflection phase of the electromagnetic waves in the A2 region and the relative reflection phase of the electromagnetic waves in the A3 region are determined based on a simulation, considering the reflection loss. When the optimum value of the absolute value of the difference in the relative reflection phases of the electromagnetic waves described above is set to 120 degrees in the simulation, the absolute vale of the difference in the relative reflection phases of the electromagnetic waves described above is preferably, for example, 90 degrees or more and 150 degrees or less, more preferably 110 degrees or more and 130 degrees or less, and further preferably 115 degrees or more and 125 degrees or less. In such cases, the turbulence on the wavefront of the reflected wave can be suppressed.

In the above case, in the dielectric member, the difference between the round-trip optical path lengths in the A1 region and the round-trip optical path lengths in the A2 region is designed such that absolute value of the difference between the relative reflection phase of the electromagnetic waves in the A1 region and the relative reflection phase of the electromagnetic waves in the A2 region is the setting as described above. Similarly, the difference between the round-trip optical path lengths in the A2 region and the round-trip optical path lengths in the A3 region is designed such that absolute value of the difference between the relative reflection phase of the electromagnetic waves in the A2 region and the relative reflection phase of the electromagnetic waves in the A3 region is the setting as described above. Also, the thickness of the A1 region is 0, and the thickness of the A2 region is designed such that the difference between the thickness of the A1 region and the thickness of the A2 region is the difference between the round-trip optical path length in the A1 region and the round-trip optical path length in the A2. That is, the thickness of the first dielectric layer is set to be the difference between the round-trip optical path length in the A1 region and the round-trip optical path length in the A2 region. Similarly, the thickness of the A3 region is designed such that the difference between the thickness of the A2 region and the thickness of the A3 region is the difference between the round-trip optical path length in the A2 region and the round-trip optical path length in the A3. That is, the thickness of the second dielectric layer is set to be the difference between the round-trip optical path length in the A2 region and the round-trip optical path length in the A3 region.

The thickness of the A1 region is 0. The thickness of the A2 region and the thickness of the A3 region are respectively appropriately set according to the wavelength of the electromagnetic waves, the dielectric constant of the material of each dielectric layer, and the intended reflection properties. For example, when the effective wavelength of the electromagnetic waves passing through the dielectric material is regarded as λ_{g}, the thickness of the A2 region and the thickness of the A3 region are respectively preferably more than 0 and λ_{g}/2 or less. Specifically, when the wavelength λ₀ of the electromagnetic waves in the air is 10 mm, and the dielectric constant of each dielectric layer is 2.57, the thickness of the A2 region and the thickness of the A3 region are respectively preferably more than 0 mm and 8.6 mm or less.

The effective wavelength of the electromagnetic waves means the wavelength when the electromagnetic waves pass through materials other than air, such as a dielectric layer. It should be noted that, when described as merely wavelength, it is referred to as the wavelength in the air.

When the dielectric member includes the first dielectric layer, the second dielectric layer, and the third dielectric layer as the dielectric layers, the third dielectric layer includes a third dielectric pattern as similar to the first dielectric layer and the second dielectric layer. In this case, the dielectric member includes four regions.

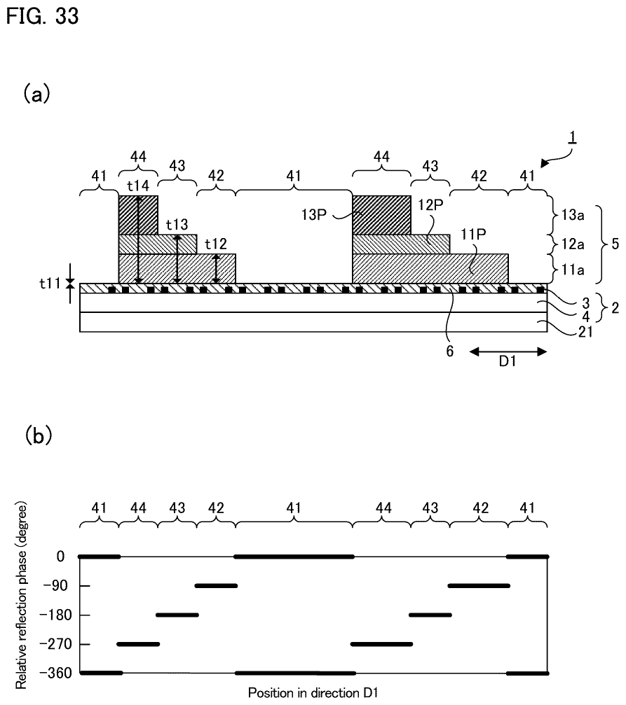

When the dielectric member includes the first dielectric layer, the second dielectric layer, and the third dielectric layer in this order from the reflecting member side, as shown in FIG. 33(a) for example, the dielectric member 5 includes, a B1 region 41 which does not include the first dielectric pattern 11P, the second dielectric pattern 12P, and the third dielectric pattern 13P from the reflecting member 2 side, a B2 region 42 including only the first dielectric pattern 11P from the reflecting member 2 side, a B3 region 43 including only the first dielectric pattern 11P and the second dielectric pattern 12P from the reflecting member 2 side, and a B4 region 44 including the first dielectric pattern 11P, the second dielectric pattern 12P, and the third dielectric pattern 13P from the reflecting member 2 side.

FIG. 33(b) is an example of the relative reflection phase of electromagnetic waves in the B1 region, the B2 region, the B3 region, and the B4 region of the dielectric member in the frequency selective reflector shown in FIG. 33(a). As shown in FIG. 33(b), when the absolute value of the difference of the relative reflection phase with low reflection loss is 90 degrees, the relative reflection phase of the electromagnetic waves in the B1 region 41, the B2 region 42, the B3 region 43, and the B4 region 44 of dielectric member 5 is respectively 0 degrees (−360 degrees), −90 degrees, −180 degrees, and −270 degrees.

In the above case, as shown in FIG. 33(a), the thickness t11 of B1 region 41 is 0, the thickness t11 of B1 region 41, the thickness t12 of B2 region 42, the thickness t13 of B3 region 43 and the thickness t14 of B4 region 44 are different from each other. Thereby, in the B1 region, the B2 region, the B3 region and the B4 region, the round-trip optical path length in the dielectric member can be varied, and the reflection phase of the electromagnetic waves can be controlled. As a result, the reflection direction of the electromagnetic wave with respect to the predetermined incident direction can be controlled in any direction.

The absolute value of the difference between the relative reflection phase of the electromagnetic waves in the B1 region and the relative reflection phase of the electromagnetic waves in the B2 region; the absolute value of the difference between the relative reflection phase of the electromagnetic waves in the B2 region and the relative reflection phase of the electromagnetic waves in the B3 region; and the absolute value of the difference between the relative reflection phase of the electromagnetic waves in the B3 region and the relative reflection phase of the electromagnetic waves in the B4 region are determined based on a simulation, considering the reflection loss. When the optimum value of the absolute vale of the difference in the relative reflection phases of the electromagnetic waves described above is set to 90 degrees in the simulation, the absolute vale of the difference in the relative reflection phases of the electromagnetic waves described above is preferably, for example, 60 degrees or more and 120 degrees or less, more preferably 80 degrees or more and 100 degrees or less, and further preferably 85 degrees or more and 95 degrees or less. In such cases, the turbulence on the wavefront of the reflected wave can be suppressed.

In the above case, in the B1 region, the B2 region, the B3 region, and the B4 region in the dielectric member, the difference between the round-trip optical path lengths in neighboring regions is designed such that the absolute value of the difference between the relative reflection phase of the electromagnetic waves in neighboring regions is set as described above. Also, the thickness of the B1 region is 0, and the thickness of the B2 region is designed such that the difference between the thickness of the B1 region and the thickness of the B2 region is the difference between the round-trip optical path length in the B1 region and the round-trip optical path length in the B2. That is, the thickness of the first dielectric layer is set to be the difference between the round-trip optical path length in the B1 region and the round-trip optical path length in the B2 region. Similarly, the thickness of the B3 region is designed such that the difference between the thickness of the B2 region and the thickness of the B3 region is the difference between the round-trip optical path length in the B2 region and the round-trip optical path length in the B3 region. That is, the thickness of the second dielectric layer is set to be the difference between the round-trip optical path length in the B2 region and the round-trip optical path length in the B3 region. Similarly, the thickness of the B4 region is designed such that the difference between the thickness of the B3 region and the thickness of the B4 region is the difference between the round-trip optical path length in the B3 region and the round-trip optical path length in the B4. That is, the thickness of the third dielectric layer is set to be the difference between the round-trip optical path length in the B3 region and the round-trip optical path length in the B4 region.

The thickness of the B1 region is 0. The thickness of the B2 region, the thickness of the B3 region and the thickness of the B4 region are set similarly to the thickness of the A2 region, and the thickness of the A3 region described above.

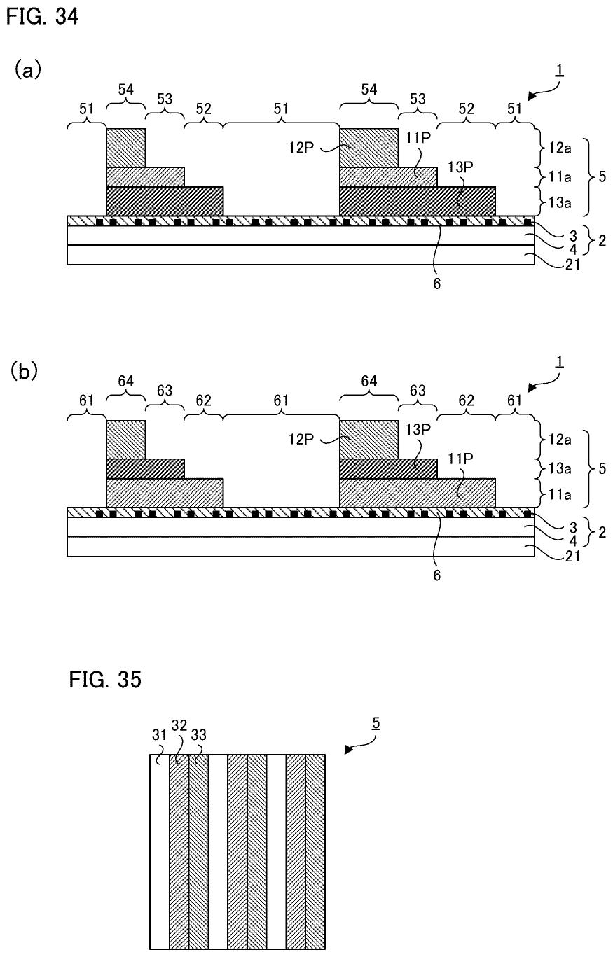

When the dielectric member includes the third dielectric layer, the first dielectric layer, and a second dielectric layer in this order from the reflecting member side, as shown in FIG. 34(a) for example, the dielectric member 5 includes a C1 region 51 which does not include the third dielectric pattern 13P, the first dielectric pattern 11P, and the second dielectric pattern 12P from the reflecting member 2 side, a C2 region 52 including only the third dielectric pattern 13P from the reflecting member 2 side, a C3 region 53 including only the third dielectric pattern 13P and the first dielectric pattern 11P from the reflecting member 2 side, and a C4 region 54 including the third dielectric pattern 13P, the first dielectric pattern 11P, and the second dielectric pattern 12P from the reflecting member 2 side.

In the above case, the thickness of the C1 region is 0, the thickness of the C1 region, the thickness of the C2 region, the thickness of the C3 region and the thickness of the C4 region are different from each other. Thereby, in the C1 region, the C2 region, the C3 region and the C4 region, the round-trip optical path length in the dielectric member can be varied, and the reflection phase of the electromagnetic waves can be controlled. As a result, the reflection direction of the electromagnetic waves with respect to the predetermined incident direction can be controlled in any direction.

The absolute value of the difference between the relative reflection phase of the electromagnetic waves in the C1 region and the relative reflection phase of the electromagnetic waves in the C2 region; the absolute value of the difference between the relative reflection phase of the electromagnetic waves in the C2 region and the relative reflection phase of the electromagnetic waves in the C3 region; and the absolute value of the difference between the relative reflection phase of the electromagnetic waves in the C3 region and the relative reflection phase of the electromagnetic waves in the C4 region are similar to the absolute value of the difference between the relative reflection phase of the electromagnetic waves in the B1 region and the relative reflection phase of the electromagnetic waves in the B2 region; the absolute value of the difference between the relative reflection phase of the electromagnetic waves in the B2 region and the relative reflection phase of the electromagnetic waves in the B3 region; and the absolute value of the difference between the relative reflection phase of the electromagnetic waves in the B3 region and the relative reflection phase of the electromagnetic waves in the B4 region described above.

In the above case, the thickness of the C1 region is 0, the thickness of the C2 region, the thickness of the C3 region and the thickness of the C4 region are set similarly to the thickness of the B2 region, the thickness of the B3 region and the thickness of the B4 region described above.

When the dielectric member includes the first dielectric layer, the third dielectric layer, and a second dielectric layer in this order from the reflecting member side, as shown in FIG. 34(b) for example, the dielectric member 5 includes a D1 region 61 which does not include the first dielectric pattern 11P, the third dielectric pattern 13P, and the second dielectric pattern 12P from the reflecting member 2 side, a D2 region 62 including only the first dielectric pattern 11P from the reflecting member 2 side, a D3 region 63 including only the first dielectric pattern 11P and the third dielectric pattern 13P from the reflecting member 2 side, and a D4 region 64 including the first dielectric pattern 11P, the third dielectric pattern 13P, and the second dielectric pattern 12P from the reflecting member 2 side.

In the above case, the thickness of D1 region is 0, the thickness of the D1 region, the thickness of the D2 region, the thickness of the D3 region and the thickness of the D4 region are different from each other. Thereby, in the D1 region, the D2 region, the D3 region and the D4 region, the round-trip optical path length in the dielectric member can be varied, and the reflection phase of the electromagnetic waves can be controlled. As a result, the reflection direction of the electromagnetic wave with respect to the predetermined incident direction can be controlled in any direction.

The absolute value of the difference between the relative reflection phase of the electromagnetic waves in the D1 region and the relative reflection phase of the electromagnetic waves in the D2 region; the absolute value of the difference between the relative reflection phase of the electromagnetic waves in the D2 region and the relative reflection phase of the electromagnetic waves in the D3 region; and the absolute value of the difference between the relative reflection phase of the electromagnetic waves in the D3 region and the relative reflection phase of the electromagnetic waves in the D4 region are similar to absolute value of the difference between the relative reflection phase of the electromagnetic waves in the B1 region and the relative reflection phase of the electromagnetic waves in the B2 region; the absolute value of the difference between the relative reflection phase of the electromagnetic waves in the B2 region and the relative reflection phase of the electromagnetic waves in the B3 region; and the absolute value of the difference between the relative reflection phase of the electromagnetic waves in the B3 region and the relative reflection phase of the electromagnetic waves in the B4 region described above.

In the above case, the thickness of the D1 region is 0, the thickness of the D2 region, the thickness of the D3 region and the thickness of the D4 region are set similarly to the thickness of the B2 region, the thickness of the B3 region and the thickness of the B4 region described above.

When the dielectric member includes three or more dielectric layers, the dielectric layer other than the first dielectric layer and the second dielectric layer includes a dielectric pattern, as similar to the first dielectric layer and the second dielectric layer. When the number of the stacked dielectric layers is “n”, the dielectric member includes “n+1” regions. Each region may be considered similar to the cases where the dielectric member includes the first dielectric layer, the second dielectric layer, and the third dielectric layer as the dielectric layers described above.

The pitch of each region is appropriately set according to the intended reflection properties. When the dielectric member includes A1 to A3 regions, the pitch of the A1 region is shifted by one wavelength (phase difference: 360 degrees) pre one pitch. Similarly, the pitch of the A2 region and the pitch of the A3 region are shifted by one wavelength (phase difference: 360 degrees) pre one pitch. The same applies to the pitch of other regions. Therefore, the reflection angle can be adjusted by the pitch of each region. For example, by shortening the pitch of each region, the difference in reflection angle with respect to the regular reflection angle can be increased. On the other hand, by lengthening the pitch of each region, the difference in the reflection angle with respect to the regular reflection angle can be reduced.

Also, when the reflecting member is a member in which a plurality of reflective elements is arranged, the pitch of each region may be the same as or different from the pitch of the reflective element of the reflecting member. If the pitch of each region is the same as the pitch of the reflective element of the reflecting member, the designing is easy. Also, for example, by adjusting the pitch of each region, the control range of the reflection properties can be widened regardless of the pitch of the reflective element of the reflecting member.

The pitch of each region is appropriately designed according to the desired reflection properties. In the dielectric member as a whole, the pitch of each region may be uniform or non-uniform.

The pitch of the A1 region refers to the distance from the center of one A1 region to the center of the neighboring A1 region. The pitch of the A2 region refers to the distance from the center of one A2 region to the center of the neighboring A2 region. The pitch of the A3 region refers to the distance from the center of one A3 region to the center of the neighboring A3 region. The same applies to the pitch of other regions.

The size of each region is respectively appropriately designed according to the desired reflection properties. In the dielectric member as a whole, the size of each region may be uniform or non-uniform.

The shape of each region in a plan view is not particularly limited if it is a shape capable of arranging each region without a gap. In the dielectric member as a whole, the shape of each region in a plan view may be uniform or non-uniform.

In the dielectric member, the arrangement of each region is appropriately set according to the intended reflection properties. Each region is usually arranged so that the thickness of each region repeats increasing and decreasing in a certain direction. The arrangement direction of each region is not particularly limited. According to the required reflection properties design, each region may be arranged by selecting the appropriate arrangement angle and the appropriate arrangement direction.

In the dielectric member, the thickness of each region affects the reflection properties of the frequency selective reflector as a whole, and for example, the pitch of each region, the size of each region, the shape of each region in a plan view, and the arrangement of each region also affect the reflection properties of the frequency selective reflector as a whole. Specifically, the adjustment of polarization characteristics, the effect on the beam profile (such as high directivity, spread, and multibeam), and the like are to be influenced.

In the dielectric member, the thickness distribution of the dielectric member is appropriately selected so that the normal vector of the same phase plane of the reflected wave with respect to the incident wave incident at a predetermined incident angle is in a desired reflection direction, and each region is arranged.

For example, when the incident plane wave is reflected in a single direction, or reflected as so-called plane wave, the pitch of each region, the width of each region, and the shape of each region in a plan view are respectively preferably uniform in the dielectric member as a whole. Also, in this case, the arrangement of each region is more preferably in a striped shape. For example, in FIG. 35, in the dielectric member 5 as a whole, the pitch of the A1 region 31, the A2 region 32 and the A3 region 33, the width of the A1 region 31, the A2 region 32 and the A3 region 33, and the shape of the A1 region 31, the A2 region 32 and the A3 region 33 in a plan view are respectively uniform. Also, the arrangement of the A1 region 31, the A2 region 32 and the A3 region 33 is in a striped shape. In this case, as exemplified in FIG. 2, the incident wave W1 incident at a predetermined incident angle 01 can be reflected at a predetermined reflection angle θ2, and the reflected wave W2 can be a plane wave that does not spread. Also, when the shape of the frequency selective reflector in a plan view is a rectangular shape, and when the arrangement of each region is in a striped shape, the longitudinal direction of the stripes of each region may be parallel to the short direction of the frequency selective reflector, and the longitudinal direction of the stripes of each region may be parallel to the longitudinal direction of the frequency selective reflector. In the actual frequency selective reflector, the longitudinal direction and the shorter direction of the stripes of each region can be set arbitrarily according to the design of the reflection properties.

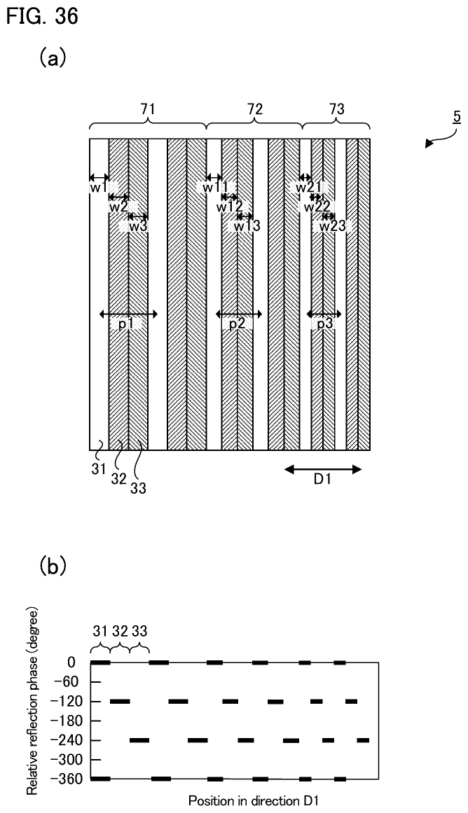

Also, for example, when spreading the electromagnetic waves, or when reflecting as a cylindrical wave, for example, an aspect wherein the dielectric member includes a plurality of periodic structures with reflection properties different from each other, may be employed. For example, in FIG. 36(a), the dielectric member 5 includes three types of periodic structures 71 to 73. In these periodic structures 71 to 73, the widths w1, w2, w3 of the A1 region 31, the widths w11, w12, w13 of the A2 region 32, and the widths w21, w22, w23 of the A3 region 33 are different from each other, and the pitches p1, p2, p3 of the A1 region 31 are different from each other. Thereby, the three types of the periodic structures 71 to 73 have different reflection properties. Also, as shown in FIG. 36(b), the relative reflection phase of the electromagnetic waves in the A1 region 31, the A2 region 32 and the A3 region 33 of dielectric member 5 are respectively 0 degrees (−360 degrees), −120 degrees, and −240 degrees. Also, the arrangement of the A1 region 31, the A2 region 32 and the A3 region 33 is in a striped shape. In this case, as exemplified in FIG. 6, the incident wave W1 incident at a predetermined incident angle θ1 can be reflected at the reflection angles θ2, θ2′, and θ2″ depending on the periodic structures, can be reflected with a spread, and the wavefront of the reflected wave W2 can be widened.

Also, for example, when a spherical wave is reflected as a plane wave, the arrangement of each region is preferably in an arc striped shape.

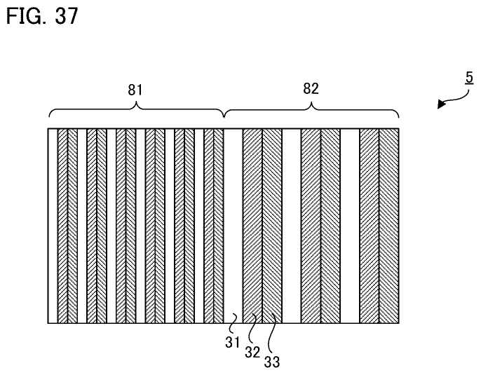

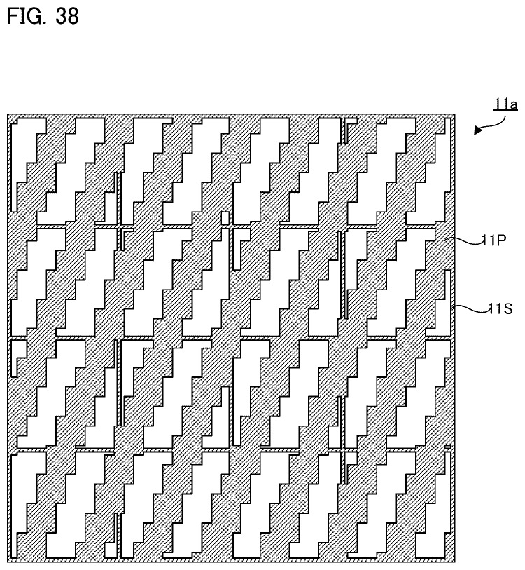

Also, the dielectric member may include a plurality of reflective regions with reflection properties different from each other, and the plurality of reflective regions may be arranged in a plane. For example, in FIG. 37, the dielectric member 5 includes two types of reflective regions 81, 82 with reflection properties different from each other, and the two types of reflective regions 81, 82 are arranged in a plane. In these reflective regions 81, 82, for example, the widths of the A1 region 31, the A2 region 32, and the A3 region 33 are different from each other, and the pitches of the A1 regions 31 differs from each other. This results in different reflectance properties between the two types of reflective regions 81, 82. In such an aspect, a plurality of coverage holes may be associated.

Further, for example, when the reflecting member described below is a frequency selective plate and includes multiple types of frequency selective surfaces (FSS) for selectively reflecting electromagnetic waves in frequency bands different from each other, the reflection properties of the dielectric member may be designed according to the frequency selectivity of these frequency selective surfaces, and the dielectric member may include regions with reflection properties different from each other. In this case also, for example, they can be arranged as shown in FIG. 37. In such an aspect, the dual bands or more bands can be corresponded.

Also, when the incident wave and the reflected wave are plane waves, the dielectric member includes a periodic structure in which each region is repeatedly arranged. The term “periodic structure” refers to a structure in which each region is periodically repeatedly arranged. In each region in the periodic structure, in the periodic structure having the identical reflection properties, for example, the width of each region, the pitch of each region, the shape of each region in a plan view, and the arrangement of each region may be the same, respectively. Also, in the case where the dielectric member includes a periodic structure, the periodic structures including different reflection properties can be combined as described above. In that case, the reflection properties of the periodic structures to be combined are appropriately designed according to the target reflection properties, and specifically, for example, the width of each region, the pitch of each region, the shape of each region in a plan view, and the arrangement of each region in the periodic structures to be combined are appropriately set according to the target reflection properties.

In general, the design of the reflection properties to reflect the plane wave, in a direction different from a regular reflection direction, as the plane wave is similar to the contents described in the first embodiment described above.

### (6) Properties of Dielectric Member

The dielectric member transmits electromagnetic waves in a particular frequency band and may or may not transmit electromagnetic waves in other frequency bands.

The dielectric loss tangent and dielectric constant of each dielectric layer constituting the dielectric member are similar to the dielectric loss tangent and dielectric constant of the dielectric layer in the first embodiment described above.

### (7) Material of Dielectric Layer

The material of each dielectric layer constituting the dielectric member is similar to the material of the dielectric layer in the first embodiment described above.

The material of each dielectric layer may be the same, and may be different from each other. When the material of each dielectric layer is different, the thickness of the dielectric layer may be adjusted by appropriately selecting the dielectric constant per dielectric layer. In addition, the total area of the dielectric pattern of the dielectric portion constituting the upper layer dielectric layer is smaller than the total area of the dielectric pattern of the dielectric portion constituting the lower layer dielectric layer, so that the strength and workability of each dielectric layer can be adjusted by the material of each dielectric layer being different.

### (8) Supporting Portion

In the present disclosure, the first dielectric portion constituting the first dielectric layer preferably includes a first supporting portion supporting the first dielectric pattern. Similarly, the second dielectric portion constituting the second dielectric layer preferably includes a second supporting portion supporting the second dielectric pattern. Also, when the dielectric member includes three or more dielectric layers, the dielectric portion constituting the dielectric layer other than the first dielectric layer and the second dielectric layer similarly preferably includes a supporting portion supporting the dielectric pattern. When the dielectric portion includes the supporting portion, the strength can be increased. Also, the dielectric patterns may be connected by the supporting portion to integrate the dielectric patterns so that it makes the formation of the dielectric portion easier.

The position of the supporting portion is not particularly limited if it is a position capable of connecting the dielectric patterns to integrate the dielectric patterns. The supporting portion is preferably disposed on the periphery of the dielectric portion, and more preferably disposed on the periphery of the dielectric portion in a form of a frame. Also, the supporting portion may be disposed on the location other than the periphery, that is, inside of the dielectric portion.

For example, in FIG. 19 and FIG. 38, the first dielectric portion 11a includes a first supporting portion 11S supporting the first dielectric pattern 11P. In FIGS. 19, the first supporting portion 11S is disposed only on the periphery of the first dielectric portion 11a. In FIG. 38, the first supporting portion 11S is disposed on the periphery and the inside of the first dielectric portion 111a. For example, in FIGS. 20, the second dielectric portion 12a includes a second supporting portion 12S supporting the second dielectric pattern 12P, and the second supporting portion 12S is disposed only on the periphery of the second dielectric portion 12a.

The thickness of the supporting portion may be the same as the thickness of the dielectric portion, and may be thinner than the thickness of the dielectric portion. When the thickness of the supporting portion is thinner than the thickness of the dielectric portion, the influence of the supporting portion on the reflection properties can be reduced. In the case of a hollowing processing such as cutting, and laser processing, the thickness of the supporting portion is usually the same as the thickness of the dielectric portion. In the case of a 3D printer, the thickness of the supporting portion is adjustable.

The width of the supporting portion is preferably a width so as not to affect the reflection properties. When the thickness of the supporting portion is equivalent to the thickness of the dielectric portion, when the wavelength of the electromagnetic waves is regarded as A, the width of the supporting portion is preferably λ or less, and more preferably A/2 or less. If the width of the supporting portion is too large, it may affect the reflection properties. Also, when the width of the supporting portion is A/2 or less, resonance is less likely to occur, and the reflection intensity of the electromagnetic waves decreases abruptly. Meanwhile, the lower limit of the width of the supporting portion is not particularly limited if it is the width capable of supporting the dielectric pattern.

Specifically, the width of the supporting portion is preferably 0.05 mm or more and 2 mm or less, more preferably 0.1 mm or more and 1 mm or less, and further preferably 0.2 mm or more and 0.5 mm or less. When the width of the supporting portion is too small, it may be difficult to form the supporting portion, and it may be difficult to support the dielectric pattern. Also, when the width of the supporting portion is too large, it may affect the reflection properties.

In the dielectric layer including a plurality of dielectric portions disposed next to each other, the supporting portion disposed on the periphery of the dielectric layer is considered not to affect the reflection properties. Therefore, the width of the supporting portion disposed on the periphery of the dielectric layer is not particularly limited, it may be in the above range, and it may be out of the above range.

In the dielectric portion, the width of the supporting portion disposed on the periphery of the dielectric portion may or may not be the same as the width of the supporting portion disposed on the location other than the periphery, that is, inside of the dielectric portion.

Also, in the dielectric layer including a plurality of dielectric portions disposed next to each other, when each dielectric portion includes the supporting portion, the ratio of the total area of the supporting portion with respect to the external area of the dielectric layer is preferably 30% or less, more preferably 20% or less, and further preferably 10% or less. If the ratio is too much, the performance of the frequency selective reflector may be degraded. Meanwhile, the lower limit of the ratio is not particularly limited if the dielectric pattern can be supported by the supporting portion. In this case, as described above, since the supporting portion disposed on the periphery of the dielectric layer is considered not to affect the reflection properties, it is not included in the total area of the supporting portion described above.

Here, the ratio of the total area of the supporting portion with respect to the external area of the dielectric layer is measured by the following method. First, a region of 1/16 size is randomly selected for the entire dielectric layer. The ratio of the total area of the supporting portion with respect to the area of this selected region is determined. At this time, if the ratio is in the above range, the ratio in the selected region is considered to be the ratio of the total area of the supporting portion with respect to the external area of the dielectric layer. Meanwhile, if the ratio exceeds the above range, the ratio of the total area of the supporting portion with respect to the external area of the dielectric layer is determined for the entire dielectric layer. Also, the external area of the dielectric layer is the area of the region enclosed by the outermost peripheral contour line of the dielectric layer in the plan view of the dielectric layer.

Among them, it is preferable that the width of the supporting portion is in the above range and the ratio of the total area of the supporting portion with respect to the external area of the dielectric layer is in the above range.

The shape of the supporting portion in a plan view is not particularly limited, and examples may include a lattice-shape, and a striped-shape.

When the first dielectric portion of the first dielectric layer includes the first supporting portion, and the second dielectric portion of the second dielectric layer incudes the second supporting portion; and when the thickness of the first supporting portion is equivalent to the thickness of the first dielectric portion, and the thickness of the second supporting portion is equivalent to the thickness of the second dielectric portion, in a plan view, the first dielectric portion and the second dielectric portion are preferably arranged so that the first supporting portion of the first dielectric portion and the second supporting portion of the second dielectric portion overlap each other. The reason therefor is to suppress turbulence on the wavefront of the reflected wave.

Meanwhile, when the first dielectric portion of the first dielectric layer includes the first supporting portion, and the second dielectric portion of the second dielectric layer incudes the second supporting portion; and when the thickness of the first supporting portion is thinner than the thickness of the first dielectric portion, and the thickness of the second supporting portion is thinner than the thickness of the second dielectric portion, in a plan view, the first dielectric portion and the second dielectric portion may be arranged so that the first supporting portion of the first dielectric portion and the second supporting portion of the second dielectric portion overlap each other; and the first dielectric portion and the second dielectric portion may be arranged so that the first supporting portion of the first dielectric portion and the second supporting portion of the second dielectric portion do not overlap each other.

When the dielectric member includes three or more dielectric layers, and when the dielectric portion constituting each dielectric layer includes the supporting portion, and the thickness of the supporting portion is equivalent to the thickness of the dielectric portion, in a plan view, the dielectric portion constituting the upper dielectric layer and the dielectric portion constituting the lower dielectric layer are preferably arranged so that the supporting portions of the dielectric portions overlap each other.

Meanwhile, when the dielectric member includes three or more dielectric layers, and when the dielectric portion constituting each dielectric layer includes the supporting portion, and the thickness of the supporting portion is thinner than the thickness of the dielectric portion, in a plan view, the dielectric portion constituting the upper dielectric layer and the dielectric portion constituting the lower dielectric layer may be arranged so that the supporting portions of the dielectric portions overlap each other; and the dielectric portion constituting the upper dielectric layer and the dielectric portion constituting the lower dielectric layer may be arranged so that the supporting portions of the dielectric portions do not overlap each other.

### (9) Method for Forming Dielectric Layer

The method for forming the dielectric layer is similar to the method for forming the dielectric layer of the first embodiment described above.

### (10) Method for Stacking Dielectric Layer

In the dielectric member, each dielectric layer is stacked. To increase strength, each dielectric layer is preferably joined. Examples of the method for joining the dielectric layers may include a method wherein an adhesive layer is disposed between the upper dielectric layer and the lower dielectric layer; a method wherein the upper dielectric layer and the lower dielectric layer are welded; and a method wherein the dielectric portion constituting each dielectric layer is fixed with a pin that passes through in the thickness direction. In the case of joining method by the adhesive layer and welding method, the upper dielectric layer and the lower dielectric layer are adhered.

In the case of the welding method, it may be a thermal welding, and may be a solvent welding. In the case of thermal welding, meltable material is used for the material of each dielectric layer. In the case of solvent welding, material that can be dissolved in a solvent is used for the material of each dielectric layer.

Among them, the joining method by an adhesive layer is preferable. Since the entire surface of the dielectric portion can be adhered, it is possible to suppress the penetration of moisture or gas into the inside of the dielectric member.

### (a) Adhesive Layer

The dielectric member may include an adhesive layer between the upper dielectric layer and the lower dielectric layer. The upper dielectric layer and the lower dielectric layer are adhered by the adhesive layer. For example, in FIG. 32(a), an adhesive layer 16a is disposed between the first dielectric layer 11 and the second dielectric layer 12.

For the adhesive layer, for example, an adhesive agent may be used, and it may be appropriately selected from known adhesive agents and used. In that case, the adhesive agent needs to be a non-conductor. In addition, when the adhesive agent is in a liquid state, it is preferable that the one can be uniformly spread and have a fluidity to the extent capable of removing the biting of bubbles. In addition, when the adhesive agent is in the form of a sheet, the thickness is preferably uniform, and it is preferable to have flexibility to the extent capable of following the unevenness of the bonding interface and suppressing the biting of bubbles.

The thickness of the adhesive layer is preferably uniform and in thickness to provide the desired adhesive force. Preferably, the thickness of the adhesive layer is sufficiently smaller than the effective wavelength of the target electromagnetic waves, and when the effective wavelength of the electromagnetic waves is λ_{g}, specifically, it is preferably 0.01λ_{g} or less.

Also, when the adhesive layer is located, in each dielectric layer, the adhesive layer may be further located between the adjacent dielectric portions. When the weather resistance of the material of the dielectric layer is low, by the dielectric portion being covered with the adhesive layer, it is possible to suppress the penetration of moisture or gas into the inside of the dielectric member so that the durability may be improved. For example, in FIG. 32(a), the adhesive layer 16b is disposed between the adjacent first dielectric portions 11a and 11b, and the adhesive layer 16b is disposed between the adjacent second dielectric portions 12a, 12b and the adjacent second dielectric portions 12b, 12c.

When applying the adhesive agent, the application method is not particularly limited. For example, in the dip coat method, adhesive agent can be easily applied to the entire surface of the dielectric portion so that the process may be shortened.

### (b) Pin

In the dielectric member, the dielectric portion constituting each dielectric layer may be fixed by a pin that passes through in the thickness direction. Even when the distance between the boundary between the adjacent dielectric portions in the upper dielectric layer and the boundary between the adjacent dielectric portions in the lower dielectric layer are short, the dielectric portions constituting each dielectric layer can be firmly joined in the thickness direction of the dielectric portions. Therefore, the strength of the dielectric member can be increased. In FIG. 32(b) for example, the first dielectric portions 11a, 11b and the second dielectric portions 12a, 12b, 12c are fixed by a pin 17 that passes through the first dielectric portions 11a, 11b and the second dielectric portions 12a, 12b, 12c.

The position of the pin is not particularly limited if it is a position capable of joining the dielectric portions constituting each dielectric layer in the thickness direction of the dielectric member. In the dielectric portion, the pin may be disposed in the dielectric pattern, and may be disposed in the supporting portion.

The material of the pin is preferably the same as the material of the dielectric layer. This reduces the influence of the pin on the reflection properties.

The height of the pin may be lower than the thickness of the dielectric member, and may be higher than the thickness of the dielectric member. Usually, the height of the pin is preferably the same as the thickness of the dielectric member. Specifically, the height of the pin is preferably within +20%, more preferably within +10%, and further preferably within +5% of the thickness of the dielectric member. As described below, when disposing a protective member on the opposite side of the dielectric member to the reflecting member, when the height of the pin is too high, it may be difficult to dispose the protective member. Also, when the height of the pin is too low, the stability of the joining of each dielectric portion in the thickness direction of the dielectric member may be low.

In the plan view, the size of the pin is preferably a size so as not to affect the reflection properties. When the shape in a plan view of the pin is a circular shape, for example, when the wavelength of the electromagnetic waves is regarded as λ, the diameter of the pin is preferably λ or less, and more preferably λ/2 or less. when the size of the pin is too large, it may affect the reflection properties. Also, when the size of the pin is λ/2 or less, resonance is less likely to occur, and the reflection intensity of the electromagnetic waves decreases abruptly. Meanwhile, the lower limit of the size of the pin is not particularly limited if it is a size capable of joining the dielectric portions constituting each dielectric layer.

The shape of the pin in a plan view is not particularly limited, and examples may include a circular shape.

Examples of the method for disposing a pin may include a method wherein a through hole is formed, in the thickness direction, in the dielectric portion constituting each dielectric layer, and a pin is inserted into the through hole.

### (11) Alignment of Dielectric Portion

In the present disclosure, the alignment of the plurality dielectric portions constituting each dielectric layer can be performed using an alignment mark of the substrate. The displacement of the relative position of the dielectric portion may reduce the reflection intensity of the electromagnetic waves, or may change the reflection phase of the electromagnetic waves. By using the alignment mark of the substrate, the alignment of the dielectric portions can be performed with high accuracy. Therefore, the desired reflection properties can be easily obtained.

The alignment a plurality of first dielectric portions constituting the first dielectric layer is hereinafter explained with reference examples. Incidentally, for convenience, the alignment mark provided on the substrate is referred to as the first alignment mark, and the alignment mark provided on the first dielectric portion is referred to as the second alignment mark.

For example, the alignment of the dielectric layer may be performed by aligning the edges of the first dielectric portions based on the first alignment marks of the substrate. Also, for example, the first dielectric portion may include a second alignment mark, and the first dielectric portions may be aligned by aligning the second alignment marks of the first dielectric portions based on the first alignment marks of the substrate.

In FIG. 23 for example, the substrate 21 includes a cross-shaped first alignment mark 22, and the first dielectric portions 11a, 11b are aligned by aligning the edged of the first dielectric portions 11a, 11b, based on the first alignment marks 22 of the substrate 21. Specifically, when the first dielectric pattern is light non-transmissive, the substrate is light transmissive, and the first alignment mark is light non-transmissive, the first dielectric portion can be aligned by detecting the first alignment mark of the substrate and the edge of the first dielectric portion by the transmitted light. Also, when the first dielectric pattern is light reflective, and the first alignment mark is light reflective, the first dielectric portion can be aligned by detecting the first alignment mark of the substrate and the edge of the first dielectric portion by the reflected light.

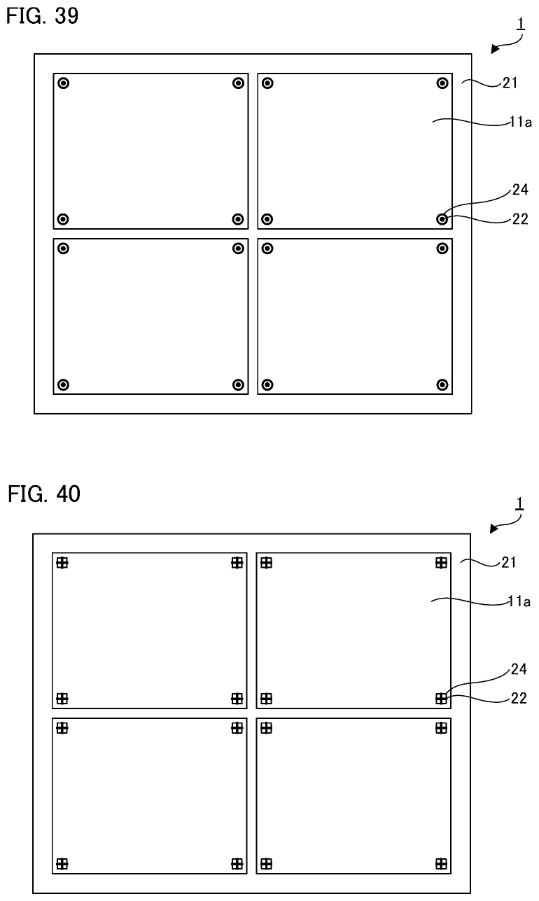

Also, as shown in FIG. 39 for example, the substrate 21 includes a circular-shaped first alignment mark 22, and the first dielectric portion 11a includes a hollow circular-shaped second alignment mark 24, and the first dielectric portions 11a is aligned by aligning the second alignment mark 24 of the first dielectric portion 11a based on the first alignment mark 22 of the substrate 21. Specifically, when the substrate 21 is light transmissive, the first alignment mark 22 is light non-transmissive, and the second alignment mark 24 is light non-transmissive, the first dielectric portion 11a can be aligned by detecting the first alignment mark 22 of the substrate 21 and the second alignment mark 24 of the first dielectric portion 11a by the transmitted light. Also, when the first alignment mark 22 is light reflective, and the second alignment mark 24 is light reflective, the first dielectric portion 11a can be aligned by detecting the first alignment mark 22 of the substrate 21 and the second alignment mark 24 of the first dielectric portion 11a by the reflected light.

The reflective element constituting the reflecting member may be light non-transmissive or light reflective. Even in such cases, it is possible to distinguish transmitted light or reflected light by the first alignment mark and the second alignment mark from transmitted light or reflected light by the reflective element by, for example, making the size of the reflective element significantly different from the size of the first alignment mark and the second alignment mark. Therefore, it is possible to align the frequency selective reflector.

Also, as shown in FIG. 40 for example, when the substrate 21 includes a cross-shaped first alignment mark 22, and the first dielectric portion 11a includes a rectangular-shaped through hole second alignment mark 24, and the first dielectric portion 11a is aligned by aligning the second alignment mark 24 of the first dielectric portion 11a based on the first alignment mark 22 of the substrate 21. Specifically, when the substrate 21 is light transmissive, and the first alignment mark 22 is light non-transmissive, the first dielectric portion 11a can be aligned by detecting the first alignment mark 22 of the substrate 21 via the through hole (second alignment mark 24) of the first dielectric portion 11a by the transmitted light. Also, when the first alignment mark 22 is light reflective, the first dielectric portion 11a can be aligned by detecting the first alignment mark 22 of the substrate 21 via the through hole (second alignment mark 24) of the first dielectric portion 11a by the reflected light.

The alignment a plurality of second dielectric portions constituting the second dielectric layer is similar to the alignment a plurality of first dielectric portions constituting the first dielectric layer described above.

Also, when the dielectric member includes three or more dielectric layers, the alignment of a plurality of dielectric portions constituting the dielectric layer other than the first dielectric layer and the second dielectric layer is also similar to the alignment of a plurality of first dielectric portions constituting the first dielectric layer described above.

### (a) Second Alignment Mark

In the present disclosure, the first dielectric portion constituting the first dielectric layer and the second dielectric portion constituting the second dielectric layer may include alignment marks. The alignment mark provided on the first dielectric portion is a mark used to align the first dielectric portion. Also, the alignment mark provided on the second dielectric portion is a mark used to align the second dielectric portion.

Also, when the dielectric member includes three or more dielectric layers, the plurality of dielectric portions constituting the dielectric layer other than the first dielectric layer and the second dielectric layer may also include an alignment mark as similar to the first dielectric portion and the second dielectric portion.

The alignment mark provided on first dielectric portion constituting the first dielectric layer is hereinafter explained with reference examples. Incidentally, for convenience, the alignment mark provided on the first dielectric portion is referred to as a second alignment mark.

The second alignment mark may be light non-transmissive. Also, the second alignment mark may be light reflective. These optical properties of the second alignment mark are selected accordingly depending on whether the second alignment mark is detected by transmitted light or reflected light.

The transmittance and the reflectance of the second alignment mark are not particularly limited if the second alignment mark can be detected by transmitted light or the reflected light, and can be appropriately set according to, for example, the material, or the thickness of the second alignment mark.

Also, the second alignment mark may be a through hole that passes through the first dielectric pattern.

The shape of the second alignment mark in a plan view is not particularly limited, and is similar to the shape of a general alignment mark in a plan view. Specific examples of the shape of the second alignment mark in a plan view is similar to the shape of the first alignment mark in a plan view described above.

The size or line width of the second alignment mark is not particularly limited if the second alignment mark can be detected, and preferably the size or the line width so as not to affect the reflection properties. When the wavelength of the electromagnetic waves is regarded as A, the size of the second alignment mark is preferably λ×λ or less, and more preferably λ/2×λ/2 or less. Also, when the wavelength of the electromagnetic waves is regarded as λ, the line width of the second alignment mark is preferably λ or less, and more preferably λ/2 or less. when the size and the line width of the second alignment mark are too large, it may affect the reflection properties. Also, when the size of the second alignment mark is λ/2×λ/2 or less, or when the line width of the second alignment mark is λ/2 or less, resonance is less likely to occur, and the reflection intensity of the electromagnetic waves decreases abruptly. Meanwhile, the lower limit of the size or line width of the second alignment mark is not particularly limited if the second alignment mark can be detected.

The number of the second alignment marks is not particularly limited if it is capable of aligning the first dielectric portion.

Also, the ratio of the total area of the second alignment mark with respect to the total area of the first dielectric portion is preferably 20% or less, more preferably 10% or less, and further preferably 5% or less. If the ratio is too much, the performance of the frequency selective reflector may be degraded. Meanwhile, the lower limit of the ratio is not particularly limited if the second alignment mark can be detected.

The method for measuring the ratio of the total area of the second alignment mark with respect to the total area of the first dielectric portion is similar to the method for measuring the ratio of the total area of the supporting portion with respect to the total area of the dielectric portion described above.

The position of the second alignment mark in the first dielectric portion is not particularly limited, and the second alignment mark is preferably disposed on the first supporting portion of the first dielectric portion, and more preferably disposed on the first supporting portion disposed on the outer periphery of the first dielectric portion.

The second alignment mark may be disposed on the reflecting member side surface of the first dielectric portion, and may be disposed on the opposite side of the first dielectric portion to the reflecting member.

The thickness the second alignment mark is not particularly limited if it is a thickness capable of forming the second alignment mark in high precision, and is appropriately adjusted according to the optical properties of the second alignment mark.

The material of and the method for forming the second alignment mark are similar to the material of and the method for forming of the first alignment mark described above.

The alignment mark provided on the second dielectric portion constituting the second dielectric layer is similar to the second alignment mark provided on the first dielectric portion constituting the first dielectric layer described above.

Also, when the dielectric member includes three or more dielectric layers, the alignment mark provided on the dielectric portion constituting the dielectric layer other than the first dielectric layer and the second dielectric layer is also similar to the second alignment mark provided on the first dielectric portion constituting the first dielectric layer described above.

### (b) Second Identification Mark

In the present disclosure, the plurality of first dielectric portions constituting the first dielectric layer may include an identification mark for identifying the first dielectric portion. Also, the plurality of second dielectric portions constituting the second dielectric layer may include an identification mark for identifying the second dielectric portion.

Also, when the dielectric member includes three or more dielectric layers, the plurality of dielectric portions constituting the dielectric layer other than the first dielectric layer and the second dielectric layer may include an identification mark for identifying the dielectric portion.

By the plurality of dielectric portions constituting each dielectric layer including the identification mark, each dielectric portion can be easily identified, and the top, bottom, left and right, or front and rear of the dielectric portion can be easily identified, so that each dielectric portion can be disposed reliably and easily in the correct position. In particular, it is useful when the dielectric member includes a plurality of reflective regions of different reflective properties from each other.

The identification mark provided on first dielectric portion constituting the first dielectric layer is hereinafter explained with reference examples. Incidentally, for convenience, the identification mark provided on the first dielectric portion is referred to as a second identification mark.

For example, in FIG. 24, the first dielectric portions 11a, 11b respectively include second identification marks 25 of “No 1” and “No 2”.

The second identification mark may be light non-transmissive. Also, the second identification mark may be light reflective. As similar to the second alignment mark, these optical properties of the second identification mark are selected accordingly depending on whether the second identification mark is detected by transmitted light or reflected light.

The transmittance and the reflectance of the second identification mark are not particularly limited if the second identification mark can be detected by transmitted light or the reflected light, and can be appropriately set according to, for example, the material, or the thickness of the second identification mark.

The second identification mark is not particularly limited if it is a mark that is able to be identified, and examples thereof may include letters, symbols, and figures. Specific examples may include codes. Also, the second identification mark may be data capable of being recognized by Optical Character Recognition (OCR).

The size or line width of the second identification mark is not particularly limited if the second identification mark can be detected, and it is similar to the size or line width of the second alignment mark described above.

The position of the second identification mark in the first dielectric portion is not particularly limited if each first dielectric portion can be identified, and the second identification mark is preferably disposed on the first supporting portion of the first dielectric portion, and more preferably disposed on the first supporting portion disposed on the outer periphery of the first dielectric portion.

The second identification mark may be disposed on the reflecting member side of the first dielectric portion, and may be disposed on the opposite side of the first dielectric portion to the reflecting member.

The thickness, material of and the method for forming the second identification mark are similar to the thickness, material of and the method for forming of the second alignment mark described above.

When the material of the second identification mark is identical to the material of the second alignment mark, the second alignment mark and the second identification mark can be formed at the same time.

The identification mark provided on the second dielectric portion constituting the second dielectric layer is similar to the second identification mark provided on the first dielectric portion constituting the first dielectric layer described above.

Also, when the dielectric member includes three or more dielectric layers, the identification mark provided on the dielectric portion constituting the dielectric layer other than the first dielectric layer and the second dielectric layer is also similar to the second identification mark provided on the first dielectric portion constituting the first dielectric layer described above.

### (c) Concave and Convex Portion

In the first dielectric layer in the present embodiment, adjacent first dielectric portions may include concave and convex portions, on the sides those are facing to each other, capable of engaging with each; and the adjacent first dielectric portions may be arranged so that the concave and convex portions are engaged with each other. By engaging the concave and convex portions, the alignment of the plurality of first dielectric portions can be easily performed. Also, since the contacting area of the adjacent first dielectric portions is increased, the strength may be increased.

Also, similarly to the first dielectric layer described above, in the second dielectric layer in the present embodiment, adjacent second dielectric portions may include concave and convex portions, on the sides those are facing to each other, capable of engaging with each; and the adjacent second dielectric portions may be arranged so that the concave and convex portions are engaged with each other.

Also, similarly to the first dielectric layer described above, when the dielectric member includes three or more dielectric layers, also in the dielectric layer other than the first dielectric layer and the second dielectric layer, adjacent dielectric portions may include concave and convex portions, on the sides those are facing to each other, capable of engaging with each; and the adjacent dielectric portions may be arranged so that the concave and convex portions are engaged with each other.

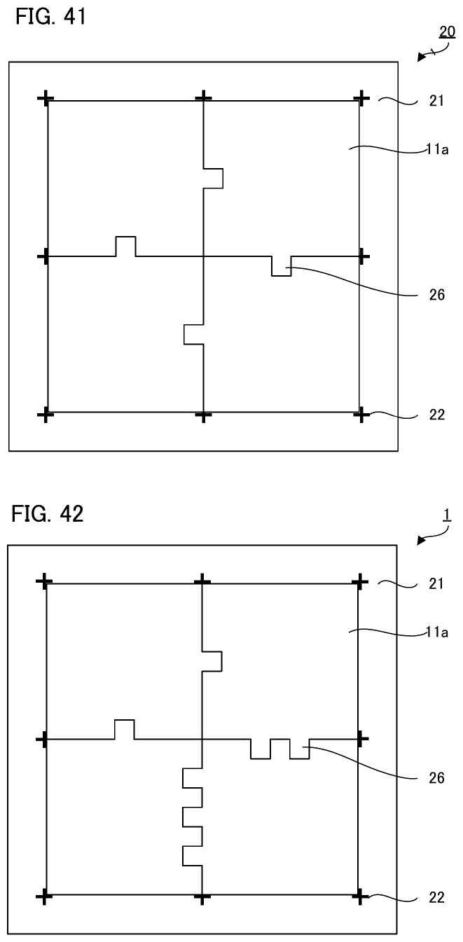

In FIG. 41 and FIG. 42 for example, in the first dielectric layer, adjacent first dielectric portions 11a include concave and convex portions 26, on the sides those are facing to each other, capable of engaging with each; and the adjacent first dielectric portions are arranged so that the concave and convex portions 26 are engaged with each other.

Also, in FIG. 42 for example, the number of concave and convex portions 26 in each first dielectric portion 11a differs from each other. In this way, if the number, shape, size, for example, of the concave and convex portion in each first dielectric portion differs from each other, the first dielectric portion can be identified. Therefore, each first dielectric portion can be easily identified, and the top, bottom, left and right, or front and rear of the first dielectric portion can be easily identified, so that each first dielectric portion can be disposed reliably and easily in the correct position.

The shape of the concave and convex portion is not particularly limited if it is a shape which can be engaged.

The number and size of the concave and convex portion is not particularly limited if it is possible to form the concave and convex portion on the side of the dielectric portion constituting each dielectric layer.

In the adjacent dielectric portions, the thicknesses of the concave and convex portions are preferably equal. The alignment of the adjacent dielectric portions is facilitated.

On the sides of the adjacent dielectric portions those are facing to each other, the concave and convex portions may not be engaged without a gap. That is, there may be a gap between the engaged concave and convex portions.

### 3. Reflecting Member

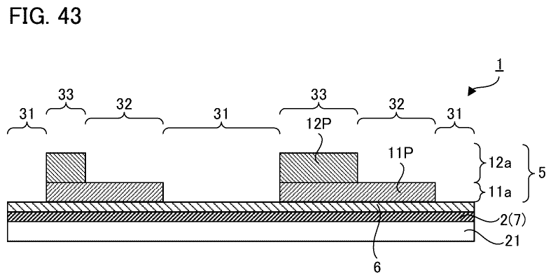

The reflecting member in the present embodiment is a member that reflects electromagnetic waves in a particular frequency band. The reflecting member is similar to the reflecting member of the first embodiment described above. For example, FIG. 43 is an example in which the reflecting member 2 is a reflective layer 7, and the reflective layer 7 is disposed on the entire surface of the substrate 21. Also, for example, FIG. 21 is an example in which the reflecting member 2 is a frequency selective plate, and the reflecting member 2 includes a dielectric substrate 4 and a plurality of reflective elements 3 arranged on a surface of the dielectric substrate 4 that is the dielectric member 5 side.

When the reflecting member includes a dielectric substrate and a plurality of reflective elements, the dielectric substrate may also serve as a substrate.

When the reflecting member is a frequency selective plate, one reflecting member may be disposed on one side of the substrate, and a plurality of reflecting members may be disposed next to each other.

When a plurality of reflecting members is disposed next to each other on one side of the substrate, the alignment of the reflecting members is similar to the alignment of the dielectric portions described above.

### 4. Control of Reflection Direction of Electromagnetic Waves

In the frequency selective reflector of the present embodiment, by stacking respective dielectric layer and varying the thickness of each region in the dielectric member, the round-trip optical path length in the dielectric member can be varied per region, and the relative reflection phase of the electromagnetic waves can be controlled. Also, in addition to the thickness of each region, by adjusting the pitch of each region, the size of each region, and the arrangement of each region, for example, the reflection direction of electromagnetic waves injected from a predetermined direction can be controlled.

In addition, when the reflecting member is a frequency selective plate and is a member having a reflection phase control function, by varying the thickness of each region, not only the round-trip optical path length in the dielectric member can be varied per region, but also, by varying the size or shape of the reflective element of the reflecting member, the resonance frequency per reflective element can be varied to control the reflection phase of the electromagnetic waves. Thereby, the degree of freedom of design related to the reflection property control can be increased.

In this case, it is also possible to divide the reflection control direction in the reflecting member and the reflection control direction in the dielectric member, and perform two-dimensional reflection direction control in the entire frequency selective reflector. Also, when the reflection control directions in the reflecting member and the dielectric member are overlapped, for example, a reflection phase distribution to be reflected in a certain direction to some degree can be achieved by the reflecting member, and further fine adjustment can be performed in the dielectric member. In this case, there is an advantage that the thickness of the dielectric member can be reduced.

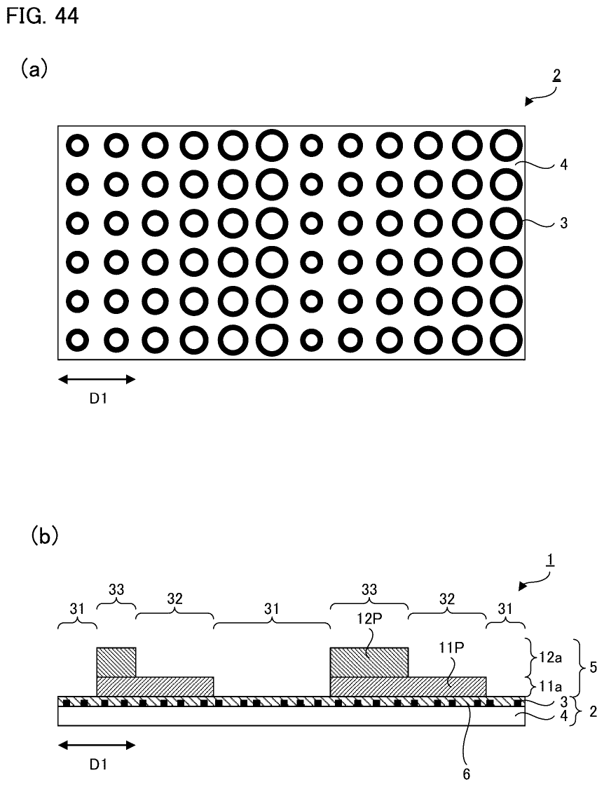

As the arrangement of the thickness distribution of the dielectric member and the size distribution of the reflective element of the reflecting member, for example, as shown in FIG. 44(b), the dielectric member 5 and the reflecting member 2 can be arranged so that the thickness of the dielectric member 5 becomes thicker as the size of the reflective element 3 of the reflecting member 2 increases. In such an aspect, the thickness of the dielectric member can be reduced. This makes it possible to reduce the weight and cost of the frequency selective reflector because the dielectric member is thin. This makes the reflected waves less likely to hit the dielectric member even when the reflection angle increases.

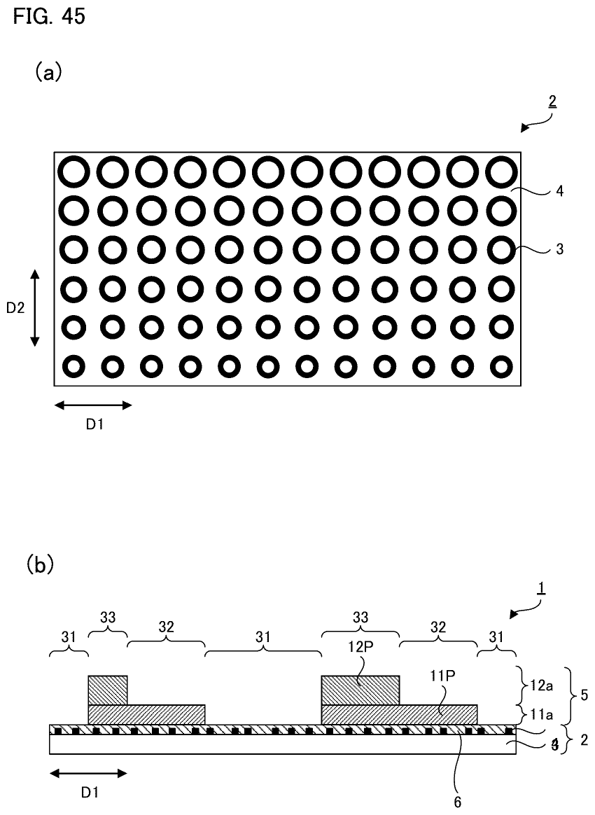

As an arrangement of the thickness distribution of the dielectric member and the size distribution of the reflective element of the reflecting member, for example, as shown in FIG. 45, the dielectric member 5 and the reflecting member 2 may be arranged such that the size of the reflective element 3 of the reflecting member 2 is increased along the direction D2, and the thickness of the dielectric member 5 becomes thicker along the direction D2.

In FIG. 45, since the sizes of the reflective element are different, the relative reflection phase of the electromagnetic waves in a unit region, in which each reflective element is disposed, is partially different according to the sizes of the reflective element.

Also, in the case of a specification in which the reflecting member and the dielectric member are separately designed and combined, the reflection direction of the electromagnetic waves can be finely adjusted by rotating the dielectric member in the plane with the normal direction as an axis, with respect to the reflecting member, to adjust the orientation direction of each region of the dielectric member relative to the reflecting member.

Also, as described above, in the dielectric member, the reflection properties can be controlled by adjusting the pitch of each region. For example, by shortening the pitch of each region, the reflection angle of the electromagnetic waves can be increased, while the reflection angle of the electromagnetic waves can be reduced by lengthening the pitch of each region.

As described above, the in-plane arrangement of each region of the dielectric member that achieves the in-plane distribution design of the reflection phase in the frequency selective reflector does not need to be in a fixed positional relationship with respect to the in-plane arrangement of the reflective element of the reflecting member, and even if each region of the dielectric member is shifted and arranged relative to the in-plane arrangement of the reflective element, there is no significant effect on the reflection properties. Thus, when the reflecting member is a frequency selective plate and is a member having a reflection phase control function, it is possible to independently design the dielectric member and the reflecting member, respectively.

### 5. Other Configurations

The frequency selective reflector of the present embodiment may include other configurations as required in addition to the reflecting member and the dielectric member described above.

### (1) Adhesive Member

The frequency selective reflector of the present embodiment may include an adhesive member between the reflecting member and the dielectric member. For example, in FIG. 21(a), an adhesive member 6 is disposed between the reflecting member 2 and the dielectric member 5. The adhesive member is similar to the adhesive layer of the first embodiment described above.

### (2) Space

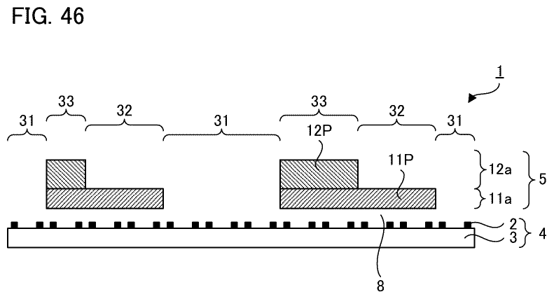

The frequency selective reflector of the present embodiment may include a space between the reflecting member and the dielectric member. For example, in FIG. 46, a space 8 is arranged between the reflecting member 2 and the dielectric member 5.

When a space is arranged between the reflecting member and the dielectric member, the distance between the reflecting member and the dielectric member is preferably constant. This makes it possible to align the optical path lengths in the space.

### (3) Protective Member

The frequency selective reflector of the present embodiment may include a protective member on an opposite side of the dielectric member to the reflecting member. The protective member is similar to the cover member of the first embodiment described above.

### (4) Ground Layer

The frequency selective reflector of the present embodiment may include a ground layer on an opposite side of the reflecting member to the dielectric member. In addition, if the reflecting member reflects not only electromagnetic waves in a particular frequency band but also electromagnetic waves in other frequency bands, that is, if the reflecting member does not have wavelength selectivity, the reflecting member may include a reflective layer that also serves as a ground layer. The ground layer is similar to the ground layer of the first embodiment described above.

### (5) Planarizing Layer

The frequency selective reflector of the present embodiment may include a planarizing layer between the reflecting member and the dielectric member. The planarizing layer is similar to the planarizing layer of the first embodiment described above.

### (6) Fixing Member

When the frequency selective reflector of the present embodiment is used by being attached to a wall or the like, a fixing member having a mechanism for attaching the frequency selective reflector may be disposed on the opposite side of the reflecting member to the dielectric member. The fixing member is similar to the fixing layer of the first embodiment described above.

### (7) Anti-Reflective Layer

Because of the impact of reflections at the dielectric member interface in the case of high frequency radio waves, in the frequency selective reflector of the present embodiment, an anti-reflective layer may be disposed in the interface between the dielectric member and the air, as necessary. The anti-reflective layer is similar to the anti-reflective layer of the first embodiment described above.

### (8) Second Adhesive Member

The frequency selective reflector of the present embodiment may include a second adhesive member between the substrate and the reflecting member. The second adhesive member is a member configured to directly or indirectly adhere the reflecting member to the substrate.

For the second adhesive member, for example, an adhesive agent may be used, and may be appropriately selected from known adhesive agents and pressure-sensitive adhesive agents.

The thickness of the second adhesive member is not particularly limited as long as a desired adhesion force may be obtained.

### (9) Interference Mitigation Layer

The frequency selective reflector of the present embodiment may include an interference mitigation layer, mitigating the property variation due to the interaction with the surface on which the frequency selective reflector is installed, on an opposite side of the substrate to the reflecting member. The interference mitigation layer is similar to the interference mitigation layer of the first embodiment described above.

### 6. Other Points of Frequency Selective Reflector

The other points of the frequency selective reflector of the present embodiment are similar to the other points of the frequency selective reflector of the first embodiment described above.

### B. Dielectric Layer

The dielectric layer in the present disclosure is a member used for the first embodiment of the frequency selective reflector described above.

Incidentally, the dielectric layer is similar to that described in the section “A. Frequency selective reflector, I. First embodiment, 1. Dielectric layer” above; thus, the descriptions herein are omitted.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

The present disclosure is hereinafter explained specifically with reference to Examples.

### Example 1

Simulation of the reflection properties of the frequency selective reflector was performed. In the simulation, a model including a pattern as shown in FIGS. 1(a), (b) was used. The first region and the second region of the dielectric layer of the pattern had thicknesses so that the difference in the relative reflection phase between the first region and the second region was 180 degrees. Also, in the simulation, the reflecting member was a model in which ring-shaped reflective elements were regularly arranged, resonated at the frequency of the incident wave, and reflected the electromagnetic waves at that frequency. Also, the following parameters were used in the simulation.
Frequency of incident wave: 28 GHZ
Incident angle of incident wave: θ=63 degrees, φ=170 degrees
Desired reflection angle of the reflected wave: θ=26 degrees, φ=0 degrees
Difference in relative reflection phase between first region and second region: 180 degrees
Transmitted power: 32 [dBm EIRP]
Receive antenna gain: 0 [dBi]
Distance from transmission point to frequency selective reflector: 15 [m]
Distance from frequency selective reflector to receiving point: 14 [m]

Incidentally, in the simulation, the frequency selective reflector was disposed at the origin of the coordinate of the right-handed system.

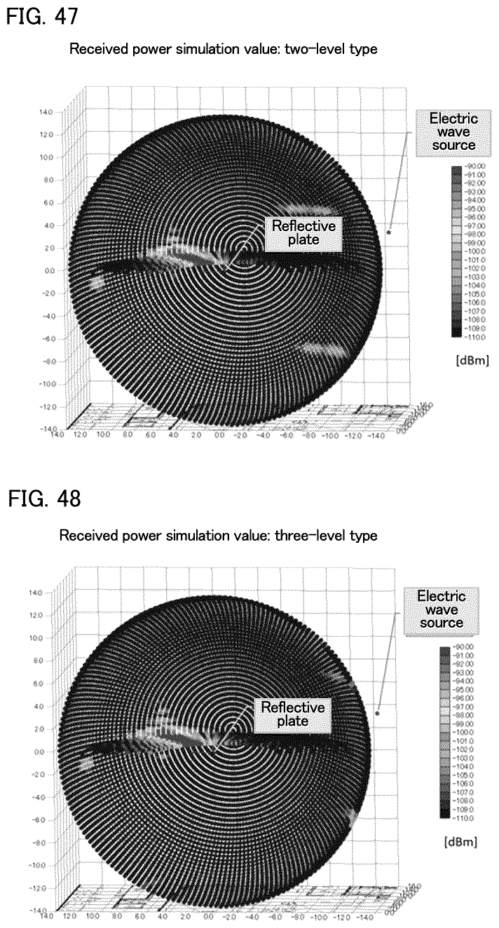

The results of the simulation using a ray trace method under the conditions described above are shown in FIG. 47.

### Example 2

Simulation of the reflection properties of the frequency selective reflector was performed. In the simulation, a model including a pattern as shown in FIGS. 10(a), (b), FIGS. 11(a), (b), and FIG. 12(a) was used. In the pattern, a dielectric layer included a first dielectric layer and a second dielectric layer; and a first region and a second region of the first dielectric layer and a first region and a second region of the second dielectric layer had thicknesses so that the difference in the relative reflection phase between the region wherein the first region of the first dielectric layer and the first region of the second dielectric layer overlapped, and the region wherein the second region of the first dielectric layer and the first region of the second dielectric layer overlapped was 120 degrees; and the difference in the relative reflection phase between the region wherein the first region of the first dielectric layer and the first region of the second dielectric layer overlapped, and the region wherein the second region of the first dielectric layer and the second region of the second dielectric layer overlapped was 240 degrees. Also, in the simulation, the reflecting member was a model in which ring-shaped reflective elements were regularly arranged, resonated at the frequency of the incident wave, and reflected the electromagnetic waves in that frequency. Also, the following parameters were used in the simulation.
Frequency of incident wave: 28 GHz
Incident angle of incident wave: θ=63 degrees, φ=170 degrees
Desired reflection angle of the reflected wave: θ=26 degrees, φ=0 degrees

Difference in the relative reflection phase between the region wherein the first region of the first dielectric layer and the first region of the second dielectric layer overlapped, and the region wherein the second region of the first dielectric layer and the first region of the second dielectric layer overlapped: 120 degrees

Difference in the relative reflection phase between the region wherein the first region of the first dielectric layer and the first region of the second dielectric layer overlapped, and the region wherein the second region of the first dielectric layer and the second region of the second dielectric layer overlapped: 240 degrees
Transmitted power: 32 [dBm EIRP]
Receive antenna gain: 0 [dBi]
Distance from transmission point to frequency selective reflector: 15 [m]
Distance from frequency selective reflector to receiving point: 14 [m]

Incidentally, in the simulation, the frequency selective reflector was disposed at the origin of the coordinate of the right-handed system.

The results of the simulation using a ray trace method under the conditions described above are shown in FIG. 48.

### Reference Example 1

Simulation of the reflection properties of the frequency selective reflector was performed. In the simulation, a model wherein the cross-sectional shape of the dielectric layer was a step shape, and the number of steps was 81, was used. Also, in the simulation, the reflecting member was a model in which ring-shaped reflective elements were regularly arranged, resonated at the frequency of the incident wave, and reflected the electromagnetic waves in that frequency. Also, the following parameters were used in the simulation.
Frequency of incident wave: 28 GHZ
Incident angle of incident wave: θ=63 degrees, φ=170 degrees
Desired reflection angle of the reflected wave: θ=26 degrees, φ=0 degrees
Difference in relative reflection phase between neighboring steps: approximately 4.4 degrees
Transmitted power: 32 [dBm EIRP]
Receive antenna gain: 0 [dBi]
Distance from transmission point to frequency selective reflector: 15 [m]
Distance from frequency selective reflector to receiving point: 14 [m]

Incidentally, in the simulation, the frequency selective reflector was disposed at the origin of the coordinate of the right-handed system.

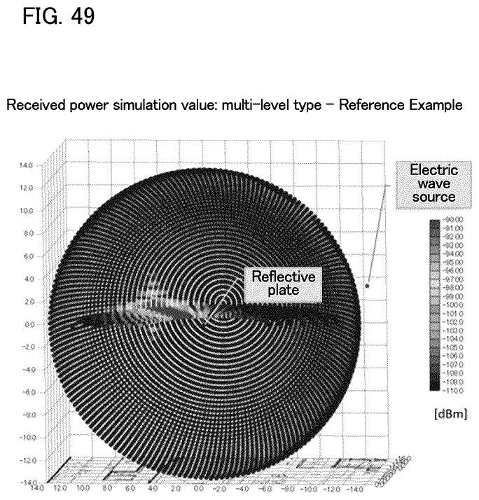

The results of the simulation using a ray trace method under the conditions described above are shown in FIG. 49.

### Example 3

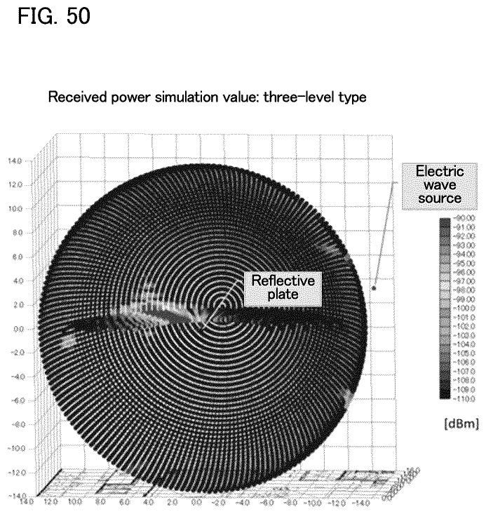

Simulation of the reflection properties of the frequency selective reflector was performed. In the simulation, a model wherein the dielectric member included a first dielectric layer and a second dielectric layer, in this order from the reflecting member side, was used. As shown in FIG. 21(a) for example, the dielectric member included, an A1 region 31 which did not include the first dielectric pattern and the second dielectric pattern; an A2 region 32 including only the first dielectric pattern; and an A3 region 33 including the first dielectric pattern and the second dielectric pattern. Also, the reflecting member was a model in which ring-shaped reflective elements were regularly arranged, resonated at the frequency of the incident wave, and reflected the electromagnetic waves in that frequency. A simulation using a ray trace method under the following conditions was performed. The frequency selective reflector was disposed at the origin of the coordinate of the right-handed system. The results are shown in FIG. 50.
Frequency of incident wave: 28 GHZ
Incident angle of incident wave: θ=63 degrees, φ=170 degrees
Desired reflection angle of the reflected wave: θ=26 degrees, φ=0 degrees
Difference in relative reflection phase of electromagnetic waves between A1 region 31 and A2 region 32: 120 degrees
Difference in relative reflection phase of electromagnetic waves between A1 region 31 and A3 region 33: 240 degrees
Transmitted power: 32 [dBm EIRP]
Receive antenna gain: 0 [dBi]
Distance from transmission point to frequency selective reflector: 15 [m]
Distance from frequency selective reflector to receiving point: 14 [m]

### Reference Example 2

The control of the reflection direction of the electromagnetic waves by controlling a relative reflection phase distribution of the electromagnetic waves, by the thickness distribution of the dielectric member, is explained with reference to Reference Examples 2 to 3.

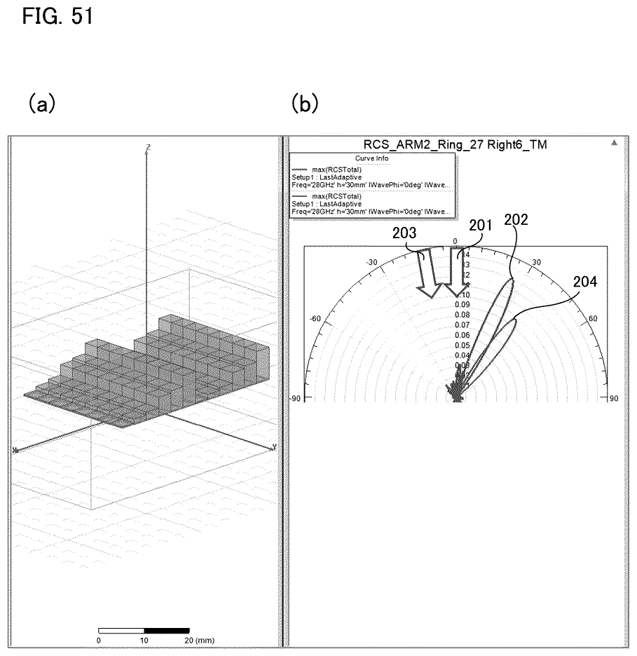

Simulation of the reflection properties of the frequency selective reflector was performed. In the simulation, as shown in FIG. 51(a), a model wherein the unit structure of the dielectric member included a thickness distribution in which the thickness increases in one direction, and included six cell regions with thicknesses different from each other; and in the dielectric member, the unit structure included a periodic structure repeatedly arranged in one direction, was used. Also, in the simulation, the reflecting member was a model in which ring-shaped reflective elements were regularly arranged, resonated at the frequency of the incident wave, and reflected the electromagnetic waves in that frequency. Also, the following parameters were used in the simulation.
Frequency of incident wave: 28 GHZ
Incident angle of the incident wave: 0 degrees, −10 degrees
Desired reflection angle of the reflected wave: 27 degrees, 37 degrees
Difference in relative reflection phase between neighboring cell regions: 60 degrees

The results of the simulation are shown in FIG. 51(b). When the incident angle was 0 degrees, which means the reflection to the incident from the front surface direction 201, was shown in solid line indicated as reference sign 202, and if the incident angle was −10 degrees, which means the reflection to incidence from −10 degrees direction 203, was shown in solid line indicated as reference sign 204. It can be seen that when the incident angle was 0 degrees, it was reflected to the +27 degrees direction from the regular reflection direction, and when the incident angle was −10 degrees, it was reflected to the +37 degrees direction from the regular reflection direction.

### Reference Example 3

First, in accordance with the model of the reflecting member of Reference Example 2, a copper foil-attached PET film was etched to create a reflecting member in which ring-shaped reflective elements are regularly arranged. Also, a dielectric member was formed by a 3D printer in accordance with the model of the dielectric member of Reference Example 2. The dielectric member was then applied on the reflecting member to create a frequency selective reflector.

The reflection properties of the frequency selective reflector were measured using a compact range measurement system and a network analyzer. The reflection properties of the frequency selective reflector of Reference Example 3 substantially matched with the simulation results of Reference Example 2.

### Reference Example 4

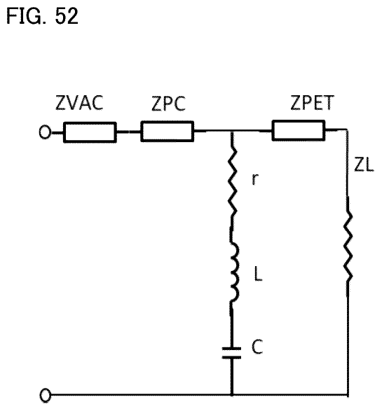

The reflection phase was calculated for a frequency selective reflector with a reflecting member including frequency selective surface (FSS) and a dielectric layer, using a general transmission line equivalent circuit, as shown in FIG. 52, in the analysis of the reflect array. Incidentally, the symbols in FIG. 52 are as follows:
ZVAC: A transmission line with a characteristic impedance of air. The line length is a length obtained by subtracting the thickness of the dielectric layer from a phase observation surface set at any distance farther than the top surface of the dielectric layer.
ZPC: A transmission line with a characteristic impedance of a dielectric layer. The line length is the thickness of the dielectric layer.
r: Resistance of the ring-shaped reflective element of the FSS.
L: The inductance of the ring-shaped reflective element of the FSS.
C: Capacity of the ring-shaped reflective element of the FSS.
ZPET: A transmission line having a dielectric constant of a dielectric substrate on which the ring-shaped reflective element of FSS is arranged. The line length is the thickness of the dielectric substrate.
ZL: The characteristic impedance of the space (air) on the back surface of the dielectric substrate.

As a result, the reflection phase variation due to the resonance frequency shift caused by the superposition of the dielectric layers of different thicknesses in the reflection phase was at most several tens of degrees, which was around 25% of the maximum reflection phase 360 degrees, and other reflection phase variations were calculated to be due to wavelength shortening in the dielectric layer. Further, even if the positions of the reflecting member including the frequency selective surface and the dielectric layer are misaligned, the shift is equalized throughout the frequency selective reflector, but it can be concluded that there is little effect on the reflection direction given that the reflection phase with the neighboring region may be equal to make the reflected wave to be a plane wave.

The present disclosure provides the following inventions.

[1]

A frequency selective reflector reflecting electromagnetic waves in a particular frequency band of 24 GHz or more in a direction different from a regular reflection direction, the frequency selective reflector comprising:
a reflecting member reflecting the electromagnetic waves; and
a dielectric layer that is disposed at an incident side of the electromagnetic waves with respect to the reflecting member and transmits the electromagnetic waves,
the dielectric layer has two types of thicknesses, and includes a plurality of first regions with thinner thickness and a plurality of second regions with thicker thickness.
   [2]

The frequency selective reflector according to [1], wherein the thickness of the first region is 0.

[3]

The frequency selective reflector according to [1] or [2], wherein the reflecting member is a frequency selective plate reflecting only the electromagnetic waves.

[4]

The frequency selective reflector according to [3], wherein the reflecting member has a reflection phase control function that controls a reflection phase of the electromagnetic waves.

[5]

The frequency selective reflector according to any one of [1] to [4], wherein an absolute value of a difference between a relative reflection phase of the electromagnetic waves in the first region and a relative reflection phase of the electromagnetic waves in the second region is more than 0 degrees and less than 360 degrees.

[6]

The frequency selective reflector according to any one of [1] to [5], wherein the dielectric layer includes a resin.

[7]

The frequency selective reflector according to [6], wherein the dielectric layer includes a filler.

[8]

The frequency selective reflector according to any one of [1] to [7], wherein the frequency selective reflector includes a ground layer on an opposite side of the reflecting member to the dielectric layer; or the reflecting member includes a reflective layer also serving as a ground layer.

[9]

The frequency selective reflector according to any one of [1] to [8], further comprising an adhesive layer between the reflecting member and the dielectric layer.

[10]

The frequency selective reflector according to any one of [1] to [8], further comprising a space between the reflecting member and the dielectric layer.

[11]

The frequency selective reflector according to any one of [1] to [10], further comprising a cover member on an opposite side of the dielectric layer to the reflecting member.

[12]

The frequency selective reflector according to any one of [1] to [11], wherein a frequency of the electromagnetic waves is 300 GHz or less.

[13]

The frequency selective reflector according to any one of [1] to [12], wherein the dielectric layer includes a supporting portion supporting the second region.

[14]

A frequency selective reflector reflecting electromagnetic waves in a particular frequency band in a direction different from a regular reflection direction, the frequency selective reflector comprising:
a substrate;
a reflecting member disposed on one side of the substrate, and reflecting the electromagnetic waves; and
a dielectric member disposed on an opposite side of the reflecting member to the substrate, and transmits the electromagnetic waves,
the dielectric member includes a first dielectric layer and a second dielectric layer, in this order from the reflecting member side;
the first dielectric layer includes a plurality of first dielectric portions disposed on an opposite side of the reflecting member to the substrate;
the second dielectric layer includes a plurality of second dielectric portions disposed on an opposite side of the first dielectric layer to the reflecting member;
the second dielectric portion is arranged so that the second dielectric portion overlaps a boundary of the adjacent first dielectric portions in a plan view; and
the first dielectric portion includes a first dielectric pattern, and the second dielectric portion includes a second dielectric pattern.
   [15]

The frequency selective reflector according to [14], wherein the dielectric member includes, an A1 region which does not include the first dielectric pattern and the second dielectric pattern from the reflecting member side; an A2 region including only the first dielectric pattern from the reflecting member side; and an A3 region including the first dielectric pattern and the second dielectric pattern from the reflecting member side.

[16]

The frequency selective reflector according to or [15], wherein, in a plan view, a distance between a boundary of the adjacent first dielectric portions and a boundary of the adjacent second dielectric portions is ⅓ or more of a thickness of the dielectric member.

[17]

The frequency selective reflector according to any one of [14] to [16], wherein the substrate includes an alignment mark.

[18]

The frequency selective reflector according to any one of [14] to [17], wherein the first dielectric portion and the second dielectric portion include alignment marks.

[19]

The frequency selective reflector according to any one of [14] to [18], wherein the first dielectric portion includes a first supporting portion supporting the first dielectric pattern, and the second dielectric portion incudes a second supporting portion supporting the second dielectric pattern.

[20]

The frequency selective reflector according to [19], wherein, in a plan view, the first dielectric portion and the second dielectric portion are arranged so that the first supporting portion and the second supporting portion overlap each other.

[21]

The frequency selective reflector according to any one of [14] to [20], wherein the first dielectric portion and the second dielectric portion are fixed by a pin that passes through the first dielectric portion and the second dielectric portion.

[22]

The frequency selective reflector according to any one of [14] to [20], wherein the first dielectric layer and the second dielectric layer are adhered together.

[23]

The frequency selective reflector according to or any one of [14] to [22], wherein
the dielectric member includes the first dielectric layer, the second dielectric layer, and a third dielectric layer in this order from the reflecting member side; the third dielectric layer includes a plurality of third dielectric portions disposed on an opposite side of the second dielectric layer to the first dielectric layer; the third dielectric portion includes a third dielectric pattern; and the dielectric member includes, a B1 region which does not include the first dielectric pattern, the second dielectric pattern, and the third dielectric pattern from the reflecting member side, a B2 region including only the first dielectric pattern from the reflecting member side, a B3 region including only the first dielectric pattern and the second dielectric pattern from the reflecting member side, and a B4 region including the first dielectric pattern, the second dielectric pattern, and the third dielectric pattern from the reflecting member side;
the dielectric member includes a third dielectric layer, the first dielectric layer, and the second dielectric layer in this order from the reflecting member side; the third dielectric layer includes a plurality of third dielectric portions disposed on an opposite side of the reflecting member to the substrate; the third dielectric portion includes a third dielectric pattern; and the dielectric member includes, a C1 region which does not include the third dielectric pattern, the first dielectric pattern, and the second dielectric pattern from the reflecting member side, a C2 region including only the third dielectric pattern from the reflecting member side, a C3 region including only the third dielectric pattern and the first dielectric pattern from the reflecting member side, and a C4 region including the third dielectric pattern, the first dielectric pattern, and the second dielectric pattern from the reflecting member side; or
the dielectric member includes the first dielectric layer, a third dielectric layer, and the second dielectric layer in this order from the reflecting member side; the third dielectric layer includes a plurality of third dielectric portions disposed on an opposite side of the first dielectric layer to the reflecting member; the third dielectric portion includes a third dielectric pattern; and the dielectric member includes, a D1 region which does not include the first dielectric pattern, the third dielectric pattern, and the second dielectric pattern from the reflecting member side, a D2 region including only the first dielectric pattern from the reflecting member side, a D3 region including only the first dielectric pattern and the third dielectric pattern from the reflecting member side, and a D4 region including the first dielectric pattern, the third dielectric pattern, and the second dielectric pattern from the reflecting member side.
   [24]

The frequency selective reflector according to [23], wherein, in a plan view, the third dielectric portion is arranged so that the third dielectric portion overlaps a boundary of the adjacent first dielectric portions, and the third dielectric portion overlaps a boundary of the adjacent second dielectric portions.

[25]

The frequency selective reflector according to any one of [14] to [24], wherein the reflecting member is a frequency selective plate reflecting only the electromagnetic waves.

[26]

The frequency selective reflector according to [25], wherein the reflecting member includes multiple types of reflective elements of different sizes.

### REFERENCE SIGNS LIST

1: frequency selective reflector
2: reflecting member
3: reflective element
4: dielectric substrate
5: dielectric member
6: adhesive member
7: reflective layer
8: space
11: first dielectric layer
11a, 11b: first dielectric portion
11P: first dielectric pattern
11S: first supporting portion
11X: boundary between adjacent first dielectric portion
12: second dielectric layer
12a, 12b, 12c: second dielectric portion
12P: second dielectric pattern
12S: second supporting portion
12X: boundary between adjacent second dielectric portion
16a, 16b: adhesive layer
17: pin
31: A1 region
32: A2 region
33: A3 region
305: dielectric layer
306: adhesive layer
309: supporting portion
311: first region of dielectric layer
312: second region of dielectric layer
D1: predetermined direction
t31: thickness of first region of dielectric layer
t32: thickness of second region of dielectric layer

1. A frequency selective reflector reflecting electromagnetic waves in a particular frequency band in a direction different from a regular reflection direction, the frequency selective reflector comprising:
a reflecting member reflecting the electromagnetic waves; and
a dielectric layer that is disposed at an incident side of the electromagnetic waves with respect to the reflecting member and transmits the electromagnetic waves,
the dielectric layer has two types of thicknesses, and includes a plurality of first regions with thinner thickness and a plurality of second regions with thicker thickness.

2. The frequency selective reflector according to claim 1, wherein the thickness of the first region is 0.

3. The frequency selective reflector according to claim 1, wherein the reflecting member is a frequency selective plate reflecting only the electromagnetic waves.

4. The frequency selective reflector according to claim 3, wherein the reflecting member includes multiple types of reflective elements of different sizes.

5. The frequency selective reflector according to claim 1, wherein an absolute value of a difference between a relative reflection phase of the electromagnetic waves in the first region and a relative reflection phase of the electromagnetic waves in the second region is more than 0 degrees and less than 360 degrees.

6. The frequency selective reflector according to claim 1, wherein the dielectric layer includes a resin.

7. The frequency selective reflector according to claim 6, wherein the dielectric layer includes a filler.

8. The frequency selective reflector according to claim 1, wherein the frequency selective reflector includes a ground layer on an opposite side of the reflecting member to the dielectric layer; or the reflecting member includes a reflective layer also serving as a ground layer.

9. The frequency selective reflector according to claim 1, further comprising an adhesive layer between the reflecting member and the dielectric layer.

10. The frequency selective reflector according to claim 1, further comprising a space between the reflecting member and the dielectric layer.

11. The frequency selective reflector according to claim 1, further comprising a cover member on an opposite side of the dielectric layer to the reflecting member.

12. The frequency selective reflector according to claim 1, wherein a frequency of the electromagnetic waves is 300 GHz or less.

13. The frequency selective reflector according to claim 1, wherein the dielectric layer includes a supporting portion supporting the second region.

14. A frequency selective reflector reflecting electromagnetic waves in a particular frequency band in a direction different from a regular reflection direction, the frequency selective reflector comprising:
a substrate;
a reflecting member disposed on one side of the substrate, and reflecting the electromagnetic waves; and
a dielectric member disposed on an opposite side of the reflecting member to the substrate, and transmits the electromagnetic waves,
the dielectric member includes a first dielectric layer and a second dielectric layer, in this order from the reflecting member side,
the first dielectric layer includes a plurality of first dielectric portions disposed on an opposite side of the reflecting member to the substrate,
the second dielectric layer includes a plurality of second dielectric portions disposed on an opposite side of the first dielectric layer to the reflecting member,
the second dielectric portion is arranged so that the second dielectric portion overlaps a boundary of the adjacent first dielectric portions in a plan view, and
the first dielectric portion includes a first dielectric pattern, and the second dielectric portion includes a second dielectric pattern.

15. The frequency selective reflector according to claim 14, wherein the dielectric member includes, an A1 region which does not include the first dielectric pattern and the second dielectric pattern from the reflecting member side; an A2 region including only the first dielectric pattern from the reflecting member side; and an A3 region including the first dielectric pattern and the second dielectric pattern from the reflecting member side.

16. The frequency selective reflector according to claim 14, wherein, in a plan view, a distance between a boundary of the adjacent first dielectric portions and a boundary of the adjacent second dielectric portions is ⅓ or more of a thickness of the dielectric member.

17. The frequency selective reflector according to claim 14, wherein the substrate includes an alignment mark.

18. The frequency selective reflector according to claim 14, wherein the first dielectric portion and the second dielectric portion include alignment marks.

19. The frequency selective reflector according to claim 14, wherein the first dielectric portion includes a first supporting portion supporting the first dielectric pattern, and the second dielectric portion incudes a second supporting portion supporting the second dielectric pattern.

20. The frequency selective reflector according to claim 19, wherein, in a plan view, the first dielectric portion and the second dielectric portion are arranged so that the first supporting portion and the second supporting portion overlap each other.

21. The frequency selective reflector according to claim 14, wherein the first dielectric portion and the second dielectric portion are fixed by a pin that passes through the first dielectric portion and the second dielectric portion.

22. The frequency selective reflector according to claim 14, wherein the first dielectric layer and the second dielectric layer are adhered together.

23. The frequency selective reflector according to claim 14, wherein
the dielectric member includes the first dielectric layer, the second dielectric layer, and a third dielectric layer in this order from the reflecting member side; the third dielectric layer includes a plurality of third dielectric portions disposed on an opposite side of the second dielectric layer to the first dielectric layer; the third dielectric portion includes a third dielectric pattern; and the dielectric member includes, a B1 region which does not include the first dielectric pattern, the second dielectric pattern, and the third dielectric pattern from the reflecting member side, a B2 region including only the first dielectric pattern from the reflecting member side, a B3 region including only the first dielectric pattern and the second dielectric pattern from the reflecting member side, and a B4 region including the first dielectric pattern, the second dielectric pattern, and the third dielectric pattern from the reflecting member side;
the dielectric member includes a third dielectric layer, the first dielectric layer, and the second dielectric layer in this order from the reflecting member side; the third dielectric layer includes a plurality of third dielectric portions disposed on an opposite side of the reflecting member to the substrate; the third dielectric portion includes a third dielectric pattern; and the dielectric member includes, a C1 region which does not include the third dielectric pattern, the first dielectric pattern, and the second dielectric pattern from the reflecting member side, a C2 region including only the third dielectric pattern from the reflecting member side, a C3 region including only the third dielectric pattern and the first dielectric pattern from the reflecting member side, and a C4 region including the third dielectric pattern, the first dielectric pattern, and the second dielectric pattern from the reflecting member side; or
the dielectric member includes the first dielectric layer, a third dielectric layer, and the second dielectric layer in this order from the reflecting member side; the third dielectric layer includes a plurality of third dielectric portions disposed on an opposite side of the first dielectric layer to the reflecting member; the third dielectric portion includes a third dielectric pattern; and the dielectric member includes, a D1 region which does not include the first dielectric pattern, the third dielectric pattern, and the second dielectric pattern from the reflecting member side, a D2 region including only the first dielectric pattern from the reflecting member side, a D3 region including only the first dielectric pattern and the third dielectric pattern from the reflecting member side, and a D4 region including the first dielectric pattern, the third dielectric pattern, and the second dielectric pattern from the reflecting member side.

24. The frequency selective reflector according to claim 23, wherein, in a plan view, the third dielectric portion is arranged so that the third dielectric portion overlaps a boundary of the adjacent first dielectric portions, and the third dielectric portion overlaps a boundary of the adjacent second dielectric portions.

25. The frequency selective reflector according to claim 14, wherein the reflecting member is a frequency selective plate reflecting only the electromagnetic waves.

26. The frequency selective reflector according to claim 25, wherein the reflecting member includes multiple types of reflective elements of different sizes.

27. The frequency selective reflector according to claim 1, wherein a frequency band of the electromagnetic waves is a frequency band used in fifth generation mobile communication systems (5G).

28. The frequency selective reflector according to claim 1, wherein a frequency band of the electromagnetic waves is 24 GHz or more.
